(19) United States
(12) Patent Application Publication
(10) Pub. No.: US 2025/0297863 A1
(43) Pub. Date: Sep. 25, 2025

(54) REAL-TIME CONTEXTUAL FEEDBACK FOR NAVIGATION APPLICATION

(71) Applicant: Rivian IP Holdings, LLC, Irvine, CA (US)

(72) Inventors: Kok Wei Koh, Mountain View, CA (US); Colin William Crenshaw, Portola Valley, CA (US); Evelyn Anne Fisher, Bozeman, MT (US); Nora Valeria Calabrese, Mountain View, CA (US)

(73) Assignee: Rivian IP Holdings, LLC, Irvine, CA (US)

(21) Appl. No.: 19/076,151

(22) Filed: Mar. 11, 2025

Related U.S. Application Data
(60) Provisional application No. 63/568,816, filed on Mar. 22, 2024.

(51) Int. Cl. G01C 21/34; G01C 21/36; G06F 3/0482; G07C 5/00

(52) U.S. Cl. CPC G01C 21/3469; G01C 21/3492; G01C 21/3682; G07C 5/008; G06F 3/0482

(57) ABSTRACT

A system including one or more processors is provided. The one or more processors can present a user interface including a prompt for feedback of performance of an application. The one or more processors can select a set of options based on a state of the application. The one or more processors can present the set of options on the user interface. The one or more processors can receive a selection of one or more options of the set of options. The one or more processors can transmit the selection of the one or more options to a remote computer.

### CROSS-REFERENCE TO RELATED APPLICATIONS

This application claims the benefit of priority to U.S. Provisional Application No. 63/568,816, filed Mar. 22, 2024, the entirety of which is incorporated by reference herein.

### INTRODUCTION

A vehicle, such as an electric vehicle, can provide an application for navigating to a destination.

### SUMMARY

This disclosure is generally directed to improving performance of an application configured for electric vehicle (EV) navigation. For example, an electric vehicle can have a display and a computing system that executes an application (e.g., a navigation application) to depict, on a user interface, an overhead view of a map representing the area in which the electric vehicle is located or driving. The application can provide instructions with a graphical representation of the instructions on the map or information about different points of interest. The instructions can indicate a route for the electric vehicle to travel to reach a destination or point of interest. The application can provide the instructions or the information on the user interface. However, given the transient nature of roads and points of interest, the navigating instructions or information about the points of interest can be incorrect or outdated. To improve performance of the application, the computing system (e.g., through the application) can provide a user interface that facilitates users providing contextual feedback regarding how the application is performing in real time. For example, via the application, the computing system can determine options to present on the user interface based on contextual information about the application, the vehicle, or the environment surrounding the vehicle. For instance, the computing system can identify the state (e.g., the current state) of the application. The computing system can select one or more options for providing feedback regarding performance of the application to present on the user interface based on the state of the application. The computing system can present the one or more options of the set of options on the user interface. A user (e.g., a driver of the vehicle) can select one or more of the options from the user interface. The computing system can transmit the selected options to a remote computing system for further processing.

At least one aspect is directed to a vehicle. The vehicle can include one or more processors. The one or more processors can be coupled with memory to present, on the display of the vehicle, a user interface comprising a prompt for feedback of performance of the application. The one or more processors can be coupled with memory to select, in response to the prompt, a set of options based on a state of the application, each option of the set of options corresponding to a different type of feedback regarding performance of the application. The one or more processors can be coupled with memory to present the set of options on the user interface. The one or more processors can be coupled with memory to receive a selection of one or more options of the set of options. The one or more processors can be coupled with memory to transmit the selection of the one or more options to a remote computer.

At least one aspect is directed to a method. The method can include presenting, by one or more processors on a display of a vehicle, a user interface comprising an element to prompt for feedback of performance of an application to provide instructions for the vehicle. The method can include selecting, by the one or more processors responsive to selection of the element, a set of options based on a state of the application, each option of the set of options corresponding to a different type of feedback regarding performance of the application. The method can include presenting, by the one or more processors, the set of options on the user interface. The method can include receiving, by the one or more processors, a selection of one or more options of the set of options at the user interface. The method can include transmitting, by the one or more processors, the selection of the one or more options to a remote computer.

At least one aspect is directed to a vehicle. The vehicle can include one or more processors. The one or more processors can be coupled with memory to execute the application to generate a route for the vehicle to reach a destination. The one or more processors can be coupled with memory to present, on the display of the vehicle, a user interface comprising an element to prompt for feedback of performance of the application. The one or more processors can be coupled with memory to select, responsive to selection of the element, a set of options based on a state of the application indicating that the application is generating the route for the vehicle to reach the destination, one or more options of the set of options corresponding to different types of feedback regarding the route. The one or more processors can be coupled with memory to present the set of options on the user interface. The one or more processors can be coupled with memory to receive a selection of one or more options of the set of options at the user interface. The one or more processors can be coupled with memory to transmit the selection of the one or more options to a remote computer.

At least one aspect is directed to a device. The device can include a display and one or more processors. The one or more processors can be coupled with memory to receive a plurality of scores for a plurality of charging stations within a geographical region including a location of the vehicle. Each score can represent performance of a different charging station of the plurality of charging stations based on one or more charging sessions performed at the charging station. The one or more processors can be coupled with memory to present, on the display of the vehicle, a graphical user interface comprising a map depicting an overhead view of a portion of the geographical region including the location of the vehicle, the map including one or more indicators representing a location of one or more of the plurality of charging stations within the portion of the geographical region. The one or more processors can be coupled with memory to, responsive to selection of an indicator of the one or more indicators representing a location of a first charging station of the one or more of the plurality of charging stations, insert a score of the plurality of scores for the first charging station into the graphical user interface.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle, in accordance with the present embodiments.

FIG. 2 depicts a system for real-time contextual feedback for an application, in accordance with present implementations.

FIG. 3 depicts a flowchart of a method for real-time contextual feedback for an application, in accordance with present implementations.

FIG. 4 depicts a flowchart of a method for real-time contextual feedback for an application, in accordance with present implementations.

FIGS. 5-10 depict example user interfaces illustrating a sequence for providing feedback for a point of interest loading state of an application, in accordance with present implementations.

FIGS. 11-15 depict example user interfaces illustrating a sequence for providing feedback for a navigation state of an application, in accordance with present implementations.

FIGS. 16-20 depict example user interfaces illustrating a sequence for providing feedback for an arrival state of an application, in accordance with present implementations.

FIGS. 21-26 depict example user interfaces illustrating a sequence for providing feedback for a point of interest state of an application, in accordance with present implementations.

FIGS. 27-32 depict example user interfaces illustrating a sequence for providing feedback for a searching state of an application, in accordance with present implementations.

FIGS. 33-38 depict example user interfaces illustrating a sequence for providing feedback for the state of the application in which the application is providing point of interest details for information regarding a charger, in accordance with present implementations.

FIGS. 39-43 depict example user interfaces illustrating a sequence for providing feedback for an arrival at a charging station state of an application, in accordance with present implementations.

FIGS. 44-49 depict example user interfaces illustrating a sequence for providing feedback for a point of interest state of an application, in accordance with present implementations.

FIGS. 50-55 depict example user interfaces illustrating a sequence for providing feedback for a searching state of an application, in accordance with present implementations.

FIG. 56 is a block diagram illustrating an architecture for a computer system that can be employed to implement elements of the systems and methods described and illustrated herein.

FIG. 57 depicts a system for charging station score presentation, in accordance with present implementations.

FIG. 58 depicts a flowchart of a method for charging station score presentation, in accordance with present implementations.

FIGS. 59-62 depict example user interfaces for providing charging station scores on a client device, in accordance with present implementations.

FIGS. 63-67 depict example user interfaces for providing charging station scores on a display device of a vehicle, in accordance with present implementations.

### DETAILED DESCRIPTION

Following below are more detailed descriptions of various concepts related to, and implementations of, methods, apparatuses, and systems of electric vehicle navigation application management. The various concepts introduced above and discussed in greater detail below may be implemented in any of numerous ways.

This disclosure is generally directed to improving performance of an application configured for vehicle navigation (e.g., electric vehicle (EV) navigation). For example, an electric vehicle can have a display and a computing system that executes an application (e.g., a navigation application) to depict an overhead view of a map representing the area in which the electric vehicle is located or driving. The application can depict the map on a user interface. The application can provide instructions with a graphical representation of the instructions on the user interface (e.g., as an overlay over the map). The instructions can indicate a route for the electric vehicle to travel to reach a destination or point of interest. The application can also provide information about the destination or other points of interest on the user interface. However, given the transient nature of roads and points of interest, the navigating instructions or information about the points of interest can be incorrect or outdated. Additionally, in some cases, the application can provide a slower route than expected for the destination because of traffic, for example, or generate instructions that would lead the electric vehicle down a road that is no longer there or that is closed. Additionally, errors in the application (e.g., errors that cause latency or poor performance) can cause the processor of the electric vehicle executing the application to use extra processing resources (e.g., the application may stall or repeatedly attempt to perform the same function), and thus cause the processor to use excess energy or power to execute or use the application, which can reduce mileage of the electric vehicle because the same battery may be used to power the vehicle for driving as that is used to power processing of the application.

To improve performance and computational efficiency of the application, and to reduce latency, the computing system (e.g., through the application) can provide a user interface that facilitates users providing contextual feedback regarding how the application is performing in real time. For example, via the application, the computing system can present options for different types of feedback regarding the performance of the application. The computing system can present the options at a user interface. The computing system can determine which options to present on the user interface based on contextual information about the application or the vehicle. For instance, the computing system can identify the state (e.g., the current state) of the application and select one or more options to present on the user interface based on the state of the application. Examples of states of the application can include, but are not limited to, point of interest details loading, active navigation, arrival at point of interest, charging station details, point of interest details, and search engine activated while in active navigation. Each state can correspond to a set of options for providing feedback regarding performance of the application. The computing system can identify and use the state of the application to select a set of options for providing feedback for the application that relates to the application's state. The computing system can present the one or more options of the set of options on the user interface. A user (e.g., a driver or passenger of the vehicle) can select one or more of the options from the user interface. The user can select a send button to cause the computing system to transmit the selected options to a remote computing system for further processing, such as to mitigate any issues with the application indicated by the feedback. Accordingly, the computing system can facilitate the driver providing contextual real-time feedback regarding performance of the application with minimal latency so any issues indicated in the feedback can be quickly or automatically addressed. For example, real-time feedback can include obtaining feedback data responsive to the application performing a function or process and the user selecting an option for feedback based on or soon after (e.g., within 30 seconds or a minute of) the application's performance of the function or process. The feedback can be contextual because the application can present selectable options for feedback based on the current state of the application when the application presents the options.

The computing system can use other data that the vehicle collects to dynamically generate the options on the user interface. For example, the vehicle can include different types of sensors that collect data regarding the temperature outside, the tire pressure of the vehicle's tires, the weather, etc., that can collect data and transmit the collected data to the computing system. The computing system can receive the data and use the data alone or in combination with the state of the application to select a set of options to present on the user interface. In another example, the computing system can use battery data to select a set of options to present on the user interface. For instance, the computing system can identify the state of charge of the battery of the vehicle and use the state of charge alone or in combination with the state of the application or sensor data to select a set of options. In another example, the computing system can use global positioning data (e.g., data that the computing system receives from a satellite or a remote computing device) indicating the location (e.g., the current location) of the vehicle in addition to or instead of any other collected or identified data to select a set of options. Using the state of charge or other sensor or global positioning data to select the set of options can facilitate the computing system providing more context-specific feedback options such that the driver or user of the vehicle can provide feedback to improve performance of the application relating to the sensor data and/or the battery, which can aid in the application generating instructions or other outputs that improve the operating efficiency of the vehicle (e.g., because the feedback can indicate when the application is not properly taking the state of charge of the battery into account when generating navigation instructions).

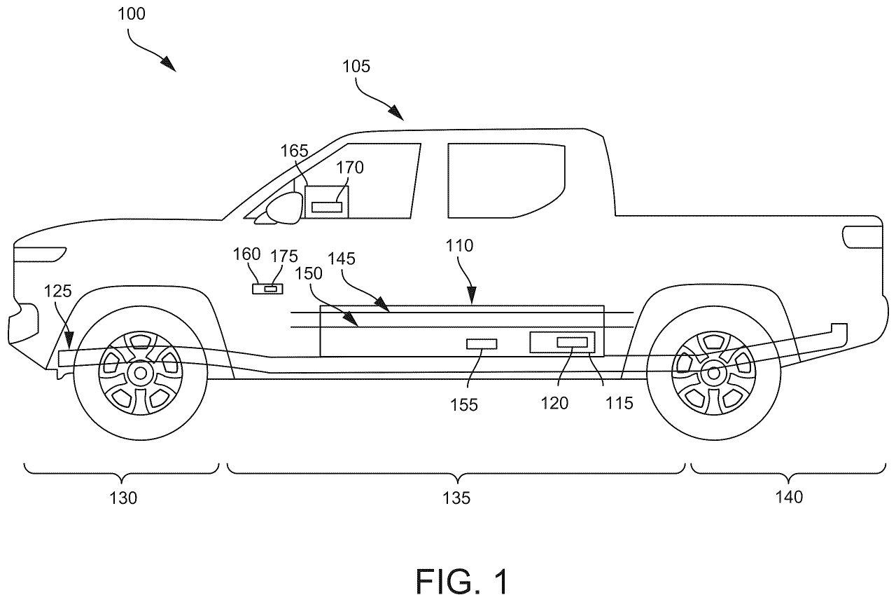

FIG. 1 depicts an example cross-sectional view 100 of a vehicle 105 installed with at least one battery pack 110. The vehicle 105 can be an electric vehicle. The vehicle 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. The vehicles 105 can be fully electric or partially electric (e.g., plug-in hybrid) and further, vehicles 105 can be fully autonomous, partially autonomous, or unmanned. The vehicles 105 can also be human operated or non-autonomous. The vehicles 105 such as electric trucks or automobiles can include on-board battery packs 110, batteries 115 or battery modules 115, or battery cells 120 to power the electric vehicles. The vehicle 105 can include a chassis 125 (e.g., a frame, internal frame, or support structure). The chassis 125 can support various components of the vehicle 105. The chassis 125 can span a front portion 130 (e.g., a hood or bonnet portion), a body portion 135, and a rear portion 140 (e.g., a trunk, payload, or boot portion) of the vehicle 105. The battery pack 110 can be installed or placed within the vehicle 105. For example, the battery pack 110 can be installed on the chassis 125 of the vehicle 105 within one or more of the front portion 130, the body portion 135, or the rear portion 140. The battery pack 110 can include or connect with at least one busbar (e.g., a current collector clement). For example, the first busbar 145 and the second busbar 150 can include electrically conductive material to connect or otherwise electrically couple the battery 115, the battery modules 115, or the battery cells 120 with other electrical components of the vehicle 105 to provide electrical power to various systems or components of the vehicle 105.

The vehicle 105 can include an on-board charger 155 and a controller 160. The on-board charger 155 can include a port for receiving power from a charger. The on-board charger 155 can receive AC power from a charger or direct AC power from one of the batteries 115 of the vehicle 105 to an external load. The on-board charger 155 can be configured to direct or receive AC power of any voltage or power. The controller 160 can include one or more processors and memory. The controller 160 can be configured to control operation of different components of the vehicle 105. In one example, the controller 160 can control the charge and discharge of the on-board charger 155 or the batteries 115 for charging an external load. The controller 160 can control the contactors (e.g., open and close the contactors) of the batteries 115 to enable the batteries 115 to be charged or discharged.

The vehicle 105 can include a display 165. The display 165 can be or include a display device or an electronic screen configured to display a user interface 170. The display 165 can be powered by the batteries 115. The controller 160 or another computing device of the vehicle 105 can generate and update the user interface 170, such as while the vehicle 105 is turned on or operating with power from the batteries 115.

The controller 160 or another computing device of the vehicle 105 can generate and/or update the user interface 170 by executing an application 175. The application 175 can be a navigation application that is configured to generate and/or display an overhead map of the area surrounding the vehicle 105.

The application 175 can operate (e.g., using global positioning data or otherwise by communicating with a satellite and/or a computing device that is remote from the vehicle 105) to provide navigating instructions for the vehicle 105 to travel to a destination. For example, a driver of the vehicle 105 can input a destination and the application 175 can generate (e.g., automatically generate) a route to the destination. The application 175 can provide navigational instructions (e.g., distances to travel before turning, directions to turn, etc.) for the route. The application 175 can generate the route or receive the route from a remote computing device. The route can be generated based on real-time traffic information (e.g., current traffic information or otherwise data representing the current state of traffic on different potential routes to the destination) such that the route is intended to be the fastest route to the destination. The application 175 can additionally provide information regarding the destination or points of interest. For example, the application 175 can generate the user interface 170 to include pointers for different locations that can be selected to view information about the locations. The application 175 can provide any type of information on the display 165 by generating and/or updating the user interface 170.

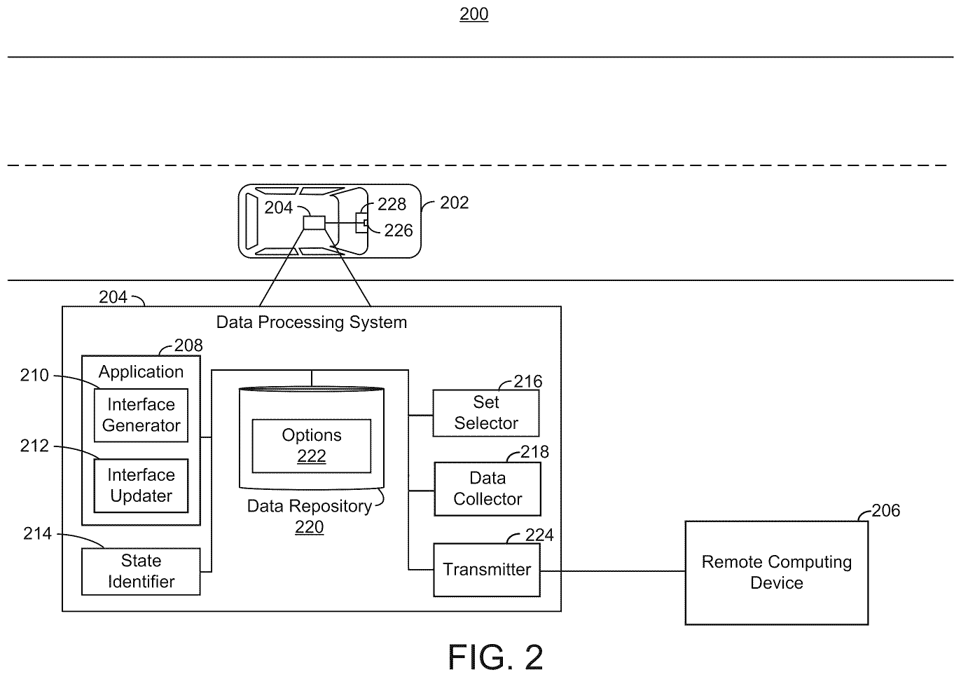

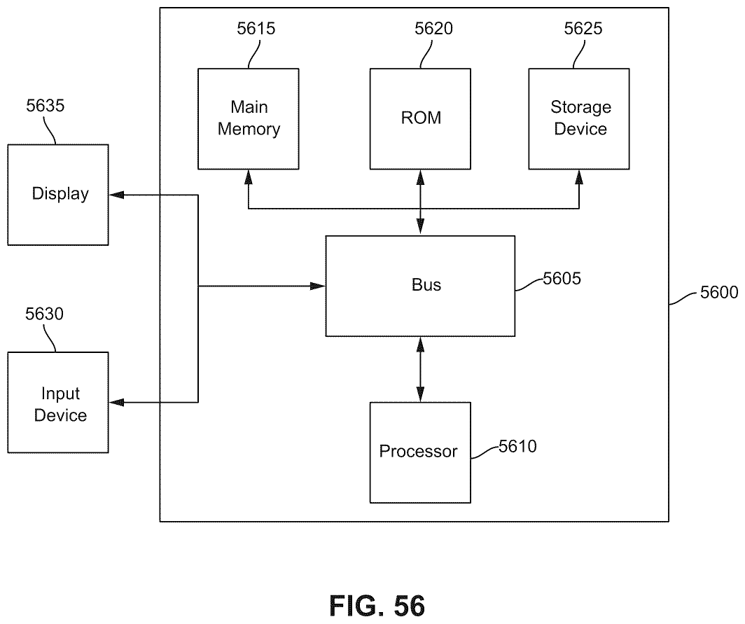

FIG. 2 depicts an example system 200, in accordance with present implementations. The system 200 can include a vehicle 202 and a remote computing device 206. The vehicle 202 can include a data processing system 204. The data processing system 204 can be the same as or be similar to the computing system 5600, shown and described with reference to FIG. 56 or the controller 160, shown and described with reference to FIG. 1. The data processing system 204 can communicate with the remote computing device 206 over a network (e.g., a communications network or a wireless network). The vehicle 202 can be similar to or the same as the electric vehicle 105, shown and described with reference to FIG. 1. The data processing system 204 can execute an application (e.g., a navigation application, such as the application 175) to generate a user interface on a display of the vehicle 202. Via the application, the data processing system 204 can display a map showing at least the area surrounding the vehicle 202 and provide instructions (e.g., directions) to reach a destination or information about different points of interest. The data processing system 204 can include a prompt (e.g., an element or virtual button on the user interface) that can be selected to present options for a user or driver to provide feedback regarding the performance of the application. The data processing system 204 can determine the state of the application (e.g., a state that indicates whether the application is navigating to a destination or has just arrived at the destination, whether the application is displaying data regarding a point of interest, or whether the application is in standby mode (e.g., free map) and tracking the location of the vehicle over time without providing navigational instructions). The data processing system can select a set of options of different types of feedback to present on the user interface based at least on the state of the application. The data processing system 204 can present the set of options and the user can select one or more of the set of options. The data processing system 204 can transmit the selected options to the remote computing device 206 for further processing. Accordingly, by implementing the systems and methods described herein, the data processing system 204 can implement real-time contextual feedback generation for improving a vehicle navigation application.

The data processing system 204 can include or execute on one or more processors or computing devices and/or communicate via the network. The network can include computer networks such as the Internet, local, wide, metro, or other area networks, intranets, satellite networks, and other communication networks such as voice or data mobile telephone networks. The network can include computer networks such as the Internet, local, wide, metro, or other area networks, intranets, satellite networks, and other communication networks such as voice or data mobile telephone networks. The network can be used to access information resources such as web pages, websites, domain names, or uniform resource locators that can be presented, output, rendered, or displayed on at least one computing device. For example, the data processing system 204 can communicate over the network with different computing devices to generate navigational routes or instructions for a vehicle to travel to a destination. A driver or user can input a destination and the data processing system 204 can communicate with one or more computing devices to generate a route or instructions for the vehicle 202 to reach the destination. The vehicle 202 can present the route or instructions on a user interface or display of the vehicle such that the user or driver can follow the route or instructions to reach the destination.

The data processing system 204 can include at least one application 208. The application 208 can include an interface generator 210 and an interface updater 212. The data processing system 204 can include at least one state identifier 214. The data processing system 204 can include at least one set selector 216. The data processing system 204 can include at least one data collector 218. The data processing system 204 can include at least one data repository 220. The data processing system 204 can include at least one transmitter 224. The application 208, the state identifier 214, the set selector 216, the data collector 218, and the transmitter 224 can each include at least one processing unit or other logic device such as a programmable logic array engine, or module configured to communicate with the data repository 220. The application 208, the state identifier 214, the set selector 216, the data collector 218, and the transmitter 224 can be separate components, a single component, or part of the data processing system 204. The data processing system 204 can include hardware elements, such as one or more processors, logic devices, circuits, or memory. The data processing system 204 can be or include one or more cloud servers or can be located on a vehicle (e.g., an electric vehicle). In one example, the data processing system 204 can be a controller (e.g., the controller 160) of an electric vehicle and can control the electric vehicle to follow (e.g., automatically follow) a path to a destination.

The data repository 220 can include one or more local or distributed databases, and can include a database management system. The data repository 220 can include computer data storage or memory. The data repository 220 can store options 222. The data repository 220 can be or include a relational database or a graphical database. The options 222 can include options that correspond to different types of feedback regarding performance of the application 208. Examples of options can include, but are not limited to, wrong information, route problem, illegal route, road closure, wrong location, inaccurate traffic, confusing guidance, wrong vehicle position, wrong charge speed, wrong price, or wrong availability. A user can select such options to provide feedback regarding the user's view of how the application 208 is performing.

The data repository 220 can store the options 222 separately or in sets. For example, a set of options 222 can include one or more options 222. The sets of options in the data repository 220 can each correspond to a different state of the application 208 or correspond with rules that can be satisfied based on the state of the application 208 or with other contextual information, such as sensor data generated by sensors of the vehicle 202 or the state of charge of the vehicle 202. The sets of options 222 can correspond to the states or rules by being stored with indications or pointers to the respective states or rules.

The application 208 can be a navigation application configured to generate instructions (e.g., directions) for navigating to a destination. The application 208 can generate a user interface 226 that displays an overhead map of the area surrounding the vehicle 202. The user interface 226 can be displayed or presented on a display device 228 of the vehicle 202. The application 208 can communicate with a remote computing device (e.g., the remote computing device 206) to generate instructions (e.g., navigation instructions) for the vehicle 202 to travel to a destination (e.g., a defined destination) or a point of interest into the user interface 226 by the driver or passenger of the vehicle 202. The application 208 can present a route on the user interface 226 that depicts directions for the vehicle 202 to travel to reach the destination. The application 208 can additionally or instead present information about different points of interest on the user interface 226. The application 208 can perform all or a portion of the operations described herein as being performed by components of the data processing system 204 or the data processing system 204 itself.

The interface generator 210 of the application 208 can generate the user interface 226. In doing so, the interface generator 210 can generate a user interface that corresponds to different states of the application 208. For example, the interface generator 210 can generate the user interface 226 upon boot up or powering of the vehicle 202. In doing so, the interface generator 210 can generate the user interface 226 with the application 208 in an initial state (e.g., a standby state (e.g., a free map state) or a general state) in which the user interface 226 only shows an overhead view of the vehicle 202 and the area surrounding the vehicle 202. In the initial state, the interface updater 212 can update the user interface 226 to follow the vehicle 202 around the overhead map, updating the surrounding area of the vehicle 202 in the process. Thus, the initial state of the application 208 can be a state in which the application 208 is not generating or presenting instructions to reach a destination or presenting details regarding a point of interest.

The interface updater 212 can update the user interface 226 based on a change in state of the application 208. For instance, the application 208 can change from the initial state to another state, such as responsive to a driver or passenger (e.g., a user) of the vehicle 202 selecting an element, virtual button, or option presented on the user interface 226. For example, a user of the vehicle 202 can select an option or set of options on the user interface to request instructions for traveling to a destination. Responsive to receiving the selection, the application 208 can generate instructions for a route for the vehicle 202 to travel to reach the destination. The application 208 can do so by transmitting a request with an identification of the destination or route to a remote computer that is configured to generate such routes or by generating the route based on a global positioning system (GPS) data of the vehicle 202 and/or of other vehicles around the vehicle 202. The application 208 can generate instructions and provide real-time instructions to travel to the destination that the driver of the vehicle 202 can follow to reach the destination.

The application 208 can generate the instructions by generating auditory instructions or visual instructions. The application 208 can be in a navigation state while generating the instructions (e.g., from the time between receiving the request to reach a destination to the time in which the vehicle 202 arrives at the destination or the application 208 stops generating the instructions). The auditory instructions can be instructions for the driver to follow in real time to reach the destination. Examples of such instructions can include, but are not limited to, “turn left,” “turn right in one mile,” and “turn left onto Washington Boulevard in three miles.” The application 208 can emit the instructions through a speaker in the vehicle 202 such that the driver can follow the instructions to reach different destinations. The visual instructions can be or include visual indicators of a path or route for the driver to follow to reach the destination. The interface updater 212 can update the user interface 226 to show the path for the vehicle 202 to travel as the vehicle 202 follows the path. The application 208 can adjust the instructions as the driver travels based on whether the driver follows the instructions (e.g., the application 208 can update the instructions with a new route to reach the same destination that the application 208 generates or a remote computer generates).

In another example, the application 208 can change state when the vehicle 202 arrives at a destination. The application 208 can determine the vehicle 202 arrives at a destination responsive to determining the vehicle 202 is within a threshold distance of the destination, for example. Responsive to determining the vehicle 202 arrived at the destination, the application 208 can stop providing instructions to reach the destination. The application 208 can change (e.g., automatically change) state to an arrival state responsive to the vehicle 202 arriving at the destination. The interface updater 212 can update the user interface 226 to include an option to end the trip or route responsive to the application 208 changing to the arrival state. The application 208 can stay in the arrival state until the user selects the option to end the trip or route or the vehicle 202 otherwise turns off or powers down.

In another example, the application 208 can change state to a trip details state. The trip details state can be a state in which the application 208 presents a user interface showing details regarding a trip or route to a destination. The application 208 can enter the trip details state after a user inputs a destination and the application 208 shows trip details about a route to reach the destination prior to entering the navigation state. Examples of details the application 208 can show on the user interface 226 in the trip details state can include a number of charging stops, trip length, arrival time, projected available state of charge upon arriving at the destination, and trip distance. The application 208 can change from the trip details state responsive to the user selecting a button on the user interface 226 to initiate the application 208 entering the navigation state.

In another example, the application 208 can change state to a point of interest state. The point of interest state can be a state in which the application 208 presents details regarding a particular point of interest. For instance, the application 208 can enter the point of interest state when a user selects an icon (e.g., a graphic, virtual button, or option) on the user interface 226 that represents a particular point of interest (e.g., a building, park, charging station, or another location). Responsive to the selection, the application 208 can present details about the point of interest. Examples of such details can include, but are not limited to, an address, an opening time range, a name, and an image of the point of interest. The application 208 can be in the point of interest state until a user selects an option or provides an input to stop viewing details about the point of interest.

In another example, the application 208 can change state to a search state. The search state can be a state in which the application 208 queries a local memory of the data processing system or memory of a remote computer for the location of a particular point of interest (e.g., a point of interest input by a user). The search state can also include the application 208 presenting a list of locations that the application 208 identifies based on a search. A user can select an option from the list of locations to cause the application 208 to generate a route and enter the navigation state.

In another example, the application 208 can change states to states involving a charging station. For instance, the application 208 can enter into a charging station information state, a navigation to charging station state, or an arrival at charging station state. Such states can be similar to or the same as the aforementioned states but correspond to the vehicle showing information for a charging station, navigating to a charging station (e.g., providing instructions to navigate to a charging station), or arrival at a charging station, respectively. In the different charging station-related states, the application 208 can present information related to the charging station, such as a number of open charging stations, a charge rate, a cost, or an operation status on the user interface 226. The application 208 can present the current state of charge of the vehicle 202 on the user interface 226.

The interface generator 210 or the interface updater 212 can include a prompt (e.g., a virtual button, an element, or a graphic) or the user interface 226. The interface generator 210 or the interface updater 212 can do so when the application 208 is in the different states. The prompt can be selectable and correspond to updating the user interface 226 to present one or more options for a user to provide feedback related to performance of the application 208. For example, a user can select the prompt on the user interface 226. Responsive to the selection, the application 208 can present one or more options that the user can select indicating how the application 208 is performing, such as whether the application 208 provided accurate data, provided an incorrect route, or is experiencing a large amount of latency. The interface updater 212 can present the options on the user interface 226 responsive to the prompt (e.g., responsive to selection of the prompt).

The application 208 can present options that correspond to or based on the state of the application 208 (e.g., the state of the application 208 at the time in which the prompt was selected). Responsive to the prompt on the user interface 226 (e.g., responsive to selection of the prompt on the user interface 226), the state identifier 214 can identify a state of the application 208. The state identifier 214 can identify the state of the application 208 at the time of the selection of the prompt. The state identifier 214 can identify the state of the application 208 by identifying the code of the application 208 that is executing or that has most recently executed, by determining what the user interface 226 is presenting or displaying (e.g., by using object recognition techniques on the user interface 226), or by using any other technique. For example, responsive to selection of the prompt on the user interface 226, the state identifier 214 can identify the code (e.g., the module) that is currently executing or that most recently executed to generate an updated version of the user interface 226. In doing so, the state identifier 214 can identify states such as the navigation state, the initial state, the point of interest state, the search state, or any other state of the application 208 based on the identified code (e.g., based on a mapping between the identified code and a state of the application, such as a mapping in a table).

The set selector 216 can select a set of options 222 (e.g., from the data repository 220) at least based on the state of the application 208. For instance, the options 222 can be stored in the data repository 220 in different sets of options 222. Each set of options 222 can correspond to a different state or rule. For example, one set of options can include one or more types of feedback that correspond to navigation (e.g., route problem, illegal route, wrong vehicle position, road closure, confusing guidance, inaccurate traffic, something else) by the application 208. Such a set of options can be stored with an indication to the navigation state of the application 208. Another set of options can include one or more types of feedback that correspond to navigation to a vehicle charging station (e.g., wrong information, wrong charge speed, wrong pricing, wrong location, something else). Such a set of options can be stored with an indication to the navigation to a charging station state of the application 208. The sets of options can correspond to any number of states of the application 208. The set selector 216 can identify the state of the application 208 identified by the state identifier 214 and select the set of options 222 that corresponds to the identified state of the application 208.

For example, the state identifier 214 can identify the state of the application 208 as being in the arrival state indicating that the vehicle 202 has arrived at a destination to which the application 208 was navigating. The set selector 216 can select a set of options 222 that corresponds to the arrival state based on the identified state of the application 208. In another example, the state identifier 214 can identify the state of the application 208 as being in the point of interest state indicating that the application is presenting information about a point of interest (e.g., a specific location). The set selector 216 can select a set of options 222 that corresponds to the point of interest state based on the identified state of the application 208. In another example, the state identifier 214 can identify the state of the application 208 as being in the vehicle charging station state indicating that the application 208 is presenting information regarding a vehicle charging station on the user interface 226. The set selector 216 can select a set of options 222 that corresponds to the vehicle charging state based on the identified state of the application 208.

The set selector 216 can identify sets of options 222 based on data other than the state of the application 208. For example, the set selector 216 can select a set of options 222 based on environmental data collected from sensors of the vehicle 202. To do so, the data collector 218 can collect data from different sensors of the vehicle 202. Examples of such data can include data indicating the current temperature of the environment surrounding the vehicle 202, data indicating the precipitation in the environment surrounding the vehicle, or data indicating a wind strength or wind direction. The set selector 216 can compare such collected data to rules in the data repository 220 and determine if the collected data satisfies any rules, individually or in combination with the state of the application 208 identified by the state identifier 214. The set selector 216 can determine a rule is satisfied based on the comparison and identify a set of options 222 that corresponds with the satisfied rule for presentation on the user interface 226. Using environmental data to select a set of options can facilitate the set selector 216 providing more context-specific options for feedback that can result from environmental factors of any negative or positive feedback, such as a large amount of rain or wind affecting a communication interface of the vehicle 202's capability to communicate with a remote computer to present various types of data on the user interface 226.

In another example, the set selector 216 can select a set of options 222 based on the state of charge (e.g., the current state of charge) of the vehicle 202 (e.g., of a battery powering the vehicle 202). The state of charge can indicate an amount of power or energy that is stored in the vehicle 202 or the distance the vehicle 202 can travel based on the amount of power or energy stored in the vehicle 202. The data collector 218 can identify the state of charge of the vehicle 202 responsive to selection of the prompt on the user interface 226. The set selector 216 can compare the state of charge of the vehicle 202 to rules in the data repository 220 and determine if the state of charge satisfies any rules, individually or in combination with the state of the application 208 identified by the state identifier 214 or any other data collected by the data collector 218. The set selector 216 can determine a rule is satisfied based on the comparison and identify a set of options 222 that corresponds with the satisfied rule for presentation on the user interface 226. In one example, the set selector 216 can select a set of options that includes an option to provide feedback indicating the state of charge of the vehicle 202 is low responsive to determining the state of charge of the battery of the vehicle 202 is below a threshold. In another example, the set selector 216 can select a set of options responsive to determining the application was in the navigation state and navigating a route to a destination that the vehicle 202 that did not include a stop at a charging station and the current state of charge would not enable to the vehicle 202 to arrive at the destination. Using the state of charge of the vehicle to select a set of options can facilitate the set selector 216 providing more context-specific options for feedback that can result from the amount of energy that is stored in the vehicle 202. Such can be useful, for example, if the application 208 were to present a long route to a destination without including a stop at a charging station despite the state of charge of the vehicle 202 being low.

In another example, the set selector 216 can select a set of options 222 based on a predicted state of charge of the vehicle 202 at a destination of a route determined by the application 208. The data collector 218 can identify the state of charge of the vehicle 202 and the application 208 can determine or generate the predicted state of charge as a function or based on the distance to the destination and the travel efficiency of the vehicle 202 (e.g., distance traveled/kWh). The set selector 216 can compare the predicted state of charge of the vehicle 202 to rules in the data repository 220 and determine if the state of charge satisfies any rules, individually or in combination with the state of the application 208 identified by the state identifier 214 or any other data collected by the data collector 218. The set selector 216 can determine a rule is satisfied based on the comparison and identify a set of options 222 that corresponds with the satisfied rule for presentation on the user interface 226. Using the predicted state of charge of the vehicle to select a set of options can facilitate the set selector 216 providing more contextually aware options for feedback that can result from an amount of energy that is remaining at the end of a navigation by the application 208. Such can be useful, for example, if the application 208 were to present a long route to a destination without including a stop at a charging station and the vehicle would not have enough power to travel to a charging station after arriving at the destination or otherwise the predicted state of charge is below a threshold.

In another example, the set selector 216 can select a set of options 222 based on data regarding the vehicle 202 itself. For example, the set selector 216 can select a set of options 222 based on data collected from sensors of the vehicle 202 configured to monitor different aspects of the vehicle. To do so, the data collector 218 can collect data from different sensors of the vehicle 202. Examples of such data can include tire pressure, engine performance data, vehicle dynamics data (e.g., speed, acceleration, steering angle, or wheel speed), safety sensor data, battery data, or transmission data. In another example, the data collector 218 can collect global positioning data (e.g., data that the computing system receives from a satellite or a remote computing device) indicating the location (e.g., the current location) of the vehicle 202. The set selector 216 can compare such collected data to rules in the data repository 220 and determine if the collected data satisfies any rules, individually or in combination with the state of the application 208 identified by the state identifier 214. The set selector 216 can determine a rule is satisfied based on the comparison and identify a set of options 222 that corresponds with the satisfied rule for presentation on the user interface 226. Using vehicle data to select a set of options can facilitate the set selector 216 providing more contextually aware options for feedback that can result from factors involving operation of the vehicle, such as detecting a flat tire but not navigating to an automobile repair center.

The set selector 216 can select individual options 222 rather than sets of options 222 or templates of options 222. For example, individual options 222 stored within the data repository 220 can correspond with different rules or states of the application 208. The options 222 can correspond to the rules or states of the application 208 in a one-to-one relationship or a one-to-many relationship in which satisfaction of one rule can indicate to present one or more options 222. The set selector 216 can compare collected data or the state of the application 208 to the rules of the different options 222 and identify options for presentation on the user interface 226. The individual options that the set selector 216 identifies together can be a set of options 222.

The interface updater 212 of the application 208 can update the user interface 226 to present the set of options 222 selected by the set selector 216. For example, the interface updater 212 can present the set of options as an overlay of the previous version of the user interface 226 in a tab that covers all or a portion of the user interface 226. The interface updater 212 can present the options 222 of the selected set in one or more rows on the tab of the user interface 226.

In some cases, the set selector 216 can pre-load or pre-select sets of options 222. For example, the state identifier 214 can monitor the application 208 and identify the states of the application 208 responsive to the application 208 changing state. Responsive to identifying a change in state, the set selector 216 select (e.g., automatically select) a set of options 222 based at least on the new state. The set selector 216 can use the state and any other sensor data to select the set of options 222. Selecting the set of options 222 can include moving an identification of the selected set of options 222 or the selected set of options 222 itself into a cache in memory of the data processing system. The state identifier 214 can identify changes in state of the application 208 and set selector 216 select new sets of options 222 based on the new states of the application 208 over time. The set selector 216 can identify new sets of options 222 based on collected sensor data with or without the identifications of the changes in state of the application 208. The set selector 216 can replace the set of options 222 in the cache with the newly selected sets of options 222 as the set selector 216 selects the new sets of options 222.

The interface updater 212 can retrieve the sets of options 222 from the cache. The interface updater 212 can retrieve the set of options 222 in the cache responsive to selection of the prompt, for example. The interface updater 212 can retrieve the set of options 222 and present the set of options 222 on the user interface 226. By pre-selecting or pre-loading the sets of options 222, the interface updater 212 can present sets of options 222 faster and with less latency because sets of options 222 are already available and the data processing system 204 does not need to perform processing techniques to select the sets of options 222 after selection of the prompt.

A user can use the user interface 226 updated with the set of options 222 to provide contextual feedback regarding the performance of the application 108. For example, the driver can select one or more of the set of options 222 presented on the user interface 226. After selecting the options 222, the transmitter 224 can store (e.g., in random access memory or in a cache) a record of the selection. The user can select one or more of the options 222 and select a “submit” or a “send” element or graphic on the user interface 226. Responsive to the selection of the submit or send element or graphic, the transmitter 224 can transmit identifications of the selected options 222 to the remote computing device 206.

The transmitter 224 can include identification information with the identifications of the selected options 222 in the transmission to the remote computing device 206. For example, the transmitter 224 can be an application programming interface (API). The transmitter 224 can include an identifier of the vehicle 202 or an account associated with the vehicle 202 (e.g., an account of the driver registered to drive the vehicle 202) in a message that contains the selected options 222 that the transmitter 224 transmits to the remote computing device 206. The identifier can facilitate the remote computing device 206 or a user of the remote computing device 206 identifying the source of the feedback. In cases in which the feedback corresponds to a navigation state or a charging state of the application 208, the transmitter 224 can include an identification of the route or path the application 208 was navigating or the charging station to which the application 208 was navigating the vehicle 202 or the vehicle 202 was charging at a time of selection of the prompt in the message. The identification of the route, path, or charging station can facilitate the remote computing device 206 or a user of the remote computing device 206 identifying the context of the feedback. The transmitter 224 can include any data that was used to select the set of options in the message, any data that was collected on the route to the destination in the message, or any data collected by the sensors of the vehicle within a defined time period of the current time in the message.

The remote computing device 206 can be a computer device of a service center that is configured to mitigate any negative feedback that is transmitted to the remote computing device 206 or another computer of the service center. The remote computing device 206 can mitigate issues with individual applications, such as the application 208, directly or indirectly. For example, the remote computing device 206 can mitigate issues with the application 208, such as latency issues or other types of errors that can indicate the application 208 is corrupted in some form, by automatically resetting the application 208 or executing a machine learning model (e.g., a large language model) that is configured to receive indications of feedback as input and generate code as output that can be used to address problems. The remote computing device 206 can transmit the output code from the machine learning model to the application 208 to resolve the issues. The remote computing device 206 can mitigate information-related issues (e.g., incorrect information displayed for a point of interest) for the application 208 by requesting information from a computer that stores information for the point of interest or retrieving such information locally and pushing an update to the application 208 and/or other applications in communication with the remote computing device 206 to update the information for the point of interest. The remote computing device 206 can indirectly mitigate issues, for example, by generating an alert or record (e.g., a table, message, notification, alert, etc.) indicating the issue and transmitting the alert to an electronic account or otherwise presenting the alert or record on a user interface. A technician can view the alert or record and take action to mitigate the issue. In one example, an issue can be a vehicle charging station is not working properly. The remote computing device 206 can generate an alert indicating the vehicle charging station is not working properly and a technician can travel to the vehicle charging station to resolve the issue. The remote computing device 206 can resolve issues relating to the application 208 in any manner.

The vehicle 202 can transmit data regarding how the vehicle is performing or different characteristics of the vehicle to the remote computing device 206. The vehicle 202 can transmit the data via a different communication interface or through different messages than the messages containing user-selected feedback. The vehicle 202 can transmit the data at set intervals (e.g., every minute, hour, or day). The vehicle 202 can include identifications of the vehicle or an account of the driver of the vehicle in the communications, in some cases with an identification of a route or path the vehicle 202 is navigating or driving at the time of the transmission or from which the data was collected. The remote computing device 206 can receive the data from the vehicle 202 and store the data with the identifications of the routes or paths or the vehicle or account of the driver in memory (e.g., in the data repository 220).

The remote computing device 206 can correlate feedback received from the vehicle 202 with other data collected from the vehicle 202. For example, the remote computing device 206 can receive the message with feedback from the vehicle 202. The message can contain an identification of the vehicle 202 or the account of the driver and a path or route the vehicle 202 was driving when the driver submitted the feedback. The remote computing device 206 can use one or more of the identifications from the message containing the feedback to query memory for matching collected sensor data that the vehicle 202 transmitted to the remote computing device 206. The remote computing device 206 can correlate the feedback with matching collected sensor data, such as tagging or flagging the sensor data with the identifications of the message or vice versa. The correlated data or any data included in the message with the message with the feedback can later be used for debugging or to determine how to improve performance of the application 208, such as by replicating the conditions of the time or instance in which the feedback was generated.

The application 208 can (e.g., via the interface updater 212) dynamically update the user interface 226 to include different options (e.g., second one or more options). For example, the application 208 can present a set of options 222 for feedback on the user interface 226. While presenting the set of options 222, the data collector 218 can collect different types of data (e.g., data regarding the environment surrounding the vehicle 202, data regarding the vehicle 202, or data regarding the battery of the vehicle 202). The set selector 216 can compare the different types of data to rules corresponding to the options 222 in the data repository 220. The set selector 216 can determine a rule is satisfied and identify an option 222 or a set of options 222 that correspond with the satisfied rule. The interface updater 212 can insert the identified option 222 or set of options 222 into the user interface 226. In one example, the set selector 216 can select and present an option 222 relating to the state of charge of the vehicle 202 responsive to determining the state of charge is below a threshold, thus giving a user of the vehicle 202 the opportunity to provide feedback related to the state of charge of the vehicle 202. The data processing system 204 can perform these steps while presenting the initially selected options 222 on the user interface 226 over time to dynamically provide context-aware feedback options that can change as the context changes.

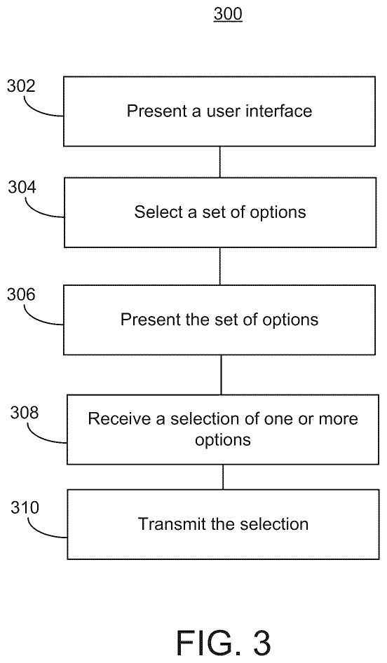

FIG. 3 depicts a method 300 for real-time contextual feedback for a navigation application, in accordance with present implementations. The method 300 can be performed by one or more components depicted in the system 200 of FIG. 2 or the computing device 5600 of FIG. 56. For example, the method 300 can be performed by a data processing system (e.g., the data processing system 204, shown and described with reference to FIG. 2). Performance of the method 300 can facilitate the data processing system's use of data regarding the state of an application or other data regarding a vehicle or the environment surrounding the vehicle to generate contextual options for a driver to provide feedback regarding performance of the application.

At ACT 302, the method 300 can include presenting a user interface. The data processing system can present the user interface by executing an application stored in memory of the data processing system. The application can be a navigation application configured to provide instructions (e.g., navigation instructions) for a vehicle, such as by presenting the instructions on a user interface or by providing auditory instructions. The data processing system can execute the application to cause the user interface to appear on a display (e.g., a display device) of the vehicle. The user interface can include an overhead view of the area surrounding the vehicle or a graphic representing the vehicle. The user interface can include a prompt (e.g., a selectable icon, a virtual button, or an element) that can be selected to cause options for providing feedback regarding performance of the application to appear on the user interface.

At ACT 304, the method 300 can include selecting a set of options. The data processing system can select the set of options responsive to the prompt. For example, the data processing system can select the set of options responsive to receiving a selection of the prompt. The set of options can be or include one or more options for providing different types of feedback of performance of the application. The data processing system can select the set of options based at least on a state of the application. For example, responsive to receiving a selection of the prompt on the user interface, the data processing system can identify the state (e.g., the current state) of the application. Examples of states of the application can include, but are not limited to, a general state, a navigation state, a point of interest state, or a vehicle charging station state. The data processing system can additionally or instead identify other data collected from sensors of the vehicle relating to the environment surrounding the vehicle, the battery of the vehicle (e.g., the state of charge of the battery), or the vehicle itself.

The data processing system can use the state of the application or other collected data to select a set of options. The set of options can include one or more options that each correspond to a different type of feedback regarding performance of the application. For example, different sets of options can be stored in memory of the data processing system and correspond to different states of the application. The data processing system can identify the state of the application and identify the set of options from memory that corresponds with the state of the application. In another example, the different sets of options can correspond to different rules. The rules can be satisfied based on the state of the application, data of the vehicle, data of the environment surrounding the vehicle, or data of the battery of the vehicle. The data processing system can identify a rule that is satisfied based on one or more of the state of the application or the collected data and identify the set of options from memory that corresponds with the satisfied rule. In another example, the data processing system can identify the set of applications by identifying individual options that correspond to a satisfied rule or a state of the application. In doing so, the data processing system can select options that correspond to a specific state of the application, environment data, battery data, or vehicle data.

At ACT 306, the method 300 can include presenting the set of options. The data processing system can present the set of options (e.g., the selected or identified set of options) on the user interface displayed on the display of the vehicle. The data processing system can present the set of options on a tab on the user interface, such as the options represented by graphics in one or more rows.

At ACT 308, the method 300 can include receiving a selection of one or more of the set of options. The data processing system can receive the selection of the one or more of the set of options from or at the user interface. For example, the user can select (e.g., via an input/output device) one or more options of the presented set of options that include feedback with which the user agrees. The data processing system can receive the selection.

At ACT 310, the method 300 can include transmitting the selection of the options. The data processing system can transmit the selection to a remote computing device. The data processing system can transmit the selection to the remote computing device across a network. The remote computing device can receive the selection. The remote computing device can mitigate any negative feedback, such as by adjusting the configuration of the application or by generating an alert, record, or report that a user can use to mitigate the negative feedback.

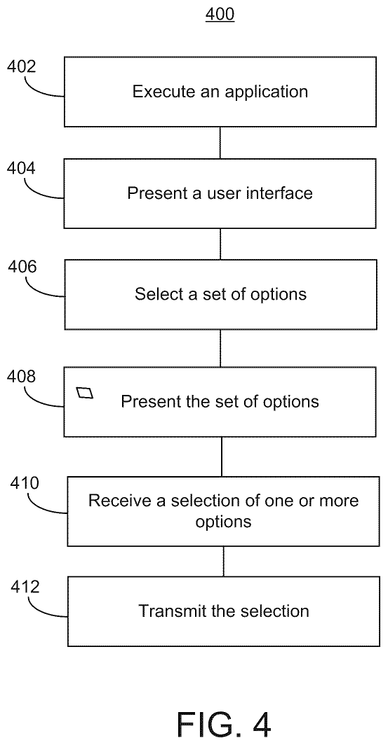

FIG. 4 depicts a method 400 for real-time contextual feedback for a navigation application, in accordance with present implementations. The method 400 can be performed by one or more components depicted in the system 200 of FIG. 2 or the computing device 5600 of FIG. 56. For example, the method 400 can be performed by a data processing system (e.g., the data processing system 204, shown and described with reference to FIG. 2). Performance of the method 400 can facilitate the data processing system use of data regarding the state of an application providing a user interface on a vehicle or other data regarding the vehicle or the environment surrounding the vehicle to generate contextual options for a driver to provide feedback regarding performance of the application.

At ACT 402, the method 400 can include executing an application. The data processing system can execute the application to generate a route for the vehicle to reach a destination. At ACT 404, the method 400 can include presenting a user interface. The data processing system can present the user interface on a display or display device of the vehicle (e.g., a display device attached to the dashboard of the vehicle). The user interface can include an element to prompt for feedback of performance of the application. At ACT 406, the method 400 can include selecting a set of options. The data processing system can select the set of options responsive to a selection of the element. The data processing system can select the set of options based on a state of the application indicating that the application is generating the route for the vehicle to reach the destination. One or more options of the set of options can correspond to different types of feedback regarding the route. At ACT 408, the method 400 can include presenting the set of options. The data processing system can present the set of options on the user interface. At ACT 410, the method 400 can include receiving a selection of one or more options. The data processing system can receive a selection of one or more options of the set of options at the user interface. At ACT 412, the method 400 can include transmitting the selection. The data processing system can transmit the selection of the one or more options to a remote computer.

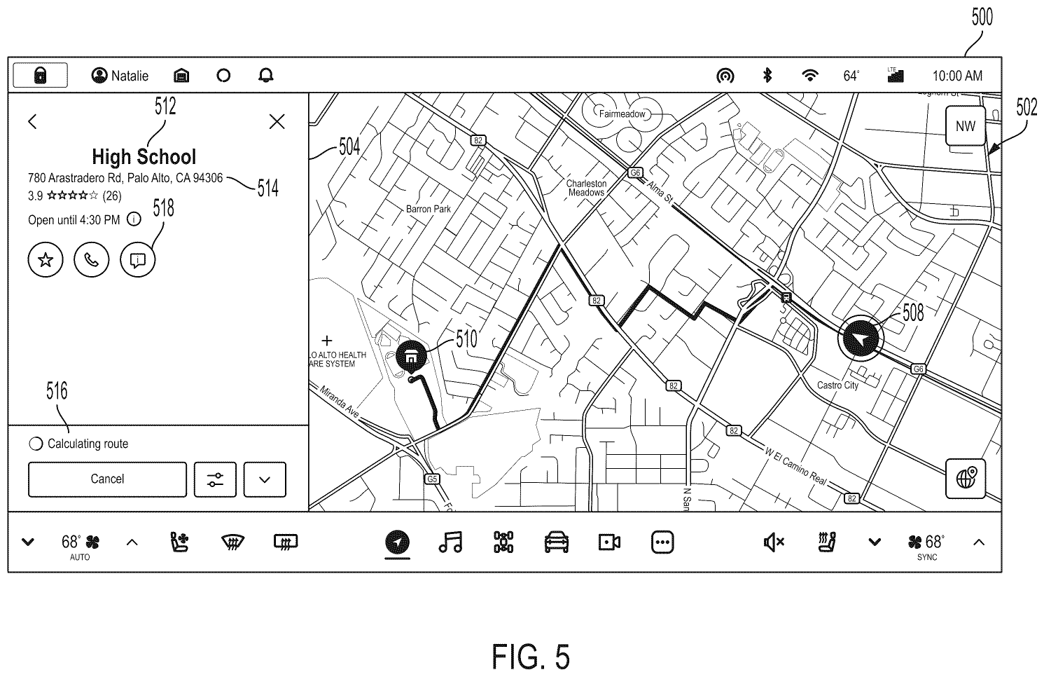

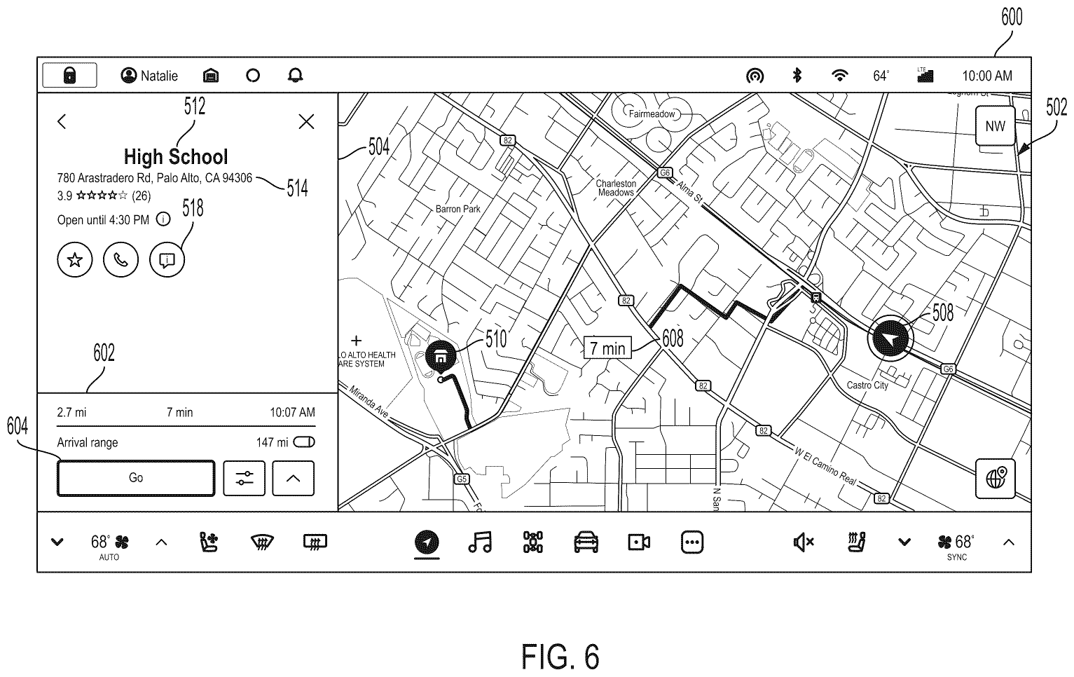

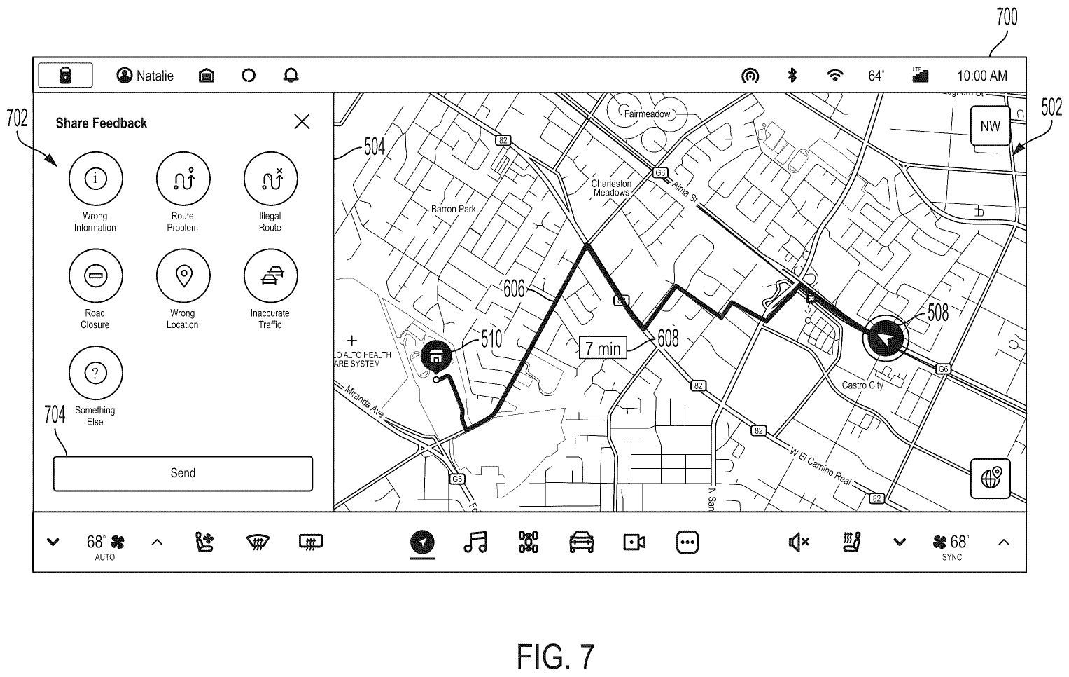

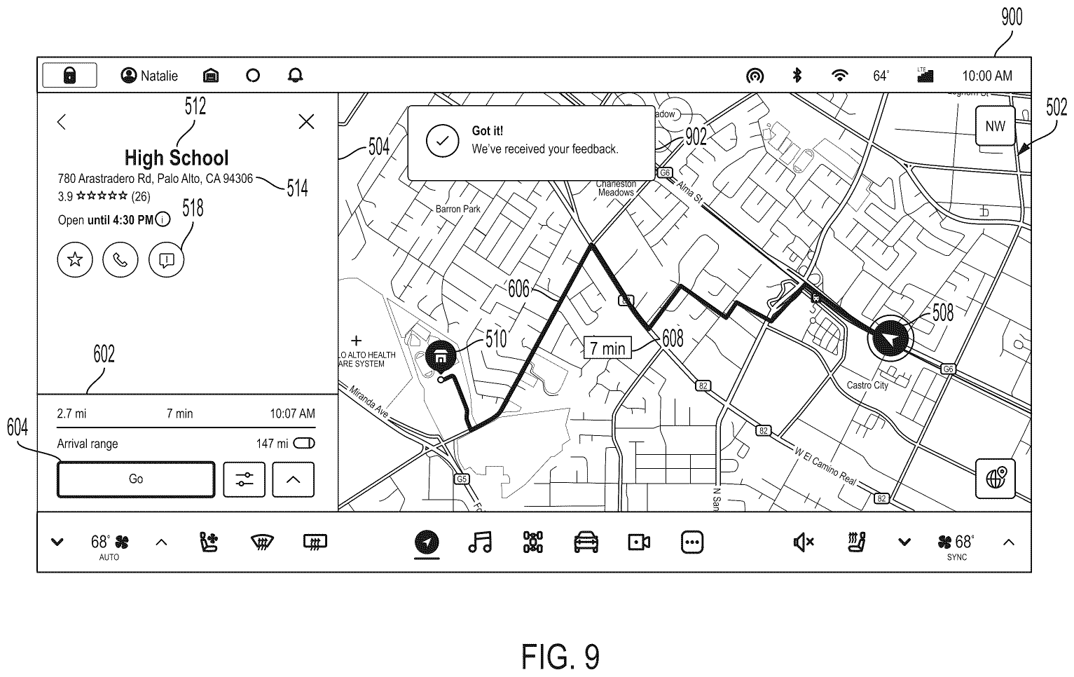

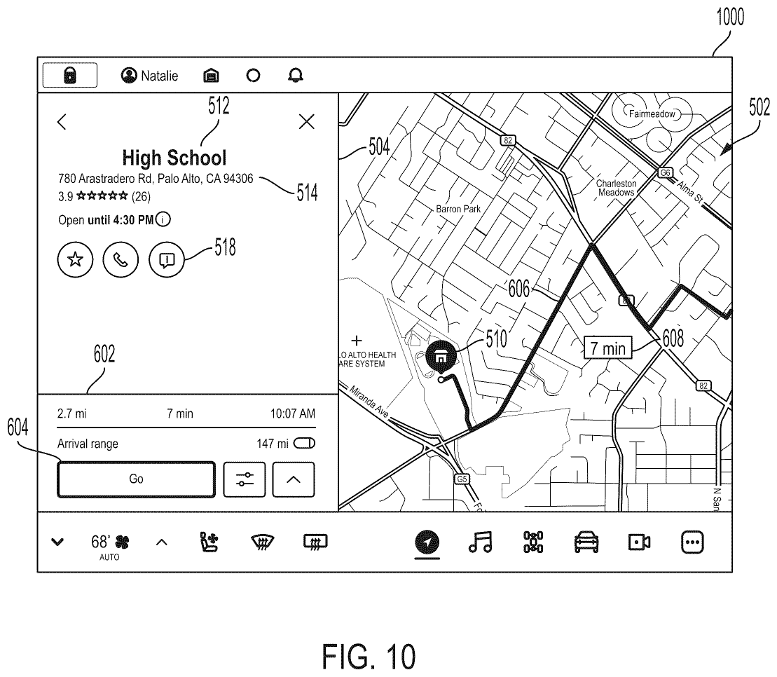

FIGS. 5-10 depict example user interfaces 500-1000 illustrating a sequence for providing feedback for a point of interest loading state of an application, in accordance with present implementations. A data processing system (e.g., the data processing system 204, shown and described with reference to FIG. 2, a client device, a computer, or a plurality of computers) can generate or update the user interfaces 500-1000. The user interfaces 500-1000 can be displayed on a display of an electric vehicle or a display on a computing device. The data processing system can execute an application to generate, present, or update the user interfaces 500-1000. A user driving a vehicle (e.g., an electric vehicle) can view the user interfaces 500-1000 (e.g., on a display of the vehicle) to provide feedback regarding performance of the application when generating a route to a destination.

For example, the user interface 500 can include a map 502 and a tab 504. The map 502 can include an overhead view of the area surrounding a vehicle (e.g., the vehicle in which the user interface 500 is being displayed). The map 502 can include a vehicle indicator 508 that displays a location of the vehicle on the map 502. The vehicle indicator 508 can be or include an arrow indicating a direction in which the vehicle is facing and/or a direction in which the vehicle is traveling. The map 502 can include a point of interest indicator 510 that displays a location of a point of interest (e.g., a location relative to the vehicle or in the geographic area depicted by the map 502). The user of the vehicle can request (e.g., via input into the user interface 500) a route for the vehicle to travel to the location of interest as a destination. Responsive to the request, the application can present the tab 504.

The tab 504 can include information about the point of interest as well as the state of the application. For example, the tab 504 can include an identifier 512 (e.g., a name) of the point of interest, information about the point of interest 514, an indication 516 that the state of the application is calculating a route to the point of interest as a destination, and a prompt 518. The identifier 512 can be a text string identifying the point of interest for which the application is generating a route. The information about the point of interest 514 can include information such as the address of the point of interest, ratings, a number of reviews about the point of interest, or a range of times in which the point of interest is open. The indication 516 can be a string of text indicating that the application is calculating a route to the point of interest. The data processing system can present the indication 516 subsequent to receiving an input requesting the route. The prompt 518 can be a virtual button, an element, or a graphical icon that can be selected for the user to view options for providing feedback regarding performance of the application.

The user interface 600 can be or include an updated version of the user interface 500. The user interface 600 can include the same or similar elements to the user interface 500. The data processing system can present the user interface 600 responsive to generating a route to a point of interest (e.g., the point of interest represented by the point of interest indicator 510 on the map 502). The user interface 600 can include route information 602 and a submit button 604 in the tab 504. The route information 602 can include information about the route for the vehicle to travel to reach the point of interest. The route information 602 can include a total distance of the route, a length of time of the route, a time of arrival of the route, and a predicted battery capacity of the battery of the vehicle upon arriving at the point of interest. The submit button 604 can include a button (e.g., a virtual button) that can be selected to initiate for the application to generate instructions for traveling to the point of interest. The map 502 can include a depiction 606 of the route and an indication of the length of time of the route.

The user interface 700 can be or include an updated version of the user interfaces 500 or 600. The user interface 700 can include the same or similar elements to the user interfaces 500 or 600. The data processing system can present the user interface 700 responsive to the user of the vehicle selecting the prompt 518 from the user interfaces 500 or 600. The user interface 700 can include options 702 (e.g., a set of options) and a submit button 704. The options 702 are depicted as including wrong information, route problem, illegal route, road closure, wrong location, inaccurate traffic, and something else, although the options 702 can include any type of option. The options 702 can be options for different types of feedback regarding the performance of the application. The data processing system can select the options 702 based on the state of the application or other types of data, such as sensor data regarding the surrounding environment, the state of the vehicle, or the current or predicted state of the battery powering the vehicle. The user can select one or more of the options 702 and select the submit button 704 to cause the data processing system to transmit the selected options (e.g., transmit identifications of the selected options) to a remote computing device for further processing (e.g., for mitigating any negative feedback for the application or the same application operating across vehicles).

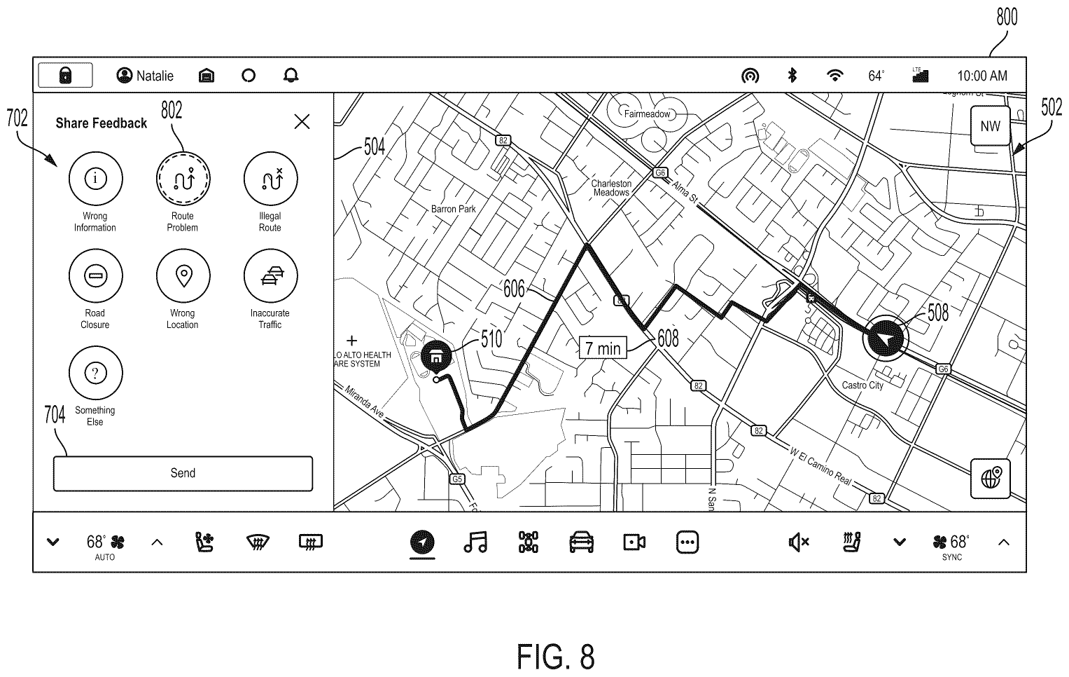

For example, as depicted in FIG. 8, the user interface 800 shows a selected option 802. The user can select the selected option 802 and select the submit button 704 to cause the data processing system to transmit an indication of the selected option 802 to a remote computing device. Responsive to transmitting the indication of the selected option 802, the data processing system can present the user interface 900. The user interface 900 can be similar to the user interface 600, but display a graphic or element 902 indicating that the transmission of the feedback from the user interface 700 or 800 was successful. The data processing system can present the user interface 800 for a time period (e.g., a predetermined or defined time period) until causing the graphic or element 902 to disappear, resulting in the user interface 1000.

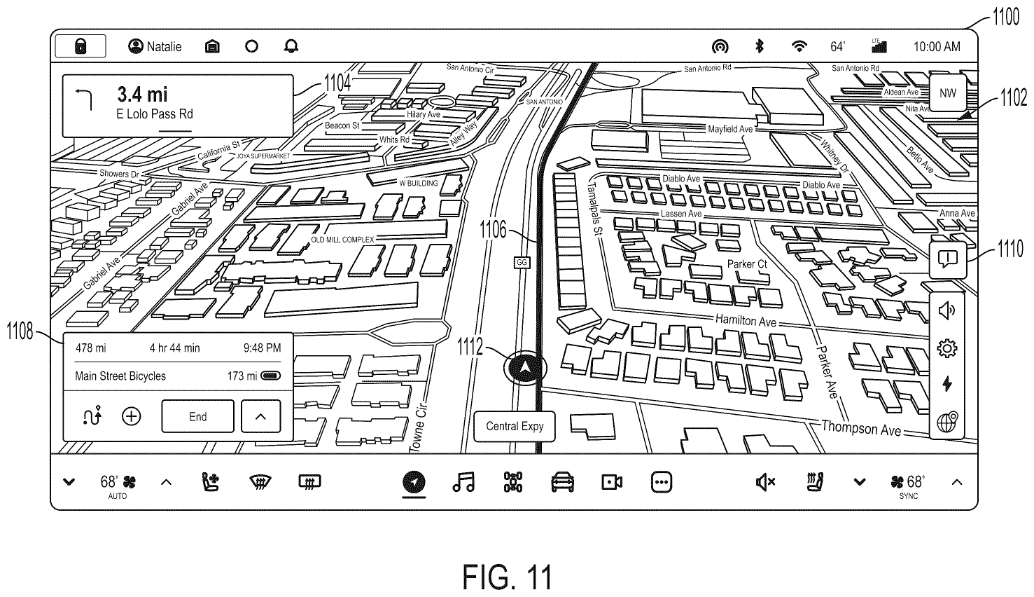

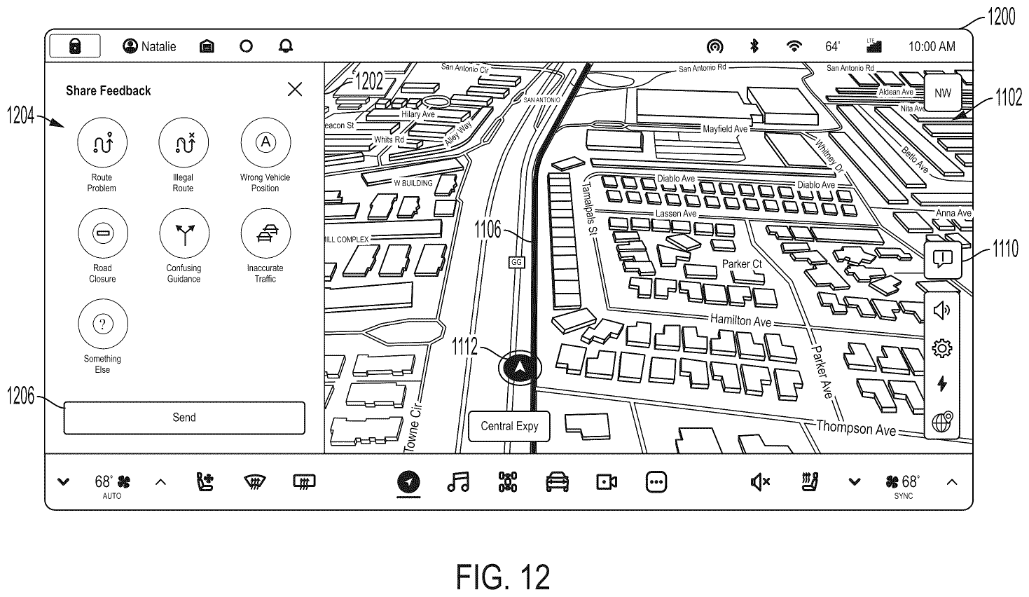

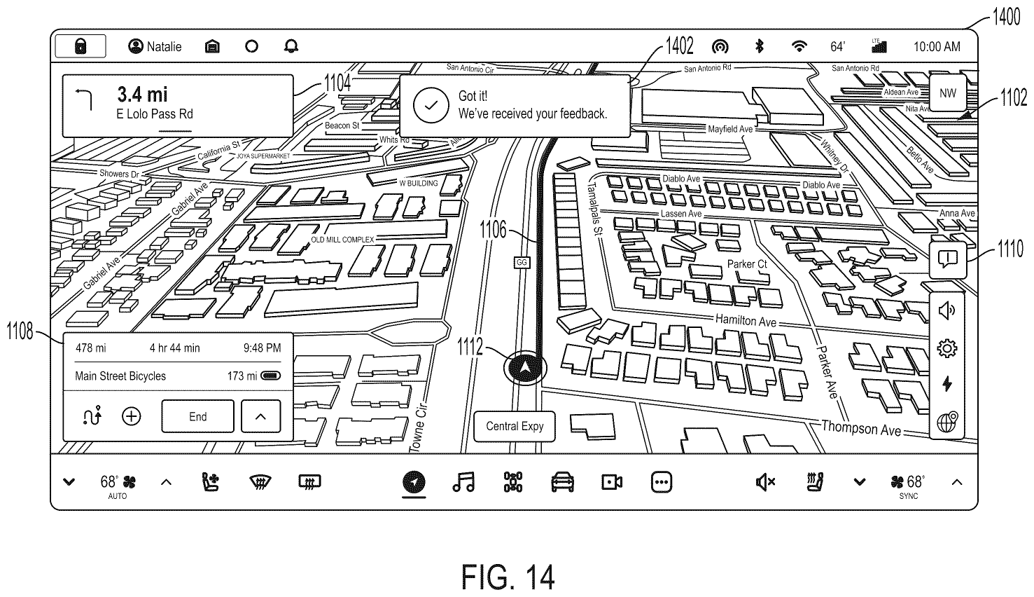

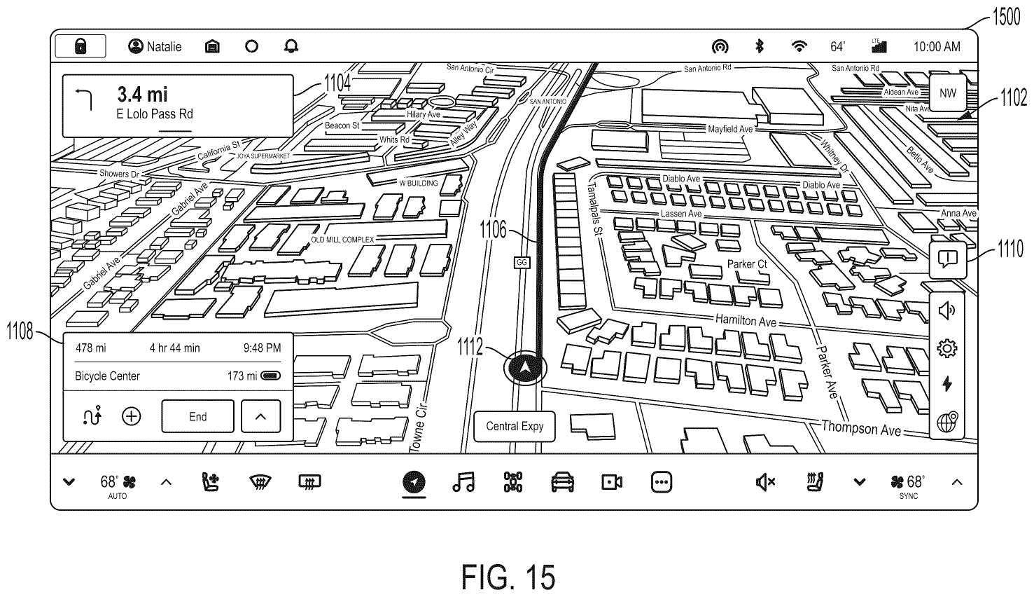

FIGS. 11-15 depict example user interfaces 1100-1500 illustrating a sequence for providing feedback for a navigation state of an application, in accordance with present implementations. A data processing system (e.g., the data processing system 204, shown and described with reference to FIG. 2, a client device, a computer, or a plurality of computers) can generate or update the user interfaces 1100-1500. The user interfaces 1100-1500 can be displayed on a display of an electric vehicle or a display on a computing device. The data processing system can execute an application to generate, present, or update the user interfaces 1100-1500. A user driving a vehicle (e.g., an electric vehicle) can view the user interfaces 1100-1500 (e.g., on a display of the vehicle) to provide feedback regarding performance of the application when generating instructions for a vehicle to reach a destination.

For example, the user interface 1100 can include a map 1102, navigation instructions 1104, a route 1106, route details 1108, a prompt 1110, and a vehicle indicator 1112. The map 1102 can include an overhead view of the area surrounding a vehicle (e.g., the vehicle in which the user interface 1100 is being displayed). The map 1102 can include the route 1106 and the vehicle indicator 1112. The vehicle indicator 1112 can display a location of the vehicle on the map 1102. The vehicle indicator 1112 can be or include an arrow indicating a direction in which the vehicle is facing and/or a direction in which the vehicle is traveling. The route 1106 can depict a path for the vehicle to travel to reach a destination. The navigation instructions 1104 can include text and visual instructions for the next action to take in following the route 1106. The route details 1108 can include about the route 1106, such as a total distance left until reaching the destination, a time until reaching the destination, a predicted time of arrival at the destination, a predicted charge capacity of the battery of the vehicle upon arrival at the destination, and a name or identifier of the destination. The prompt 1110 can be or include a button (e.g., a virtual button), an element, an icon, or a graphic that can be selected to facilitate the user providing feedback regarding performance of the application.

Responsive to selection of the prompt 1110, the data processing system can generate or present the user interface 1200. The user interface 1200 can be or include an updated version of the user interface 1100. The user interface 1200 can include the same or similar elements to the user interface 1100. The data processing system can present the user interface 1200 responsive to the user of the vehicle selecting the prompt 1110 from the user interface 1100. The user interface 1200 can include a tab 1202. The tab 1202 can include options 1204 (e.g., a set of options) and a submit button 1206. The options 1204 are depicted as including route problem, illegal route, wrong vehicle position, road closure, confusing guidance, inaccurate traffic, and something else, although the options 1204 can include any type of option. The options 1204 can be options for different types of feedback regarding the performance of the application. The data processing system can select the options 1204 based on the state of the application or other types of data, such as sensor data regarding the surrounding environment, the state of the vehicle, or the current or predicted state of the battery powering the vehicle. The user can select one or more of the options 1204 and select the submit button 1206 to cause the data processing system to transmit the selected options (e.g., transmit identifications of the selected options) to a remote computing device for further processing (e.g., for mitigating any negative feedback for the application or the same application operating across vehicles).

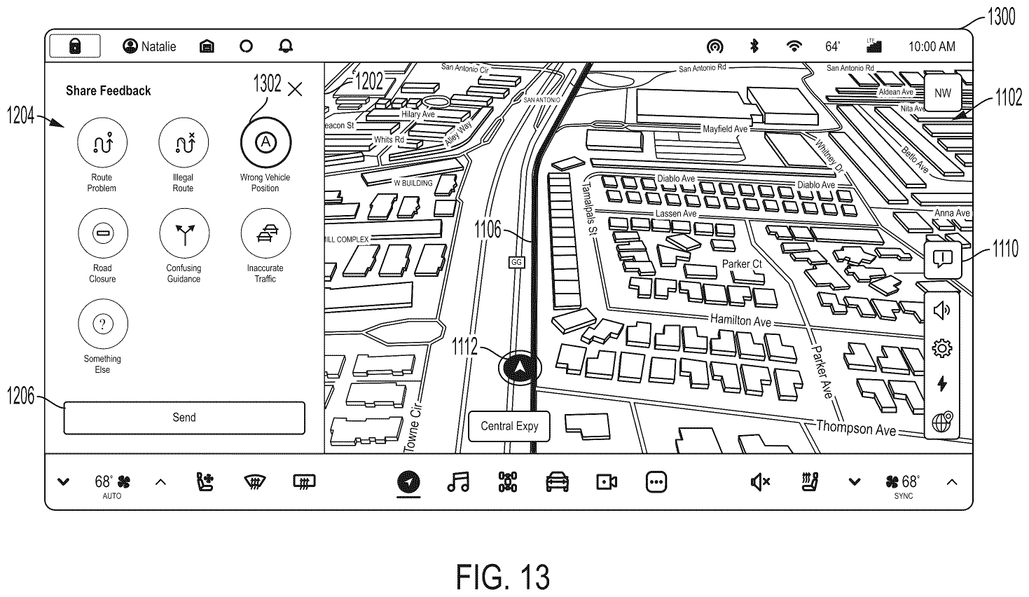

For example, as depicted in FIG. 13, the user interface 1300 shows a selected option 1302. The user can select the selected option 1302 and select the submit button 1206 to cause the data processing system to transmit an indication of the selected option 1302 to a remote computing device. Responsive to transmitting the indication of the selected option 1302, the data processing system can present the user interface 1400. The user interface 1300 can be similar to the user interface 1100, but display a graphic or element 1402 indicating that the transmission of the feedback from the user interface 1200 or 1300 was successful. The data processing system can present the user interface 1400 for a time period (e.g., a predetermined or defined time period) until causing the graphic or element 1402 to disappear, resulting in the user interface 1500.

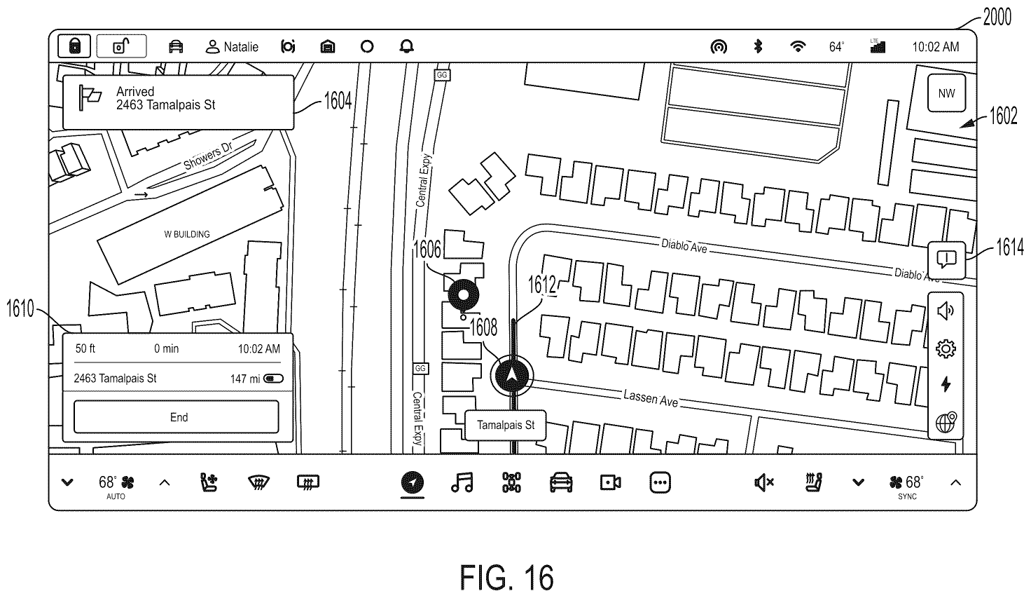

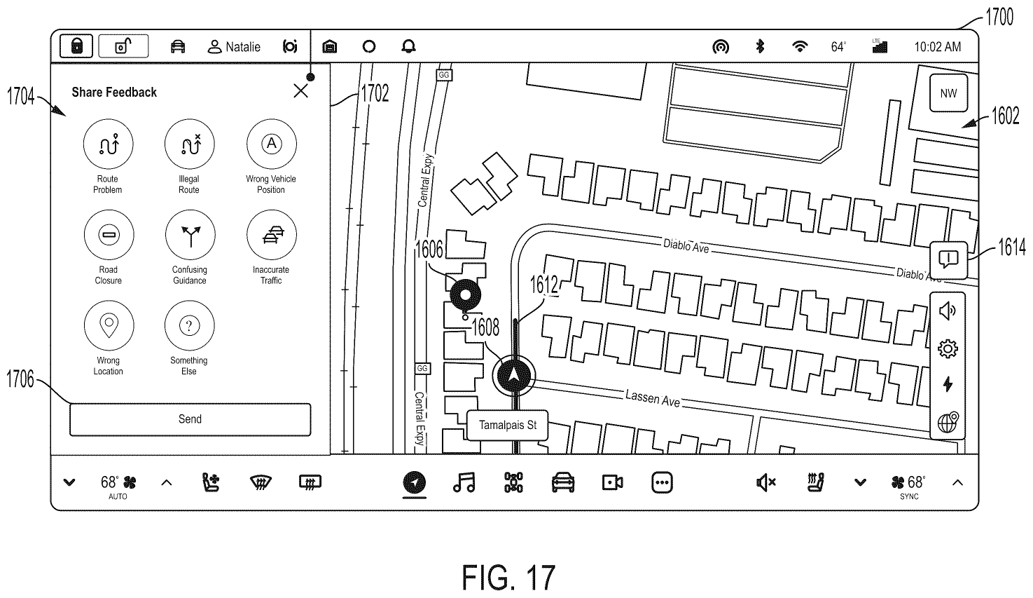

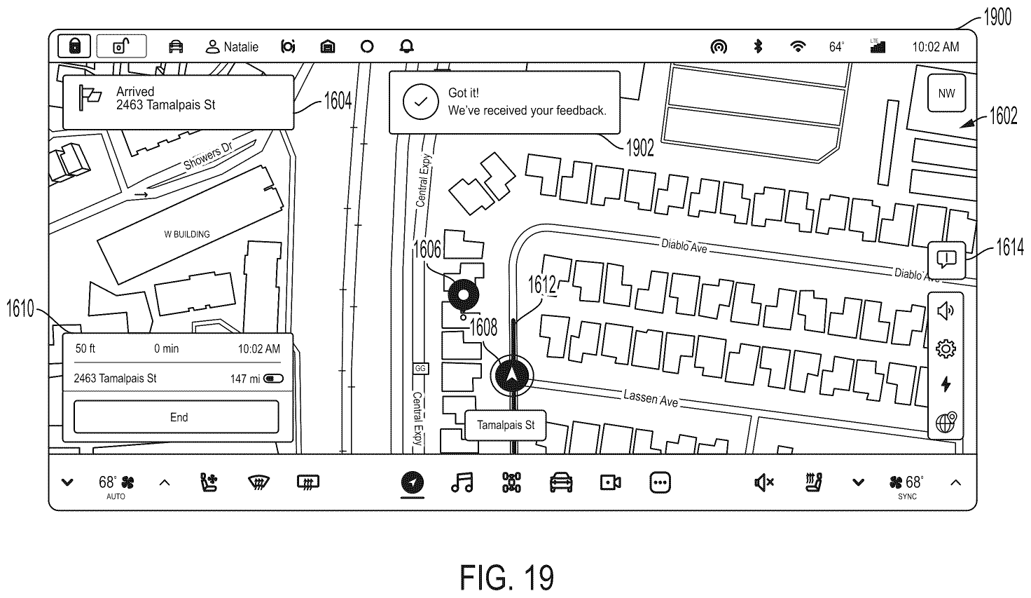

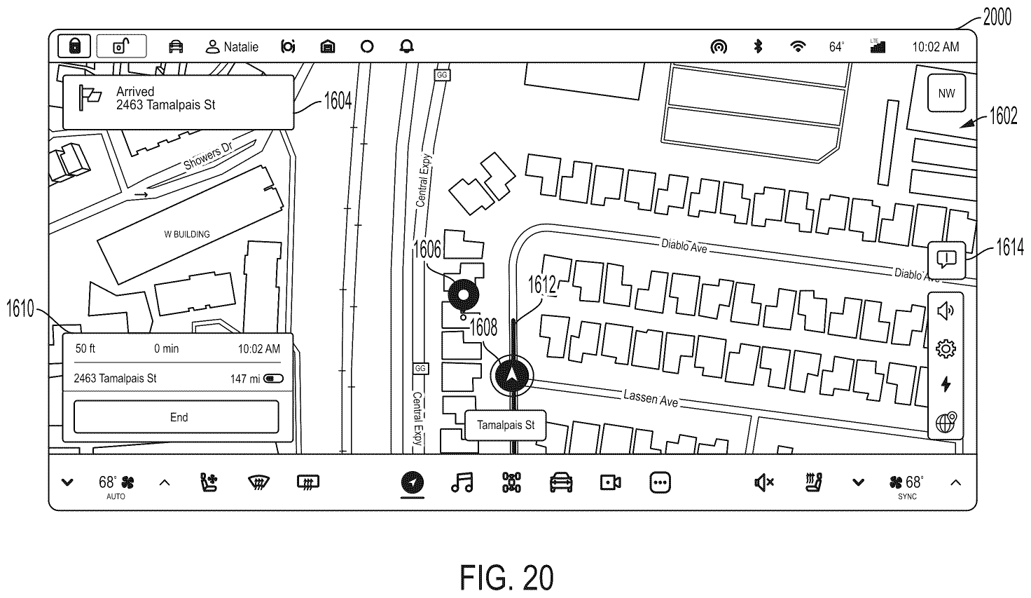

FIGS. 16-20 depict example user interfaces 1600-2000 illustrating a sequence for providing feedback for an arrival state of an application, in accordance with present implementations. A data processing system (e.g., the data processing system 204, shown and described with reference to FIG. 2, a client device, a computer, or a plurality of computers) can generate or update the user interfaces 1600-2000. The user interfaces 1600-2000 can be displayed on a display of an electric vehicle or a display on a computing device. The data processing system can execute an application to generate, present, or update the user interfaces 1600-2000. A user driving a vehicle (e.g., an electric vehicle) can view the user interfaces 1600-2000 (e.g., on a display of the vehicle) to provide feedback regarding performance of the application after the vehicle arrives at a destination for which the application was generating instructions for the vehicle to reach.

For example, the user interface 1600 can include a map 1602, an arrival indication 1604, a destination indication 1606, a vehicle indicator 1608, arrival details 1610, a route 1612, route details 1108, and a prompt 1614. The map 1602 can include an overhead view of the area surrounding a vehicle (e.g., the vehicle in which the user interface 1100 is being displayed). The map 1602 can include the vehicle indicator 1608, the destination indication 1606, and the route 1612. The vehicle indicator 1608 can display a location of the vehicle on the map 1602. The vehicle indicator 1608 can be or include an arrow indicating a direction in which the vehicle is facing and/or a direction in which the vehicle is traveling. The route 1612 can depict a path for the vehicle to travel to reach the destination. The destination indication 1606 can indicate the location of the destination to which the data processing system was navigating the vehicle.

The arrival indication 1604 can include text and/or a visual indication that corresponds to the vehicle arriving at the destination. The arrival details 1610 can include details about the route 1612, such as a total distance left until reaching the destination, a time until reaching the destination, a predicted time of arrival at the destination, a predicted charge capacity of the battery of the vehicle upon arrival at the destination, and a name or identifier of the destination. The prompt 1614 can be or include a button (e.g., a virtual button), an element, an icon, or a graphic that can be selected to facilitate the user providing feedback regarding performance of the application in the arrival state.

Responsive to selection of the prompt 1614, the data processing system can generate or present the user interface 1700. The user interface 1700 can be or include an updated version of the user interface 1600. The user interface 1700 can include the same or similar elements to the user interface 1600. The data processing system can present the user interface 1700 responsive to the user of the vehicle selecting the prompt 1614 from the user interface 1100. The user interface 1700 can include a tab 1702. The tab 1702 can include options 1704 (e.g., a set of options) and a submit button 1706. The options 1704 are depicted as including route problem, illegal route, wrong vehicle position, road closure, confusing guidance, inaccurate traffic, wrong location, and something else, although the options 1704 can include any type of option.

The options 1704 can be options for different types of feedback regarding the performance of the application. The data processing system can select the options 1704 based on the state of the application or other types of data, such as sensor data regarding the surrounding environment, the state of the vehicle, or the current or predicted state of the battery powering the vehicle. The user can select one or more of the options 1704 and select the submit button 1706 to cause the data processing system to transmit the selected options (e.g., transmit identifications of the selected options) to a remote computing device for further processing (e.g., for mitigating any negative feedback for the application or the same application operating across vehicles).

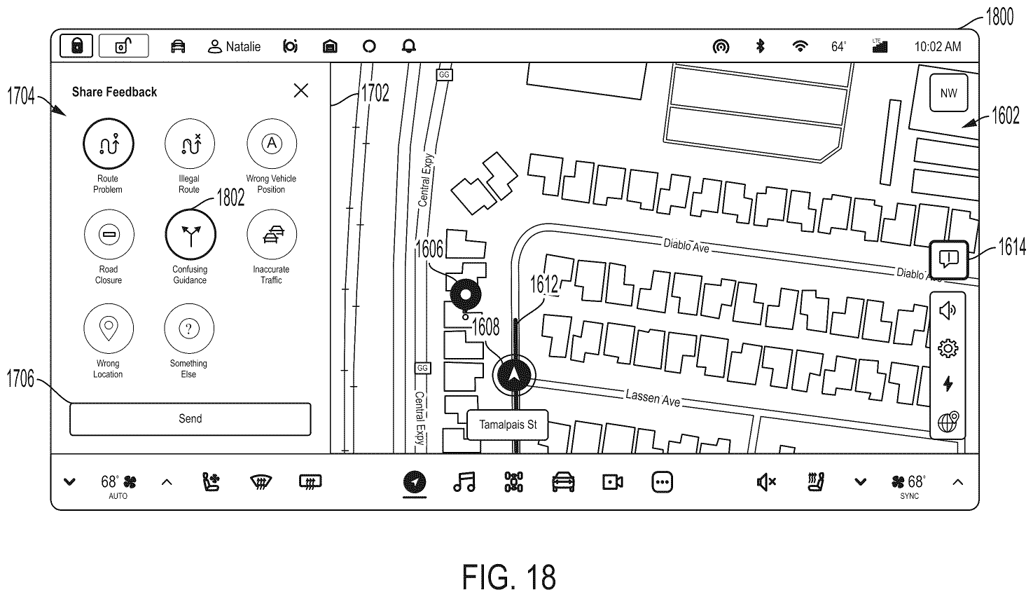

For example, as depicted in FIG. 18, the user interface 1800 shows a selected option 1802. The user can select the selected option 1802 and select the submit button 1706 to cause the data processing system to transmit an indication of the selected option 1802 to a remote computing device. Responsive to transmitting the indication of the selected option 1802, the data processing system can present the user interface 1900. The user interface 1900 can be similar to the user interface 1100, but display a graphic or element 1902 indicating that the transmission of the feedback from the user interface 1700 or 1800 was successful. The data processing system can present the user interface 1900 for a time period (e.g., a predetermined or defined time period) until causing the graphic or element 1902 to disappear, resulting in the user interface 2000.

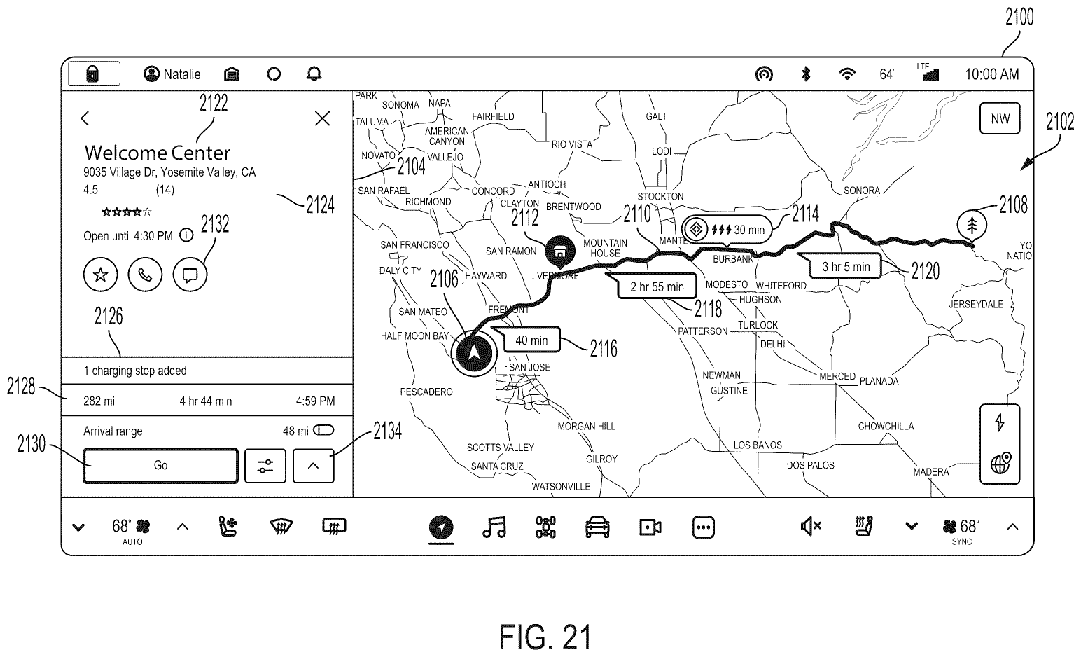

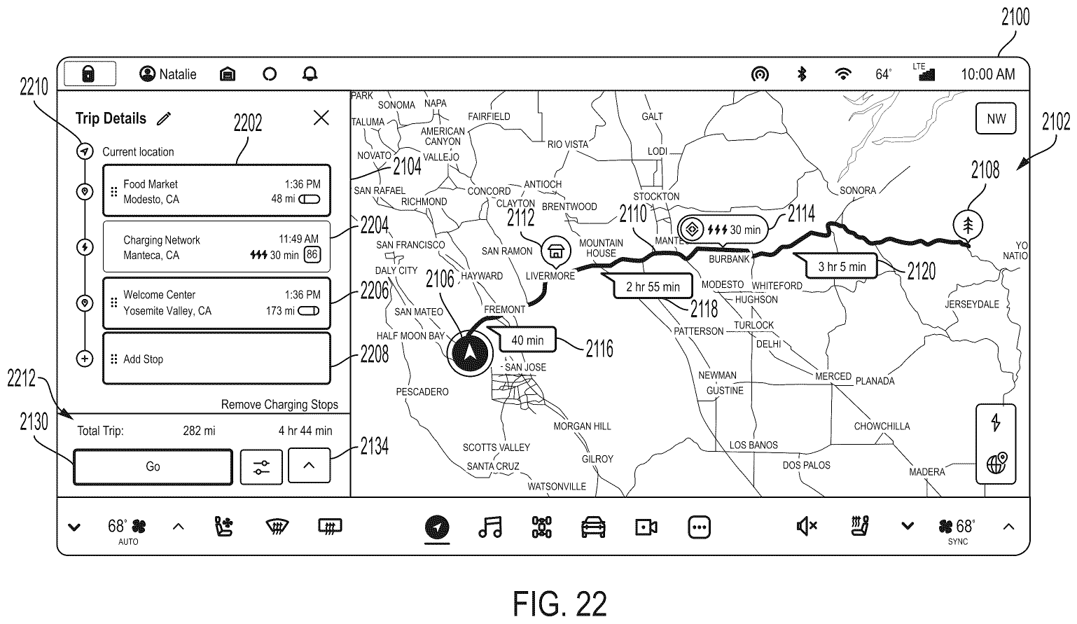

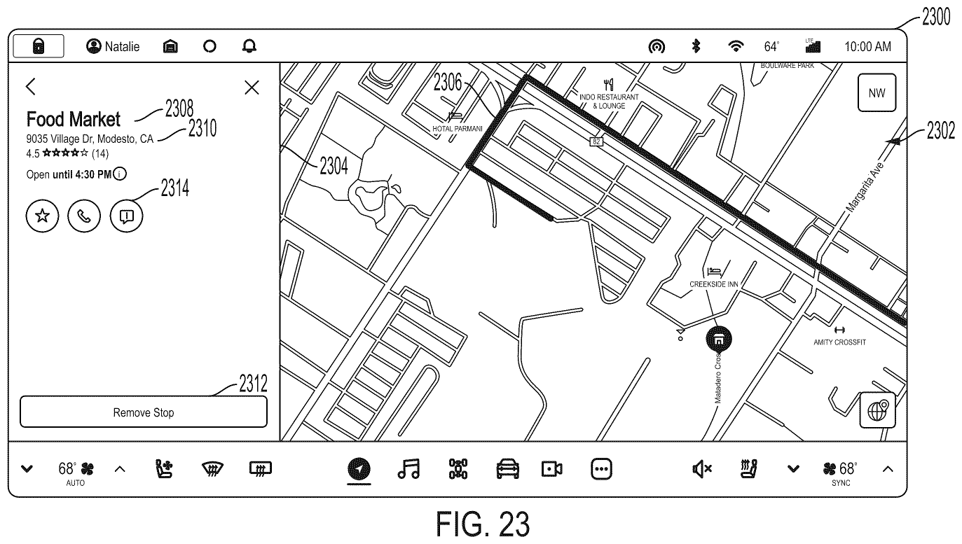

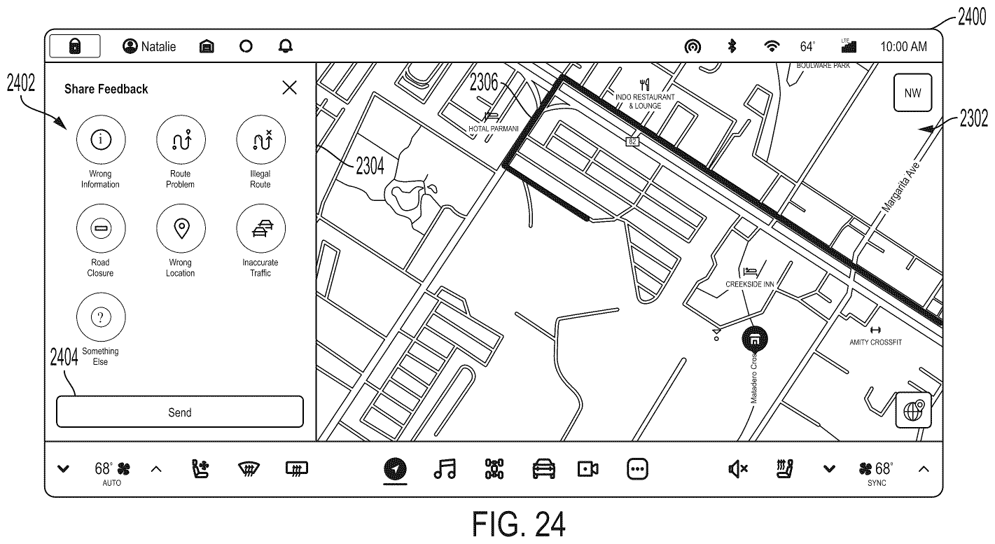

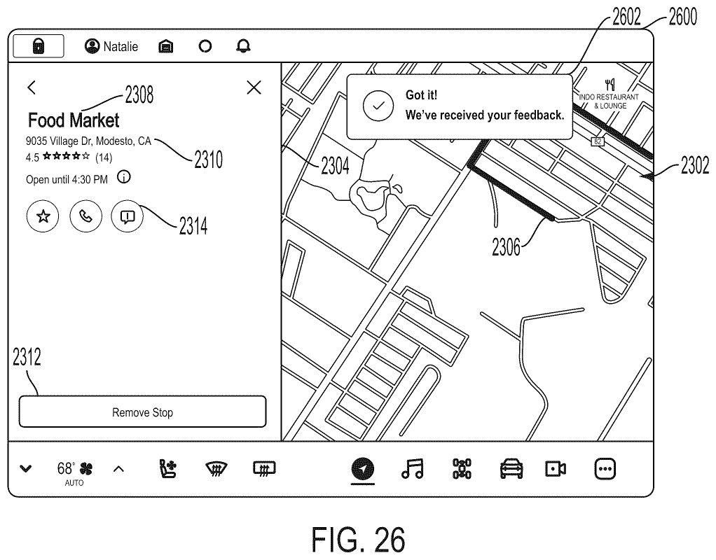

FIGS. 21-26 depict example user interfaces 2100-2600 illustrating a sequence for providing feedback for a point of interest state of an application, in accordance with present implementations. A data processing system (e.g., the data processing system 204, shown and described with reference to FIG. 2, a client device, a computer, or a plurality of computers) can generate or update the user interfaces 2100-2600. The user interfaces 2100-2600 can be displayed on a display of an electric vehicle or a display on a computing device. The data processing system can execute an application to generate, present, or update the user interfaces 2100-2600. A user driving a vehicle (e.g., an electric vehicle) can view the user interfaces 2100-2600 (e.g., on a display of the vehicle) to provide feedback regarding performance of the application after the vehicle arrives at a destination for which the application was generating instructions for the vehicle to reach.

For example, the user interface 2100 can include a map 2102 and a tab 2104. The map 2102 can include an overhead view of the area surrounding a vehicle (e.g., the vehicle in which the user interface 2100 is being displayed). The map 2102 can include a vehicle indicator 2106 that displays a location of the vehicle on the map 2102. The vehicle indicator 2168 can be or include an arrow indicating a direction in which the vehicle is facing and/or a direction in which the vehicle is traveling. The map 2102 can include a point of interest indicator 2108 that displays a location of a point of interest (e.g., a location relative to the vehicle or in the geographic area depicted by the map 2102). The user of the vehicle can request (e.g., via input into the user interface 2100) a route for the vehicle to travel to the location of interest as a destination. Responsive to the request, the application can present the tab 2104.

The map 2102 can include other information about the route to the destination. For example, the map 2102 can include a depiction 2110 of the route that illustrates the roads of the route. The map 2102 can also include identifications 2112 and 2114 of points of interest on the route to the destination. In one example, the identification 2114 can be an indication of a charging stop at which the application determines for the vehicle to stop to have enough energy to complete the route or complete the route with at least a threshold amount of energy. The map 2102 can also include time stamps 2116, 2118, and 2120 indicating the amount of time it will take the vehicle to reach different points on the route.

The tab 2104 can include information about the point of interest as well as the state of the application. For example, the tab 2104 can include an identifier 2122 (e.g., a name) of the point of interest, information about the point of interest 2124, an indication 2126 of the number of charging stops on the route, and information 2128 regarding the route, a submit button 2130, a prompt 2132, and a point of interest details button 2134. The identifier 2122 can be a text string identifying the point of interest for which the application is generating a route. The information about the point of interest 2124 can include information such as the address of the point of interest, ratings, a number of reviews about the point of interest, or a range of times in which the point of interest is open. The indication 2126 can indicate a total number of charging stop on the route. The information 2128 regarding the route can include one or more data points about the route, such as a total distance left until reaching the destination, a time until reaching the destination, a predicted time of arrival at the destination, a predicted charge capacity of the battery of the vehicle upon arrival at the destination, and a name or identifier of the destination. The submit button 2130 can include a button (e.g., a virtual button) that can be selected to initiate for the application to generate instructions for traveling to the point of interest. The prompt 2132 can be or include a button (e.g., a virtual button), an element, an icon, or a graphic that can be selected to facilitate the user providing feedback regarding performance of the application. The points of interest details button 2134 can be or include a button that can be selected to view details regarding the different points of interest along the route to the destination, which can include the destination itself.

The user interface 2200 can be or include an updated version of the user interface 2100. The user interface 2200 can include the same or similar elements to the user interface 2100. The data processing system can present the user interface 2200 responsive to selection of the points of interest details button 2134. The user interface 2200 can include details about different points of interest along the route to the destination in the tab 2104. For example, the user interface 2200 can include a list of points of interest on the route to the destination. The list can include one or more graphics or icons 2202, 2204, and 2206 that correspond to different points of interest along the route to the destination. Each icon or graphic can include information about the route to the respective points of interest, such as name, time of arrival, location, and predicted state of charge upon arrival at the point of interest. The user interface 2200 can include point of interest type identifications 2210 next to or adjacent to (e.g., in parallel with or on the same horizontal line with) with respective points of interest that indicate the type of the points of interest. Examples of types can include building, current location, and charging station. The user interface 2200 can also include a graphic 2208 that can be selected to add a stop or add a point of interest to the route. The user interface 2200 can additionally include details 2212 about the trip, such as a total distance of the trip and a total amount of time the trip will take.

Responsive to a selection of one of the graphics or icons 2202-2206, the data processing system can present information about the corresponding point of interest to the selected graphic or icon 2202-2206. For example, responsive to a selection of the graphic or icon 2202, the data processing system can present the user interface 2300. The user interface 2300 can be or include an updated version of the user interface 2100 or 2200. The user interface 2300 can include a map 2302 and a tab 2304. The map 2302 can include an overhead view of the area around the point of interest that corresponds to the selected graphic or icon 2202. The map 2302 can also include a route 2306 for reaching the selected point of interest.

The tab 2304 can include information about the point of interest. For example, the tab 2304 can include an identifier 2308 (e.g., a name) of the point of interest, information about the point of interest 2310, a remove point of interest button 2312, and a prompt 2314. The identifier 2308 can be a text string identifying the point of interest that corresponds to the selected graphic or icon 2202. The information about the point of interest 2310 can include information such as the address of the point of interest, ratings, a number of reviews about the point of interest, or a range of times in which the point of interest is open. Selection of the remove point of interest button 2312 can remove the point of interest from the user interface 2200. The prompt 2314 can be a virtual button, an element, or a graphical icon that can be selected for the user to view options for providing feedback regarding performance of the application.

The user interface 2400 can be or include an updated version of the user interface 2300. The user interface 2400 can include the same or similar elements to the user interfaces 2300. The data processing system can present the user interface 2400 responsive to the user of the vehicle selecting the prompt 2314 from the user interface 2300. The user interface 2400 can include options 2402 (e.g., a set of options) and a submit button 2404. The options 2402 are depicted as including wrong information, route problem, illegal route, road closure, wrong location, inaccurate traffic, and something else, although the options 2402 can include any type of option. The options 2402 can be options for different types of feedback regarding the performance of the application. The data processing system can select the options 2402 based on the state of the application or other types of data, such as sensor data regarding the surrounding environment, the state of the vehicle, or the current or predicted state of the battery powering the vehicle. The user can select one or more of the options 2402 and select the submit button 2404 to cause the data processing system to transmit the selected options (e.g., transmit identifications of the selected options) to a remote computing device for further processing (e.g., for mitigating any negative feedback for the application or the same application operating across vehicles).

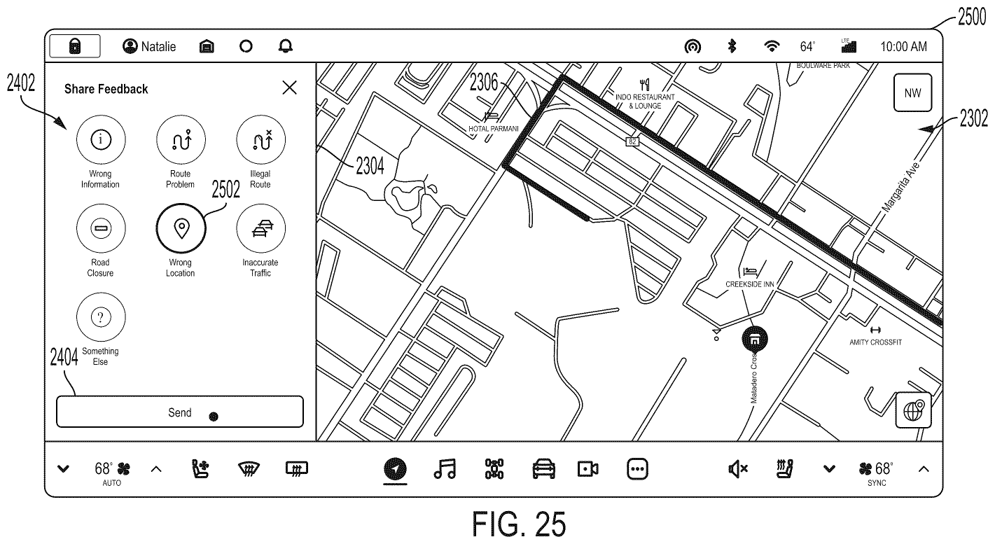

For example, as depicted in FIG. 25, the user interface 2500 shows a selected option 2502. The user can select the selected option 2502 and select the submit button 2404 to cause the data processing system to transmit an indication of the selected option 2502 to a remote computing device. Responsive to transmitting the indication of the selected option 2502, the data processing system can present the user interface 2600. The user interface 2600 can be similar to the user interface 2300, but display a graphic or element 2602 indicating that the transmission of the feedback from the user interface 2400 or 2500 was successful. The data processing system can present the user interface 2600 for a time period (e.g., a predetermined or defined time period) until causing the graphic or element 2602 to disappear.

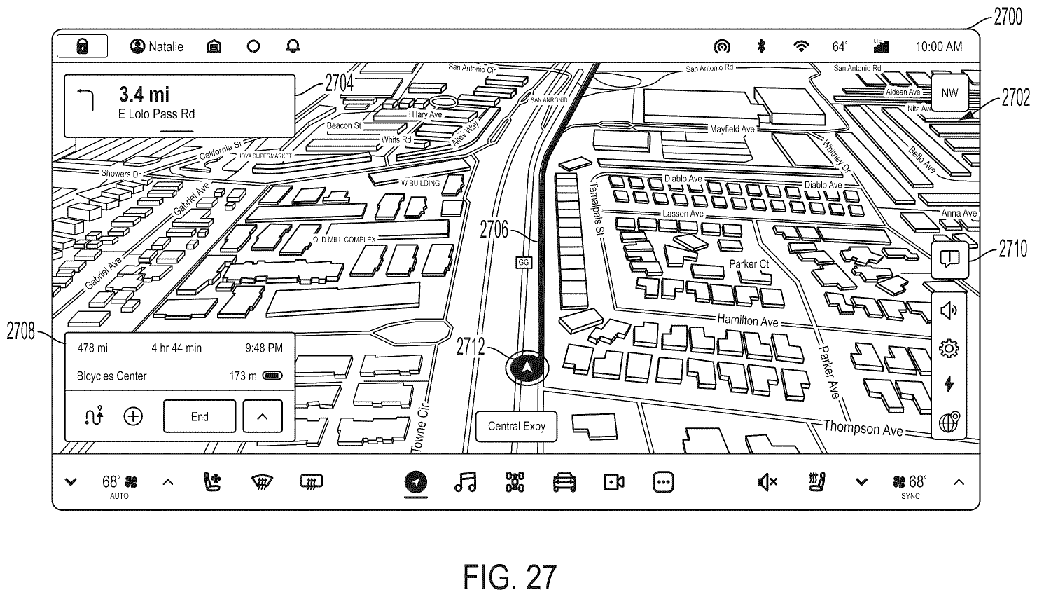

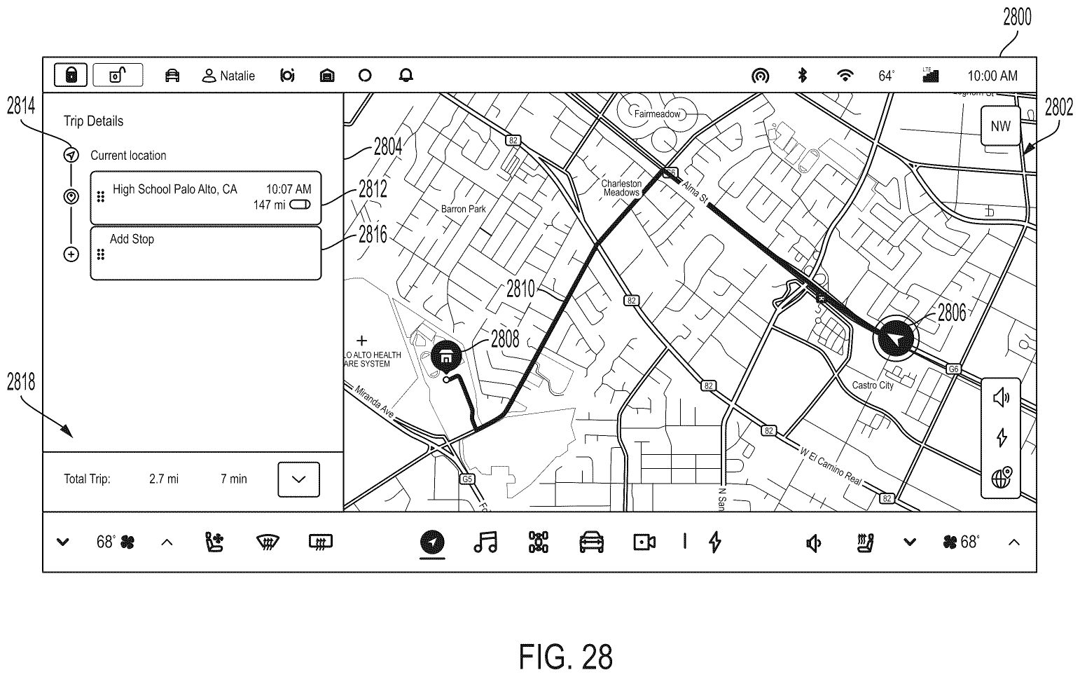

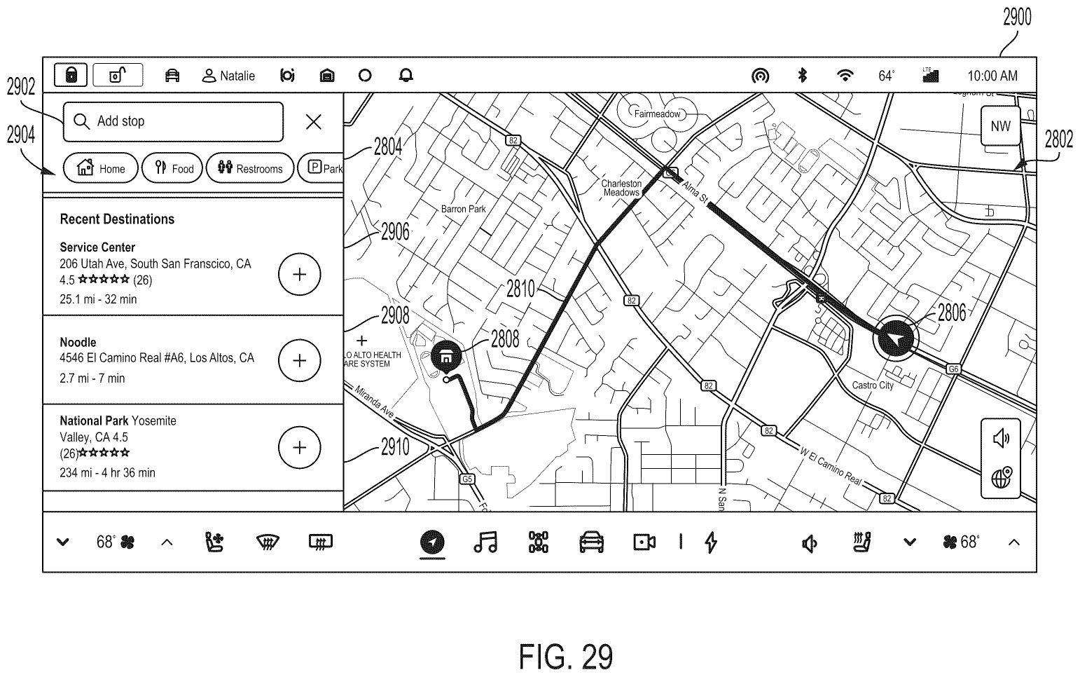

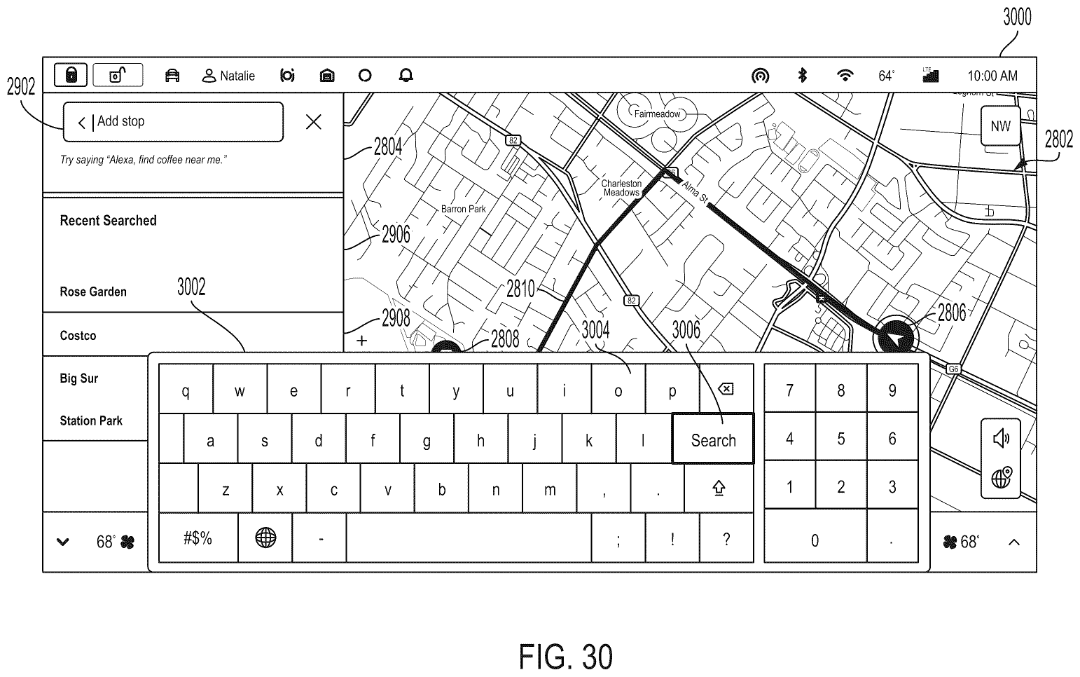

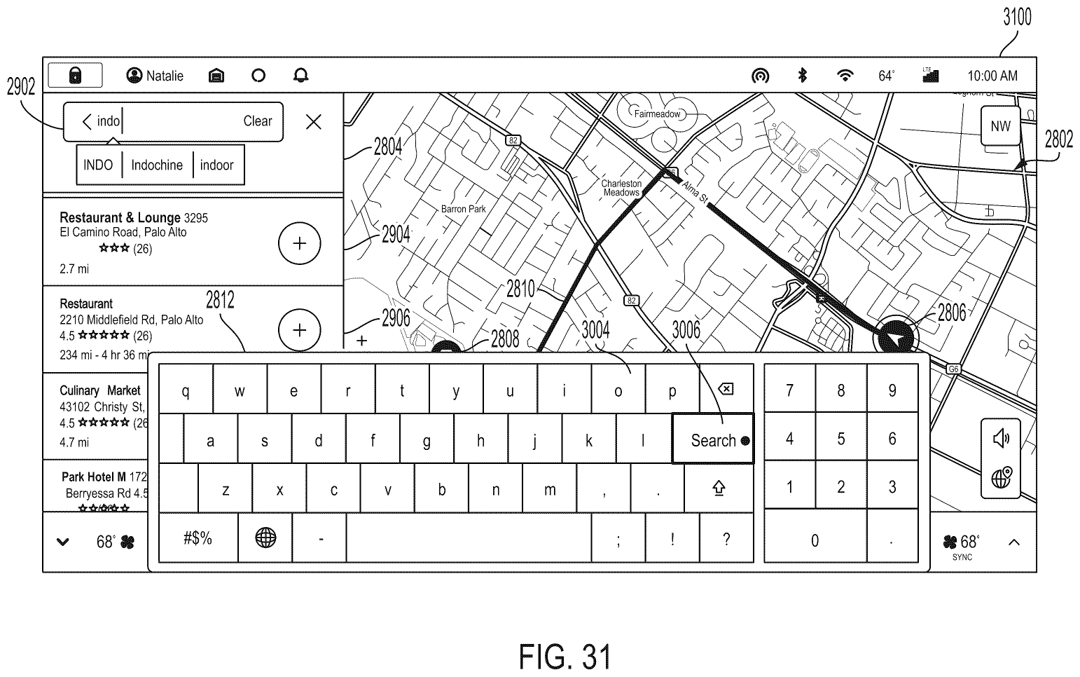

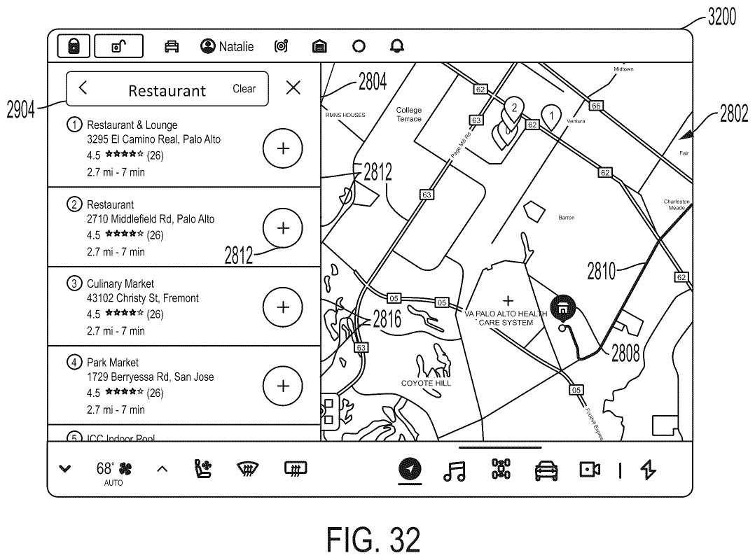

FIGS. 27-32 depict example user interfaces 2700-3200 illustrating a sequence for providing feedback for searching state of an application, in accordance with present implementations. A data processing system (e.g., the data processing system 204, shown and described with reference to FIG. 2, a client device, a computer, or a plurality of computers) can generate or update the user interfaces 2700-3200. The user interfaces 2700-3200 can be displayed on a display of an electric vehicle or a display on a computing device. The data processing system can execute an application to generate, present, or update the user interfaces 2700-3200. A user driving a vehicle (e.g., an electric vehicle) can view the user interfaces 2700-3200 (e.g., on a display of the vehicle) to provide feedback regarding performance of the application when generating instructions for a vehicle to reach a destination.

For example, the user interface 2700 can include a map 2702, navigation instructions 2704, a route 2706, route details 2708, a trip details button 2710, and a vehicle indicator 2712. The map 2702 can include an overhead view of the area surrounding a vehicle (e.g., the vehicle in which the user interface 2700 is being displayed). The map 2702 can include the route 2706 and the vehicle indicator 2712. The vehicle indicator 2712 can display a location of the vehicle on the map 2702. The vehicle indicator 2712 can be or include an arrow indicating a direction in which the vehicle is facing and/or a direction in which the vehicle is traveling. The route 2706 can depict a path for the vehicle to travel to reach a destination. The navigation instructions 2704 can include text and visual instructions for the next action to take in following the route 2706. The route details 2708 can include about the route 2706, such as a total distance left until reaching the destination, a time until reaching the destination, a predicted time of arrival at the destination, a predicted charge capacity of the battery of the vehicle upon arrival at the destination, and a name or identifier of the destination. The trip details button 2710 can be or include a button (e.g., a virtual button), an element, an icon, or a graphic that can be selected to view information about a trip that the application is navigating for the vehicle.

Responsive to selection of the trip details button 2710, the data processing system can generate or present the user interface 2800. The user interface 2800 can be or include an updated version of the user interface 2800. The user interface 2800 can include a map 2802 and a tab 2804. The map 2802 can include an overhead view of the area surrounding the vehicle. The map 2802 can include a vehicle indicator 2806 that displays a location of the vehicle on the map 2802. The vehicle indicator 2806 can be or include an arrow indicating a direction in which the vehicle is facing and/or a direction in which the vehicle is traveling. The map 2802 can include a point of interest indicator 2808 that displays a location of a point of interest or destination (e.g., a location relative to the vehicle or in the geographic area depicted by the map 502). The map 2802 can include a route 2810 for the vehicle to travel to reach the point of interest.

The user interface 2800 can include details about different points of interest along the route to the destination in the tab 2804. For example, the user interface 2200 can include a list of points of interest on the route to the destination. The list can include one or more icons or graphics 2812 that correspond to different points of interest along the route to the destination. Each icon or graphic can include information about the route to the respective points of interest, such as name, time of arrival, location, and predicted state of charge upon arrival at the point of interest. The user interface 2200 can include point of interest type identifications 2814 next to or adjacent to (e.g., in parallel with or on the same horizontal line with) with respective points of interest that indicate the type of the points of interest. Examples of types can include building, current location, and charging station. The user interface 2800 can also include a graphic 2816 that can be selected to add a stop or add a point of interest to the route. The user interface 2800 can additionally include details 2818 about the trip, such as a total distance of the trip and a total amount of time the trip will take.

Responsive to selection of the graphic 2816, the data processing system can generate or present the user interface 2900. The user interface 2900 can be or include an updated version of the user interface 2800. The user interface 2900 can include a search bar 2902, options 2904 for types of points of interest to search, and recent destinations 2906, 2908, and 2910. A user can provide an input into the search bar 2902 and select an option of the options 2904 to query for a specific point of interest or different types of points of interest. The recent destinations 2906, 2908, and 2910 can be or include a list of previous destinations to which the vehicle has navigated. A user can select the search bar 2902 to cause the data processing system to update the user interface 2900 to the user interface 3000.

The user interface 3000 can include a virtual keyboard 3002. A user can provide input into the virtual keyboard 3002 to input a destination to query for instructions for the application to navigate the vehicle. The virtual keyboard 3002 can include keys, such as a key 3004, and a search button 3006. A user can provide input into the virtual keyboard 3002 and select the search button to search for a destination to which the data processing system can generate and provide instructions.

As the user types into the virtual keyboard 3002, the data processing system can update the user interface 3000. For example, the user can receive an input into the virtual keyboard 3002 to cause the data processing system to update the user interface 3000 to the user interface 3100. The user interface 3100 can include the input text in the search bar 2902 as well as suggested locations with text that matches the input text (e.g., matches to a threshold amount).

The data processing system can present the user interface 3200 responsive to receiving the input text into the search bar 2902. The user interface 3200 can include different possibilities of locations for the data processing system to which the data processing system can provide instructions to travel to a destination.

At any time during searching for a destination (e.g., when the user is inputting the search query, when the data processing system is performing the query, or when the data processing system is displaying the results of the query), the user can select a prompt that corresponds to providing feedback regarding performance of the application. Responsive to receipt of the input, the data processing system can select a set of options that corresponds to different types of feedback regarding performance of the application (e.g., performance of the application in the searching state). The data processing system can select the set of options based on the state of the application (e.g., the application being in the searching state) or any data that the data processing system collects. The data processing system can present the set of options on the user interface (e.g., one of the user interfaces 2700-3200). The data processing system can receive a selection of the one of the set of options and transmit the selection to a remote computing device.

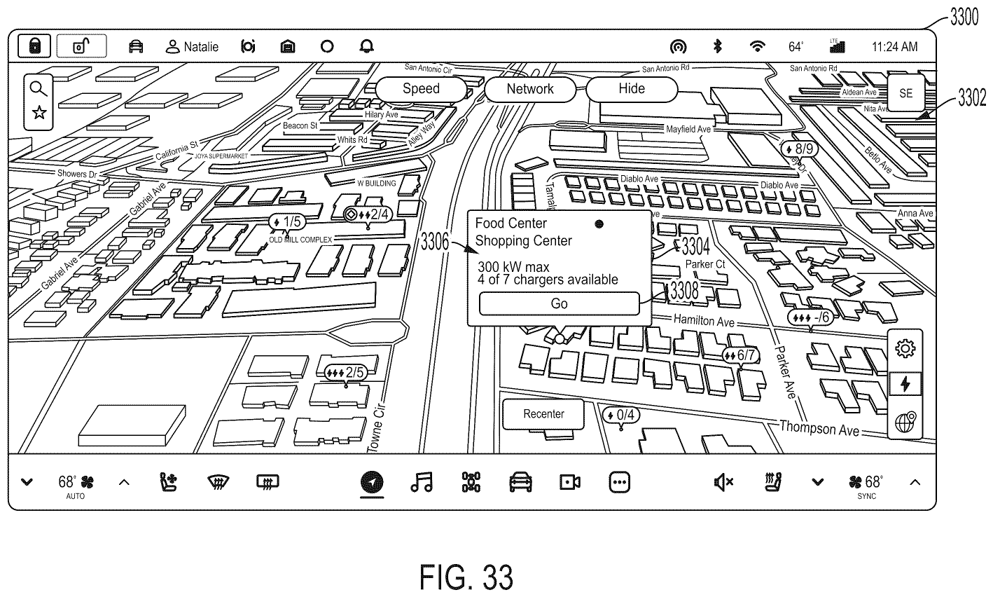

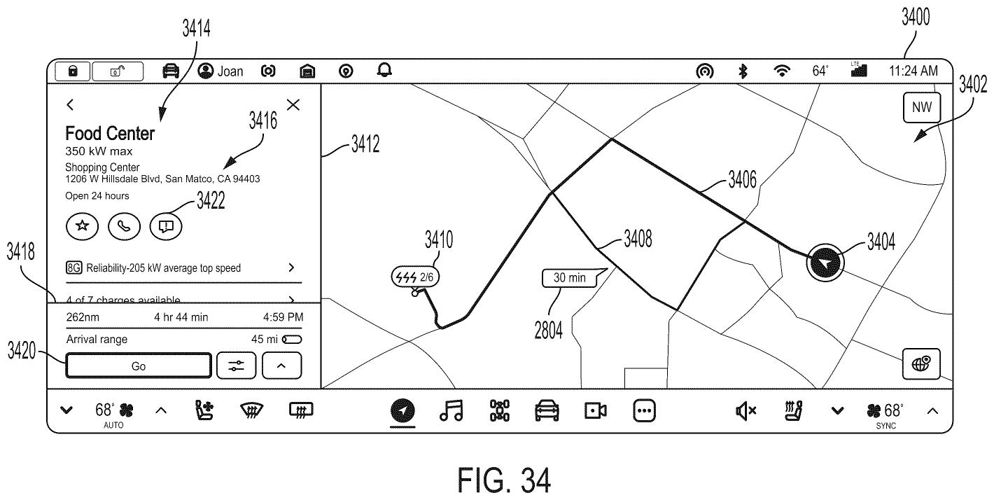

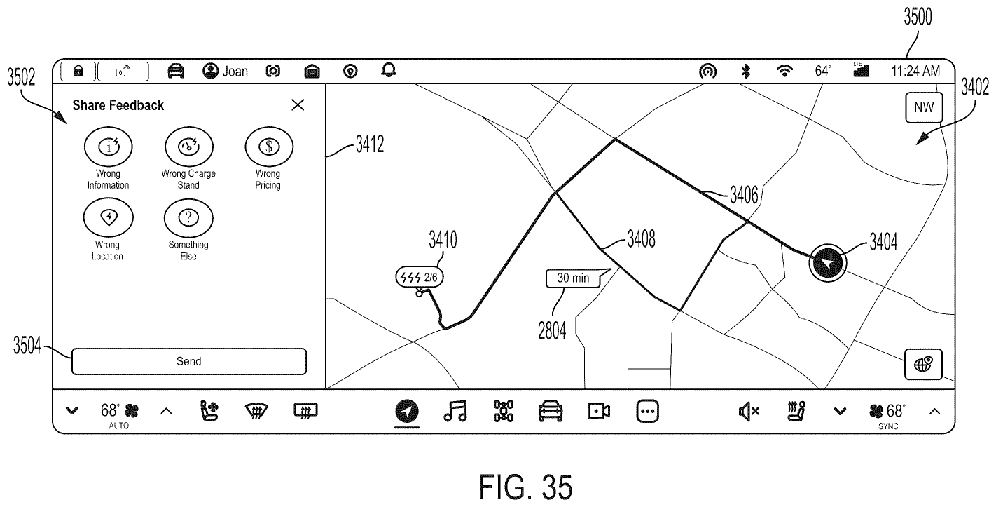

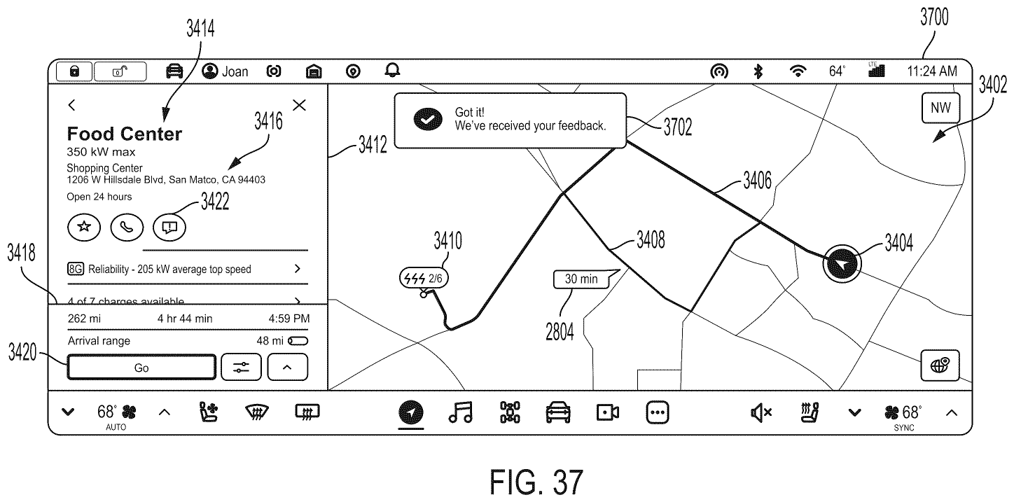

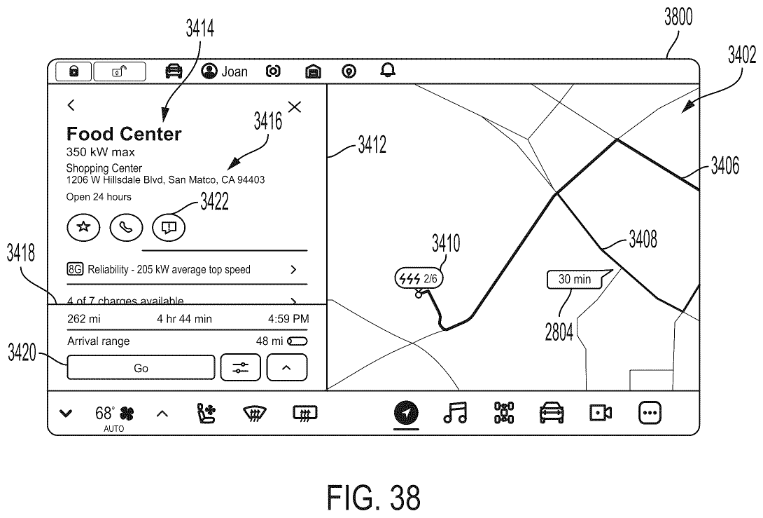

FIGS. 33-38 depict example user interfaces 3300-3800 illustrating a sequence for providing feedback for the state of the application in which the application is providing point of interest details for information regarding a charging station, in accordance with present implementations. A data processing system (e.g., the data processing system 204, shown and described with reference to FIG. 2, a client device, a computer, or a plurality of computers) can generate or update the user interfaces 3300-3800. The user interfaces 3300-3800 can be displayed on a display of an electric vehicle or a display on a computing device. The data processing system can execute an application to generate, present, or update the user interfaces 3300-3800. A user driving a vehicle (e.g., an electric vehicle) can view the user interfaces 3300-3800 (e.g., on a display of the vehicle) to provide feedback regarding performance of the application when generating instructions for a vehicle to reach a charging station.

For example, the user interface 3300 can include a map 3302 and a prompt 3304. The map can be an overhead view of a geographic area. The prompt 3304 can include information 3306 about a location that includes one or more charging stations. The information 3306 can include the address of the charging stations, the power output of the chargers at the charging station, the total number of chargers at the charging station location, and a total number of available or unavailable chargers at the charging station location. The prompt 3304 can also include a submit button 3308. The data processing system can present the prompt 3304 responsive to a user selecting an indication of the point of interest from the map 3302. The user can select the submit button 3308 to cause the data processing system to generate instructions to travel to the location including the charging stations.

Responsive to selection of the submit button 3308, the data processing system can present the user interface 3400. The user interface 3400 can include a map 3402, a vehicle indicator 3404, a route 3406, an alternate route 3408, and a charging station indicator 3410. The route 3406 can be or include a route to a charging station represented by the charging station indicator 3410. The user interface 3400 can also include an estimated travel time for the alternate route 3408.

The user interface 3400 can include a tab 3412. The tab 3412 can include information about the charging station (e.g., the location of the charging station, which can include one or more chargers) as well as the state of the application. For example, the tab 3412 can include an identifier 3414 (e.g., a name) of the charging station, information 3416 about the point of interest, information 3418 about the route 3406, a submit button 3420, and a prompt 3422. The identifier 3414 can be a text string identifying the charging station for which the application is generating a route. The information 3416 about the charging station can include information, such as the address of the charging station, the power output of the charging station (e.g., the power output of individual chargers of the charging station), the open times of the charging station, and the number of chargers that are available at the charging station. The information 3418 about the route can include information such as the length of the route, the time traveling the route is estimated to take, the time of arrival, and the predicted state of charge at arrival at the charging station. The submit button 3420 can be selected to cause the data processing to begin generating instructions for the route. The prompt 3422 can be a virtual button, an element, or a graphical icon that can be selected for the user to view options for providing feedback regarding performance of the application.

The user interface 3500 can be or include an updated version of the user interface 3400. The user interface 3500 can include the same or similar elements to the user interface 3400. The data processing system can present the user interface 3500 responsive to the user of the vehicle selecting the prompt 3422 from the user interfaces 3400. The user interface 3500 can include options 3502 and a submit button 3504. The options 3502 are depicted as including wrong information, wrong charge speed, wrong pricing, wrong location, and something else, although the options 3502 can include any type of option. The options 3502 can be options for different types of feedback regarding the performance of the application. The data processing system can select the options 3502 based on the state of the application or other types of data, such as sensor data regarding the surrounding environment, the state of the vehicle, or the current or predicted state of the battery powering the vehicle. The user can select one or more of the options 3502 and select the submit button 3504 to cause the data processing system to transmit the selected options (e.g., transmit identifications of the selected options) to a remote computing device for further processing (e.g., for mitigating any negative feedback for the application or the same application operating across vehicles).

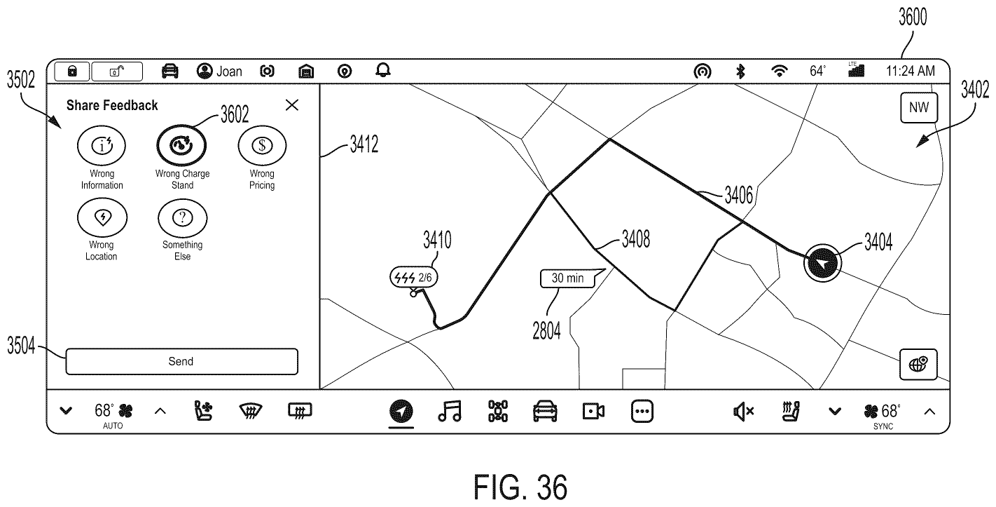

For example, as depicted in FIG. 36, the user interface 3600 shows a selected option 3602. The user can select the selected option 3602 and select the submit button 3504 to cause the data processing system to transmit an indication of the selected option 3602 to a remote computing device. Responsive to transmitting the indication of the selected option 3602, the data processing system can present the user interface 3700. The user interface 3700 can be similar to the user interface 3400, but display a graphic or element 3702 indicating that the transmission of the feedback from the user interface 3500 or 3600 was successful. The data processing system can present the user interface 3700 for a time period (e.g., a predetermined or defined time period) until causing the graphic or element 3702 to disappear, resulting in the user interface 3800.

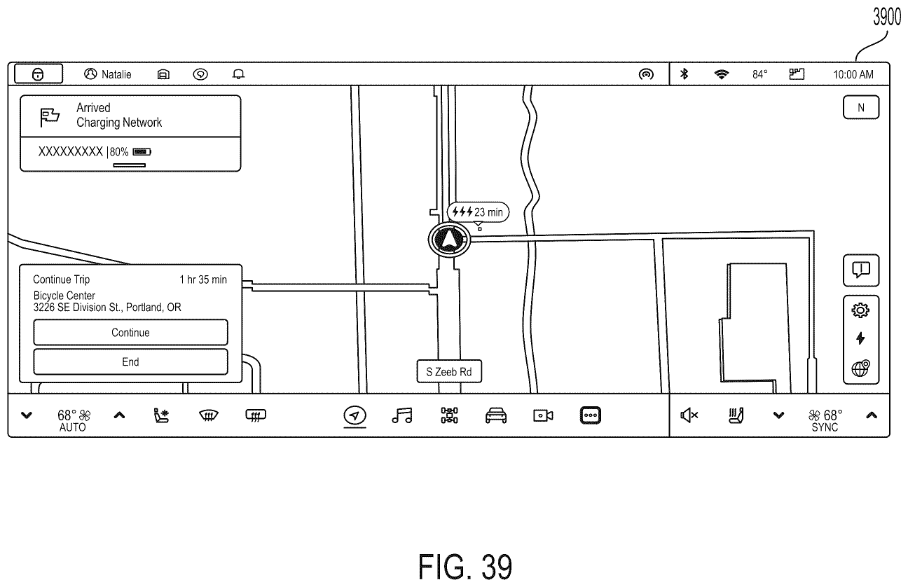

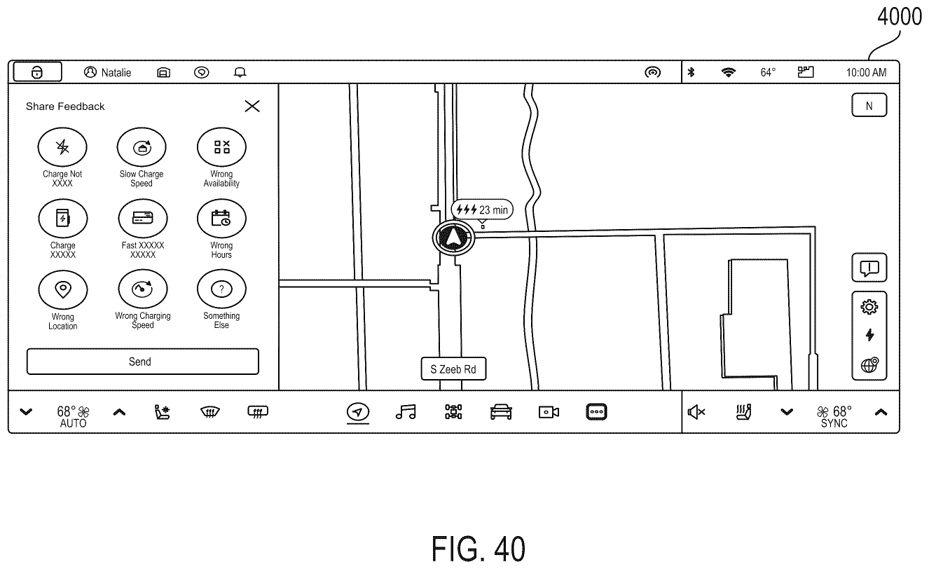

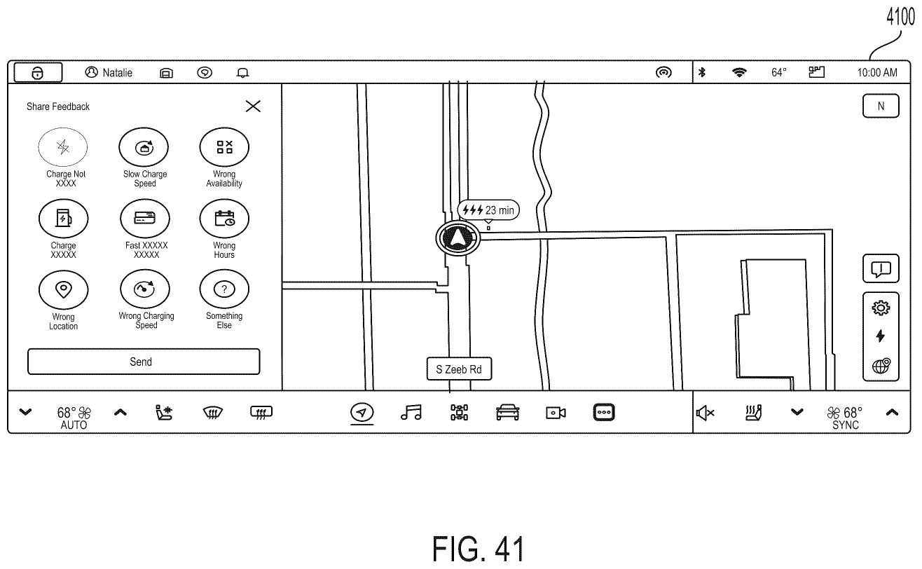

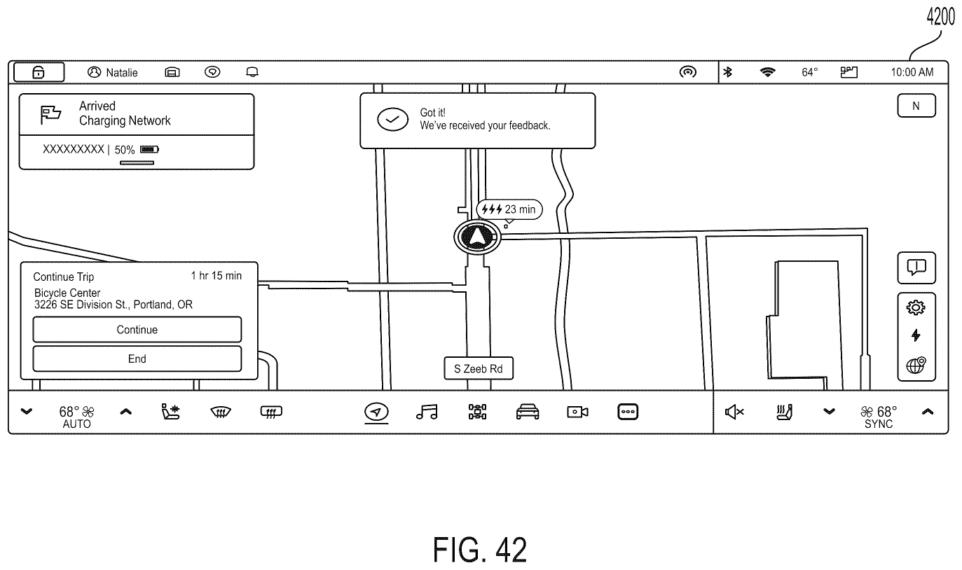

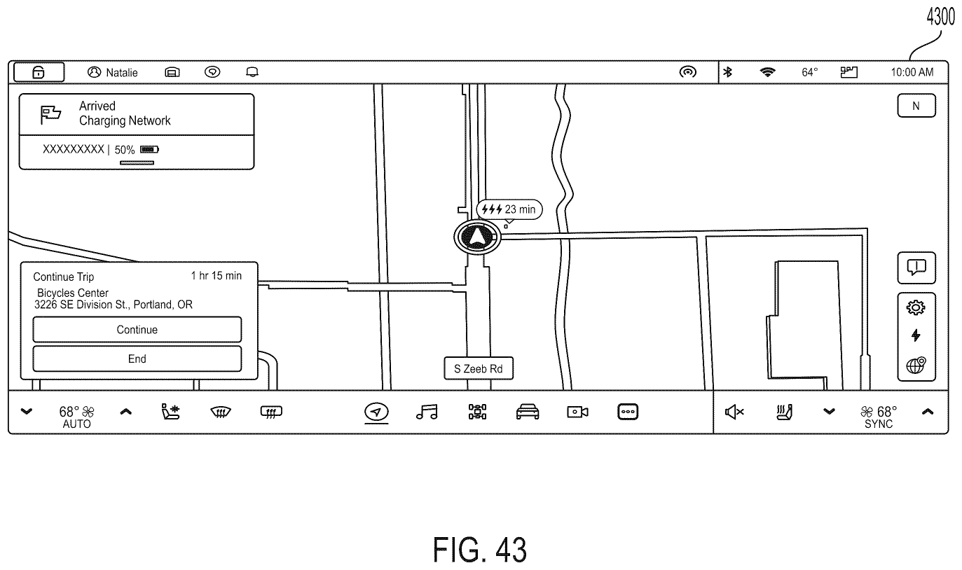

FIGS. 39-43 depict example user interfaces 3900-4300 illustrating a sequence for providing feedback for an arrival at a charging station state of an application, in accordance with present implementations. A data processing system (e.g., the data processing system 204, shown and described with reference to FIG. 2, a client device, a computer, or a plurality of computers) can generate or update the user interfaces 3900-4300. The user interfaces 3900-4300 can be displayed on a display of an electric vehicle or a display on a computing device. The data processing system can execute an application to generate, present, or update the user interfaces 2900-4300. A user driving a vehicle (e.g., an electric vehicle) can view the user interfaces 3900-4300 (e.g., on a display of the vehicle) to provide feedback regarding performance of the application after the vehicle arrives at a charging station for which the application was generating instructions for the vehicle to reach.

For example, in the user interfaces 3900-4300, the data processing system can present the user interface 3900 that shows that the vehicle has arrived at a charging station after navigating to the charging station. The data processing system can then present the user interface 4000 after a user selects a prompt corresponding to providing feedback for the application. The user interface 4000 can include options associated with the vehicle arriving at the destination. The options can include, for example, charger not working, wrong availability, charger blocked, problems with payment, wrong hours, wrong location, wrong charge speed, and something else. A user can select one of the options and select a submit button to cause the data processing system to transmit indications of the selected options to a remote computing device. The data processing system can present the user interface 4200 to indicate that the feedback transmission was successful. the user interface 1600 can include a map 1602, an arrival indication 1604, a destination indication 1606, a vehicle indicator 1608, arrival details 1610, a route 1612, route details 1108, and a prompt 1614. The map 1602 can include an overhead view of the area surrounding a vehicle (e.g., the vehicle in which the user interface 1100 is being displayed). The map 1602 can include the vehicle indicator 1608, the destination indication 1606, and the route 1612. The vehicle indicator 1608 can display a location of the vehicle on the map 1602. The vehicle indicator 1608 can be or include an arrow indicating a direction in which the vehicle is facing and/or a direction in which the vehicle is traveling. The route 1612 can depict a path for the vehicle to travel to reach the destination. The destination indication 1606 can indicate the location of the charging station to which the data processing system was navigating the vehicle.

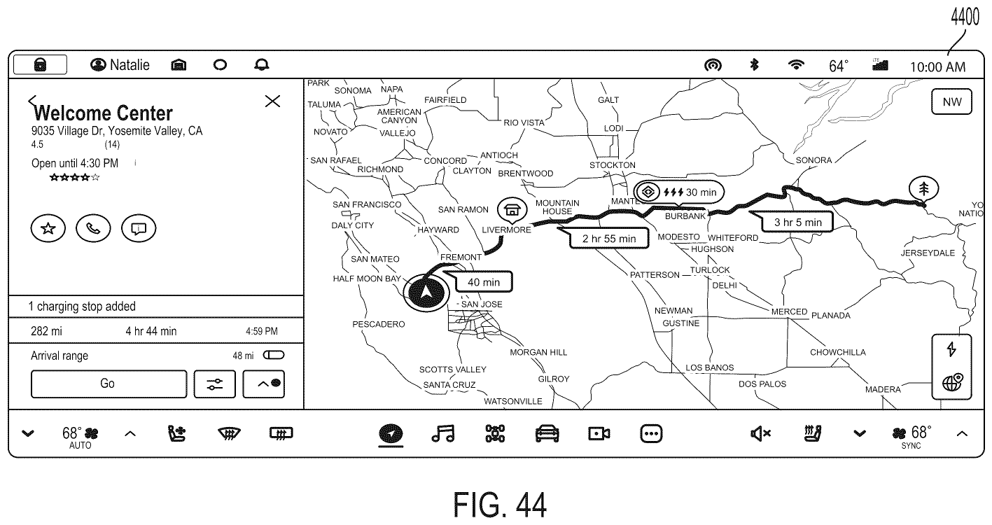

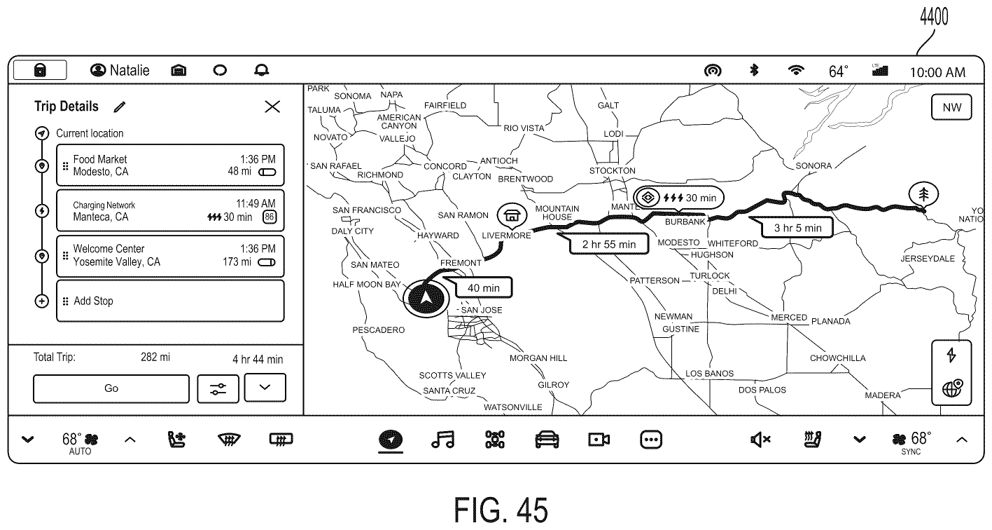

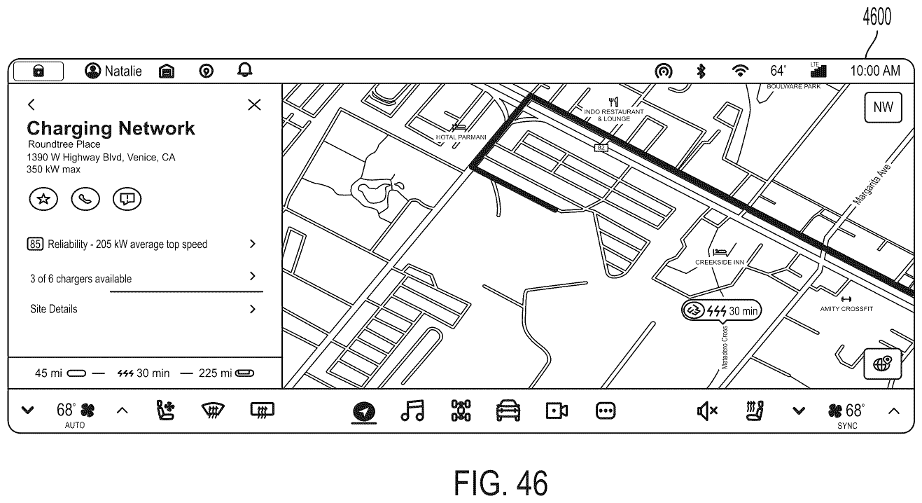

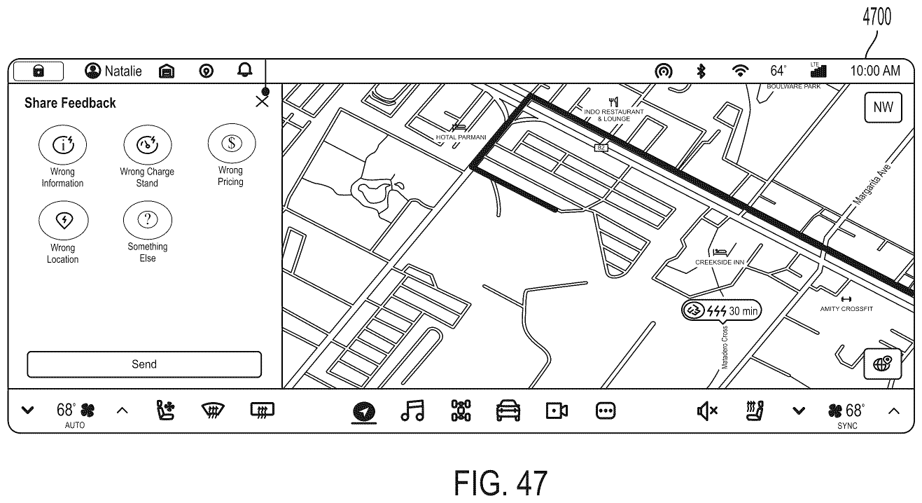

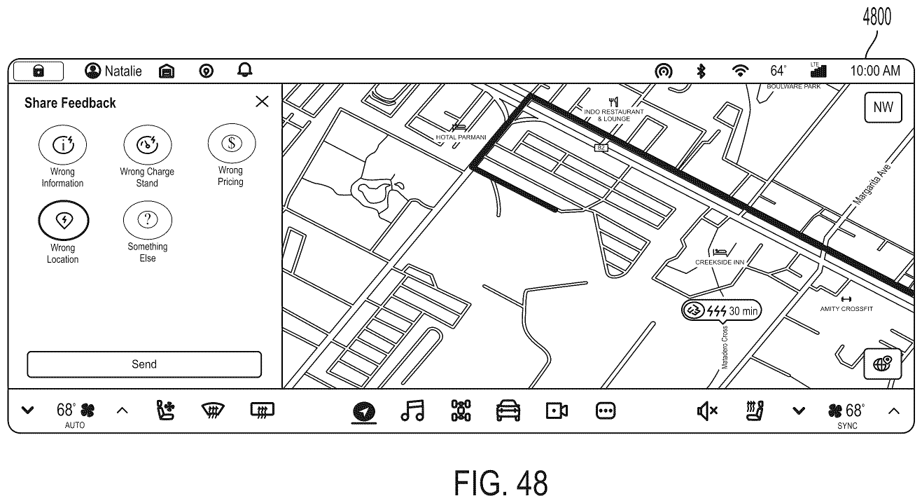

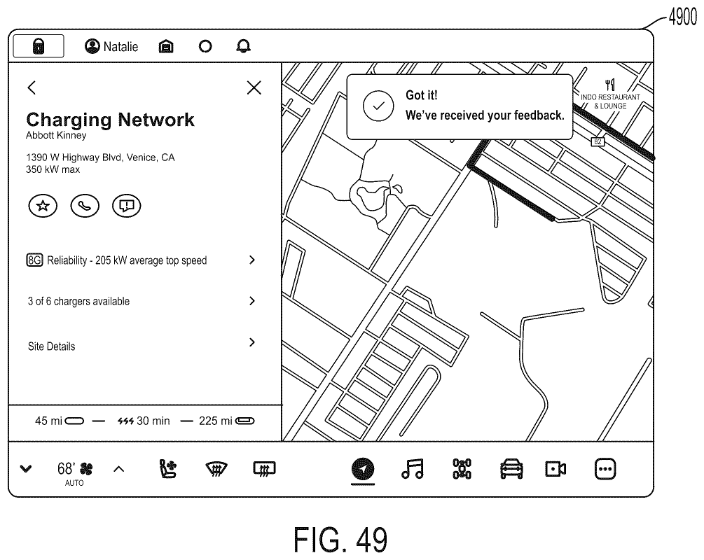

FIGS. 44-49 depict example user interfaces 4400-4900 illustrating a sequence for providing feedback for a point of interest state of an application, in accordance with present implementations. A data processing system (e.g., the data processing system 204, shown and described with reference to FIG. 2, a client device, a computer, or a plurality of computers) can generate or update the user interfaces 4400-4900. The user interfaces 4400-4900 can be displayed on a display of an electric vehicle or a display on a computing device. The data processing system can execute an application to generate, present, or update the user interfaces 4400-4900. A user driving a vehicle (e.g., an electric vehicle) can view the user interfaces 4400-4900 (e.g., on a display of the vehicle) to provide feedback regarding performance of the application when the application is providing details regarding providing information about a charging station when navigating to a destination.

For example, in the user interfaces 4400-4900, the data processing system can present the user interface 4400 that shows a route for the vehicle to travel to a destination. The user interface 4500 can show a list of points of interest on the route to the destination. The list of points of interest can include a charging station at which the vehicle can charge such that the vehicle can reach the destination. The user interface 4600 can include a map depicting the area around the charging station of the points of interest. The data processing system can present the user interface 4700 after a user selects a prompt corresponding to providing feedback for the application from the user interface 4600. The user interface 4700 can include options associated with the vehicle navigating to a charging station. The options can include, for example, wrong information, wrong charge speed, wrong pricing, wrong location, and something else. A user can select one of the options and select a submit button to cause the data processing system to transmit indications of the selected options to a remote computing device. The data processing system can present the user interface 4900 to indicate that the feedback transmission was successful.

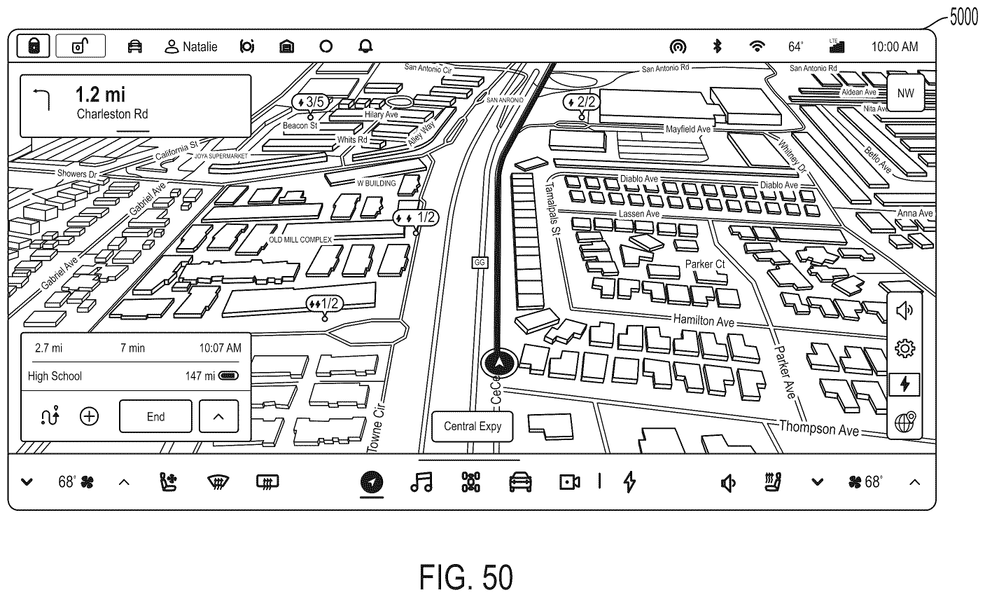

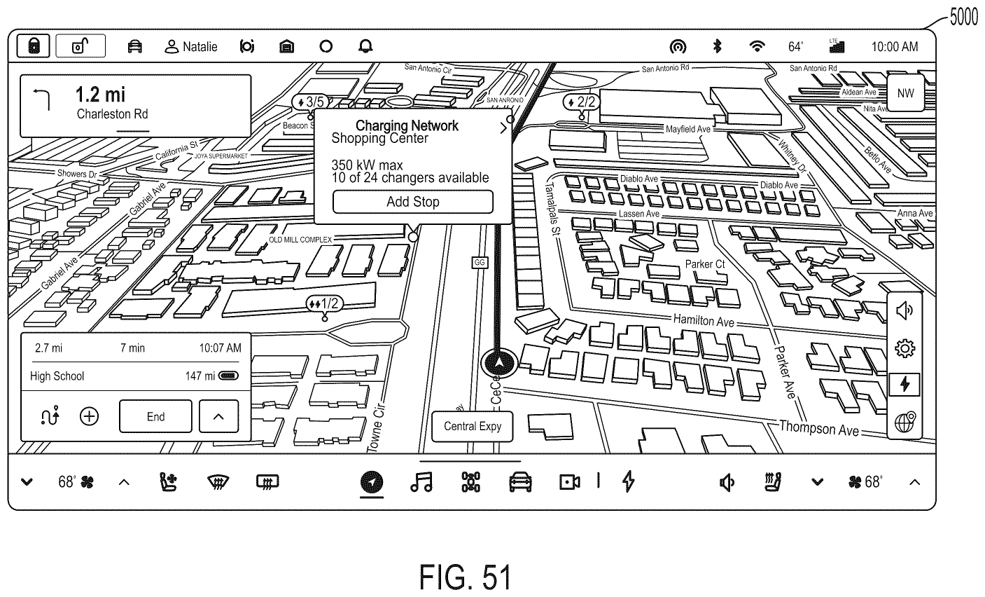

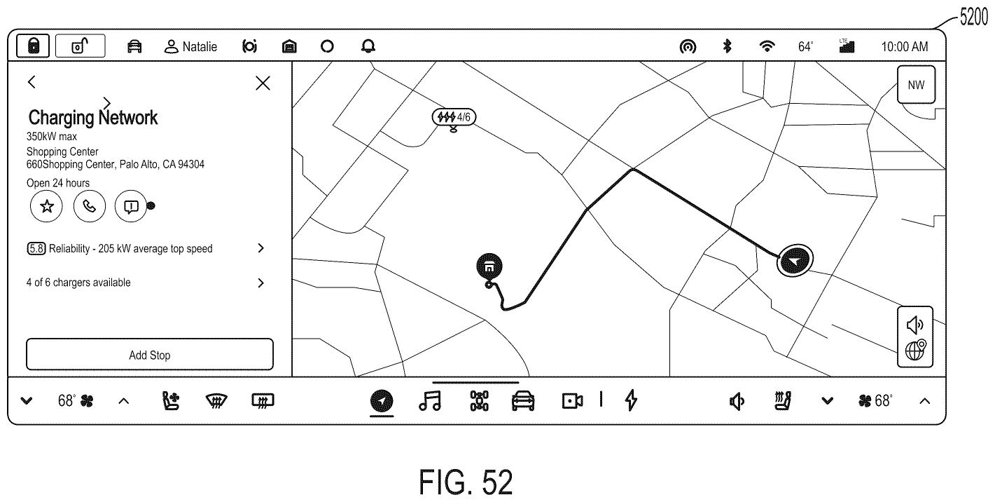

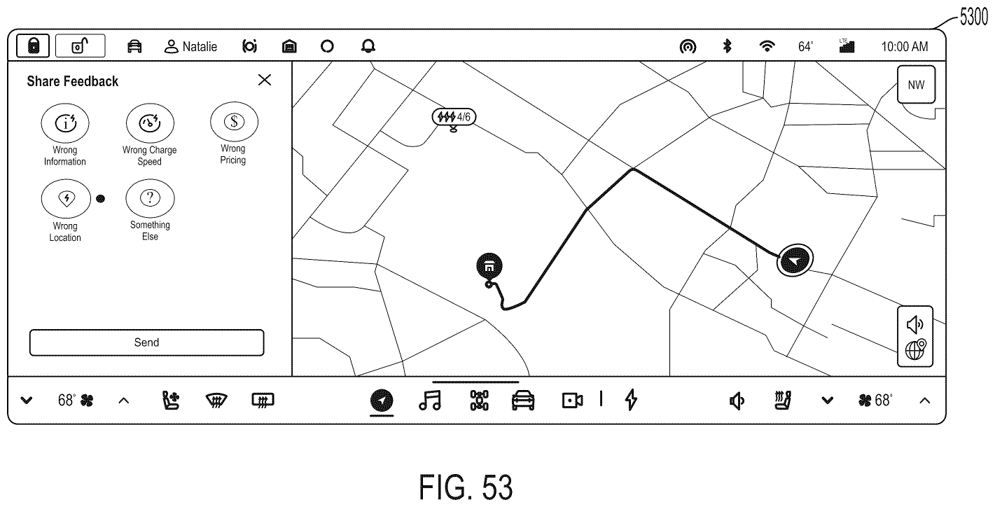

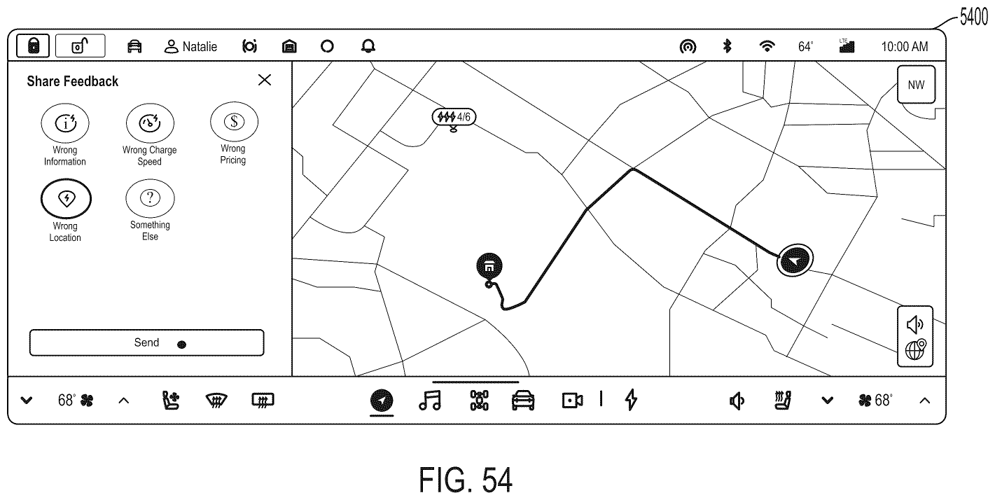

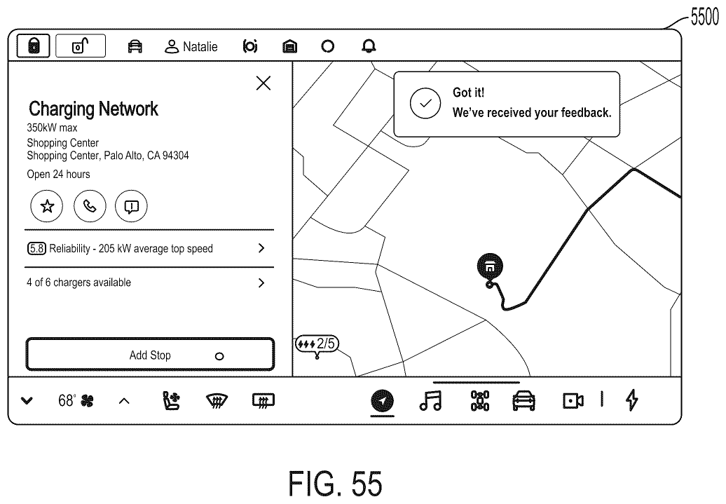

FIGS. 50-55 depict example user interfaces 5000-5500 illustrating a sequence for providing feedback for a searching state of an application, in accordance with present implementations. A data processing system (e.g., the data processing system 204, shown and described with reference to FIG. 2, a client device, a computer, or a plurality of computers) can generate or update the user interfaces 5000-5500. The user interfaces 5000-5500 can be displayed on a display of an electric vehicle or a display on a computing device. The data processing system can execute an application to generate, present, or update the user interfaces 5000-5500. A user driving a vehicle (e.g., an electric vehicle) can view the user interfaces 5000-5500 (e.g., on a display of the vehicle) to provide feedback regarding performance of the application when the application is querying for information about different charging stations when navigating to a destination.

For example, in the user interfaces 5000-5500, the data processing system can present the user interface 5000 that shows a route for the vehicle to travel to a destination. The user interface can show the locations of different charging stations on a map. The user interface 5100 can show a prompt including information about a charging station after a user selects an indication regarding the charging station from the map. The user interface 5200 can show a tab with further information about the charging station after the user selects the prompt from the user interface 5100. The data processing system can present the user interface 5300 after a user selects a prompt corresponding to providing feedback for the application from the user interface 5200. The user interface 5300 can include options associated with the vehicle navigating to a charging station. The options can include, for example, wrong information, wrong charge speed, wrong pricing, wrong location, and something else. A user can select one of the options and select a submit button to cause the data processing system to transmit indications of the selected options to a remote computing device. The data processing system can present the user interface 5500 to indicate that the feedback transmission was successful.

FIG. 56 depicts an example block diagram of an example computer system 5600, in accordance with some implementations. The computer system or computing device 5600 can include or be used to implement a data processing system or its components. The computing system 5600 includes at least one bus 5605 or other communication component for communicating information and at least one processor 5610 or processing circuit coupled to the bus 5605 for processing information. The computing system 5600 can also include one or more processors 5610 or processing circuits coupled to the bus for processing information. The computing system 5600 also includes at least one main memory 5615, such as a random access memory (RAM) or other dynamic storage device, coupled to the bus 5605 for storing information, and instructions to be executed by the processor 5610. The main memory 5615 can be used for storing information during execution of instructions by the processor 5610. The computing system 5600 can further include at least one read only memory (ROM) 5620 or other static storage device coupled to the bus 5605 for storing static information and instructions for the processor 5610. A storage device 5625, such as a solid state device, magnetic disk or optical disk, can be coupled to the bus 5605 to persistently store information and instructions.

The computing system 5600 can be coupled via the bus 5605 to a display 5635, such as a liquid crystal display, or active matrix display, for displaying information to a user such as a driver of the electric vehicle 105 or other end user. An input device 5630, such as a keyboard or voice interface can be coupled to the bus 5605 for communicating information and commands to the processor 5610. The input device 5630 can include a touch screen display 5635. The input device 5630 can also include a cursor control, such as a mouse, a trackball, or cursor direction keys, for communicating direction information and command selections to the processor 5610 and for controlling cursor movement on the display 5635.

The processes, systems and methods described herein can be implemented by the computing system 5600 in response to the processor 5610 executing an arrangement of instructions contained in main memory 5615. Such instructions can be read into main memory 5615 from another computer-readable medium, such as the storage device 5625. Execution of the arrangement of instructions contained in main memory 5615 causes the computing system 5600 to perform the illustrative processes described herein. One or more processors in a multi-processing arrangement can also be employed to execute the instructions contained in main memory 5615. Hard-wired circuitry can be used in place of or in combination with software instructions together with the systems and methods described herein. Systems and methods described herein are not limited to any specific combination of hardware circuitry and software.

Although an example computing system has been described in FIG. 56, the subject matter including the operations described in this specification can be implemented in other types of digital electronic circuitry, or in computer software, firmware, or hardware, including the structures disclosed in this specification and their structural equivalents, or in combinations of one or more of them.

Although an example computing system has been described in FIG. 56, the subject matter including the operations described in this specification can be implemented in other types of digital electronic circuitry, or in computer software, firmware, or hardware, including the structures disclosed in this specification and their structural equivalents, or in combinations of one or more of them.

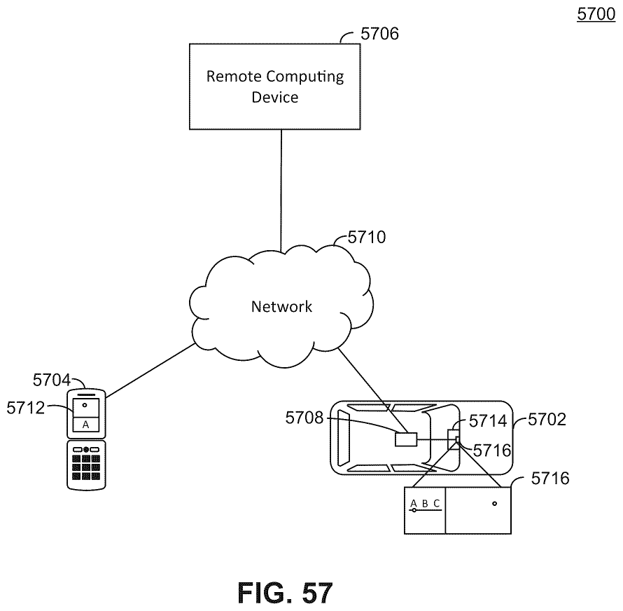

FIG. 57 depicts an example system 5700, in accordance with present implementations. The system 5700 can include a vehicle 5702, a client device 5704, and a remote computing device 5706. The vehicle 5702 can include a data processing system 5708. The data processing system 5708 can be the same as or be similar to the computing system 5600, shown and described with reference to FIG. 56, or the data processing system 204, shown and described with reference to FIG. 2. The client device 5704 can be the same as or be similar to the computing system 5600. The client device 5704 and the data processing system 5708 can communicate with the remote computing device 5706 over a network 5710. The network 5710 can be any type of wired or wireless communications network. The vehicle 5702 can be similar to or the same as the electric vehicle 105, shown and described with reference to FIG. 1, or the vehicle 202, shown and described with reference to FIG. 2. The remote computing device 5706 can generate scores for different charging stations. The remote computing device 5706 can transmit the scores to the client device 5704 or the data processing system 5708. The client device 5704 or the data processing system 5708 can execute an application (e.g., a navigation application, such as the application 175) to display the scores to a user. By doing so, the client device 5704 or the data processing system 5708 can provide the user with data that the user can use to select a charging station at which the user can charge the vehicle 5702 quickly or efficiently. The remote computing device 5706 can provide such scores to a large number of vehicles to provide information to a network of vehicles that facilitates charging sessions at charging stations that are operating efficiently, which can increase the speed of charging for the network of vehicles as a whole.

The remote computing device 5706 can generate scores for different charging stations based on data collected regarding charging sessions performed at the charging stations. For example, the remote computing device 5706 can receive data (e.g., session data) regarding charging sessions performed at different charging stations. The data can include, but is not limited to, geolocation data, indications of whether charge sessions succeeded or failed (e.g., successes or failures of delivering a charge at all or completed a charge to a target amount of a vehicle's battery capacity), temperature sensor data, or amounts of current delivered over the course of the charging sessions. The remote computing device 5706 can store the data in a data repository. The remote computing device 5706 can generate metrics from the data collected regarding the charging. For example, the remote computing device 5706 can use the collected data to generate metrics such as actual delivered power for a given temperature, geolocation of a vehicle, time to begin a charging session after entering an area around the charging station, or charging station health. The remote computing device 5706 can generate such metrics for individual charging stations. The remote computing device 5706 can generate scores based on or as a function of the metrics or the session data for the charging sessions for the individual charging stations. In doing so, the remote computing device 5706 can use a function such as a sum, weighted sum, average, weighted average, or median, for example. The remote computing device 5706 can use the function on one or more types of session data or metrics generated from the session data. The client device 5704 or the data processing system 5708 can similarly determine or calculate scores for charging stations.

The remote computing device 5706 can transmit scores determined for individual charging stations to the vehicle 5702 or the client device 5704. In doing so, the remote computing device 5706 can transmit each score that the remote computing device 5706 determines for the charging stations or select scores to transmit to the vehicle 5702 or the client device 5704 based on the geographic locations of the vehicle 5702 or the client device 5704. For example, the remote computing device 5706 can determine or calculate the scores for the charging stations and transmit the scores to the client device 5704 or the data processing system 5708 responsive to the determination or calculation of the scores. The remote computing device 5706 can update the scores over time as the remote computing device 5706 receives session data regarding new charging sessions performed at the charging stations (e.g., by determining new metrics for the respective charging stations and determining or calculating new scores for the charging stations based on or as a function of the new metrics or new session data). The remote computing device 5706 can transmit the updated scores to the client device 5704 or the data processing system 5708 responsive to determining or calculating the updated scores.

In another example, the remote computing device 5706 can transmit scores to the client device 5704 or the data processing system 5708 based on the geographic location of the vehicle 5702 or the client device 5704. For instance, the remote computing device 5706 can receive global positioning system (GPS) data indicating the location of the vehicle 5702 or the client device 5704. The remote computing device 5706 can identify one or more charging stations that are within a radius (e.g., a defined radius) of the location of the vehicle 5702 or the client device 5704. The remote computing device 5706 can transmit scores for the one or more charging stations to the client device 5704 or the data processing system 5708 that the remote computing device 5706 identified as being within the radius of the location of the vehicle 5702 or the client device 5704.

In another example, the remote computing device 5706 can transmit scores to the client device 5704 or the data processing system 5708 based on the scores being within a distance (e.g., a defined distance) of a route that the remote computing device 5706 determines for the vehicle 5702 to reach a destination. For instance, the remote computing device 5706 can receive an identifier (e.g., a name) of a destination for the vehicle 5702 to travel. The remote computing device 5706 can receive the identifier from the client device 5704 or the data processing system 5708. The remote computing device 5706 can generate a route for the vehicle 5702 to travel to the destination based on traffic data, such as by using an optimization function to identify the fastest route to reach the destination. The remote computing device 5706 can identify the charging stations that are within a distance of any point or location on the route. The remote computing device 5706 can transmit the route with scores for the identified charging stations to the client device 5704 or the data processing system 5708.

The remote computing device 5706 can transmit the scores as a numerical value or a text value. For example, the remote computing device 5706 can determine numerical values for individual charging stations based on or as a function of the session data for charging sessions or metrics for the respective charging stations. The numerical values can be the scores for the charging stations or the remote computing device 5706 can determine the scores for the charging stations based on the numerical values. For instance, the remote computing device 5706 can store a set of ranges that each include one or more or a plurality of numerical values. Each range can correspond to a letter, text, or other visual indicator. The remote computing device 5706 can compare the numerical values determined for the charging stations to the ranges and identify a range within which the numerical values fall. The remote computing device 5706 can identify the letter, text, or visual indicator that corresponds to the ranges within which the numerical values fall for the individual charging stations. The identified letter, text, or visual indicators can be the scores for the charging stations. In some cases, the client device 5704 or the data processing system 5708 can receive numerical values and determine letters, text, or visual indicators for the charging stations using the numerical values in the same or a similar manner.

The client device 5704 can present the scores for the charging stations. The client device 5704 can present the scores on a user interface 5712. For example, the client device 5704 can execute an application to present a map or list of different charging stations. In the case of a map, the map can depict a geographical region and include indicators of charging stations within the geographical region. A user of the client device 5704 can select an indicator of a charging station from the list or map. Responsive to the selection, the user interface 5712 can update to show a score for the charging station that the client device 5704 received from the remote computing device 5706 as a numerical value, text, or visual indicator. The client device 5704 can present scores for charging stations in any manner.

The data processing system 5708 can present the scores for the charging stations. The data processing system 5708 can present the scores on a display device 5714 via a user interface 5716. For example, the data processing system 5708 can execute an application (e.g., a navigation application) to present a map or list of different charging stations. In the case of a map, the map can depict a geographical region and include indicators of charging stations within the geographical region. The map can depict route for the vehicle 5702 to travel to a destination and update as the vehicle 5702 moves. A user (e.g., a driver or passenger) of the vehicle 5702 can select an indicator of a charging station from the user interface 5716. Responsive to the selection, the data processing system 5708 can update the user interface 5716 to show a score for the charging station that the data processing system 5708 received from the remote computing device 5706 as a numerical value, text, or visual indicator. The display device 5714 can present scores for charging stations in any manner via the user interface 5716.

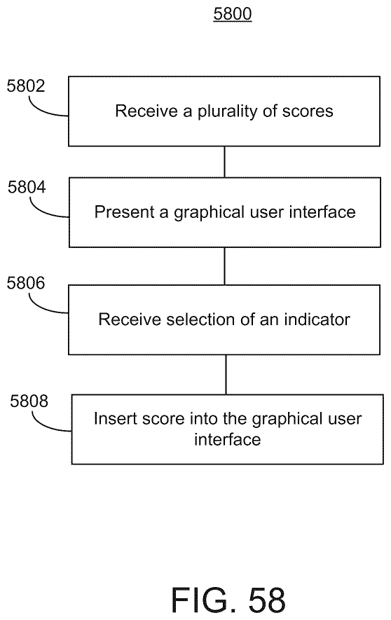

FIG. 58 depicts a method 5800 for charging station score presentation, in accordance with present implementations. The method 5800 can be performed by one or more components depicted in the system 5700 of FIG. 57 or the computing device 5600 of FIG. 56. For example, the method 5800 can be performed by a data processing system (e.g., client device 5704 or the data processing system 5708, shown and described with reference to FIG. 57). Performance of the method 5800 can facilitate the data processing system presenting real-time scoring of charging stations to facilitate vehicles faster vehicle charging of vehicles (e.g., electric vehicles).

At ACT 5802, the method 5800 can include receiving a plurality of scores. The plurality of scores can be scores for a plurality of charging stations within a geographical region. The geographical region can be a region that includes a location of a vehicle. Each of the scores can represent a performance of a different charging station of the plurality of charging stations based on one or more charging sessions performed at the charging station. The data processing system can receive the plurality of scores from a remote computing device (e.g., the remote computing device 5706) after the remote computing device determines the scores, or the data processing system can determine the scores. The data processing system or the remote computing device can determine the scores based on or as a function of session data of charging sessions performed at the respective charging stations or metrics determined for the respective charging stations.

At ACT 5804, the method 5800 can include presenting a graphical user interface. The data processing system can present the graphical user interface on a display of a client device or a display of a vehicle. The graphical user interface can include a map. The map can include an overhead view of a portion of the geographical region including the location of the vehicle. The map can include an indicator of the vehicle indicating the vehicle's position or location within the geographical region. The map can include one or more indicators representing a location of one or more of the plurality of charging stations for which the data processing system received scores or that are within the portion of the geographical region displayed on the map. The data processing system can receive a selection of an indicator of the indicators presented on the map.

At ACT 5806, the method 5800 can include inserting a score for a charging station into the graphical user interface. The data processing system can insert the score for the charging station represented by or corresponding to the selected indicator into the graphical user interface. The data processing system can insert the score for the charging station into the graphical user interface responsive to the selection of the indicator corresponding to the charging station. The data processing system can insert the score as a numerical value, text, or another visual indicator.

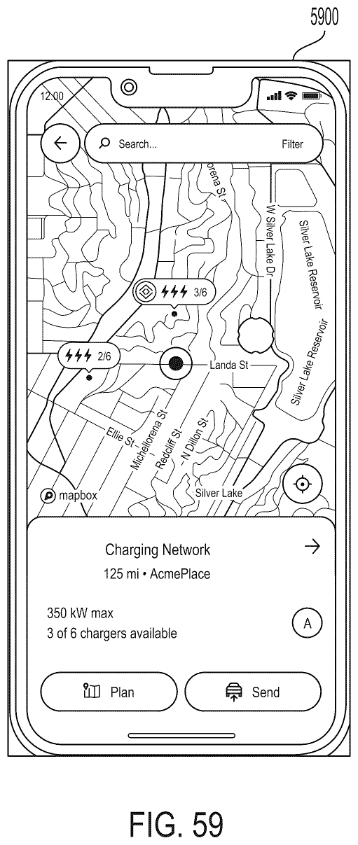

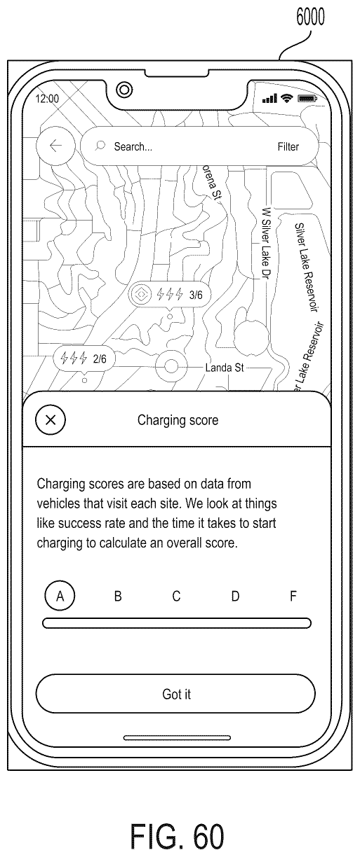

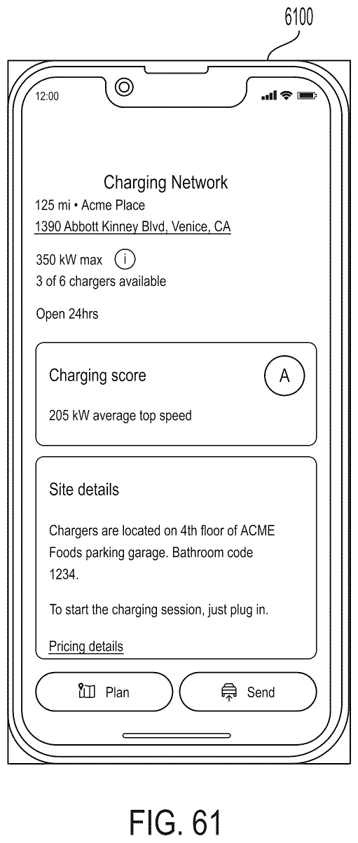

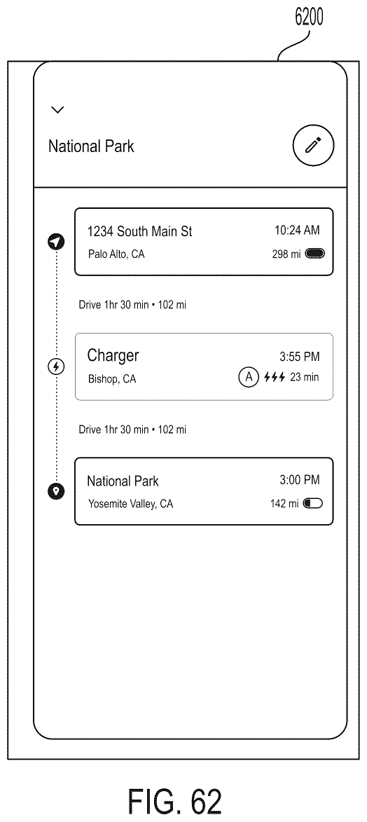

FIGS. 59-62 depict example user interfaces 5900-6200 for providing charging station scores on a client device, in accordance with present implementations. A data processing system (e.g., the client device 5704 or the data processing system 5708, shown and described with reference to FIG. 57, a client device, a computer, or a plurality of computers) can generate or update the user interfaces 5900-6200. The user interfaces 5900-6200 can be displayed on a display of a computing device. The data processing system can execute an application to generate, present, or update the user interfaces 5900-6200.

For example, the data processing system can present the user interface 5900. The user interface 5900 can depict an overhead view of a portion of a geographical region that includes a vehicle or the data processing system on a map. The vehicle or data processing system can be represented by a visual indicator on the user interface 5900. The user interface 5900 can show indicators of different charging stations within the portion of the geographical region shown on the map.

The user interface 5900 shows a view after a user selects one of the indicators for a charging station on the map of the user interface 5900. For example, the user interface 5900 can show a name and information about the charging station associated with the selected indicator. The information can include a max charging power, a number of chargers available, a distance to the charging station, and a score (e.g., as the letter “A” in a green circle).

The data processing system can present the user interface 6000 responsive to selection of the score for the charging station from the user interface 5900. The user interface 6000 can include a description of how scores such as the score for the charging station are determined as well as a visual representation of the score compared with other possible scores. For example, the user interface 6000 shows a sliding color-coded scale of the score compared with other scores ranging from A to F with a corresponding green-to-red color coding scheme.

The user interface 6100 can depict another view that includes details regarding the charging station selected from the map. The data processing system can present the user interface 6100 responsive to a selection of a button (e.g., a virtual button) or element from the user interface 5900 for example, or responsive to selection from any other user interface. The user interface 6100 can include site details regarding the charging station and the score for the charging station.

The user interface 6200 can depict a view of a route to a destination. The user interface 6200 can include an identification of the current location of the data processing system or a vehicle, an identification of a charging station to stop at on the route to the destination, and an identification of the destination. The data processing system can present the user interface 6200 responsive to determining or receiving the route for the vehicle (e.g., a vehicle linked or associated with the data processing system, such as through a common account) to travel from the current location to the destination. The charging station may be a charging station at which the vehicle can stop to charge to have enough energy to reach the destination. The indication of the charging station can include information about the charging station, such as the distance to the charging station from the current location, the location of the charging station, and a score for the charging station determined as described herein.

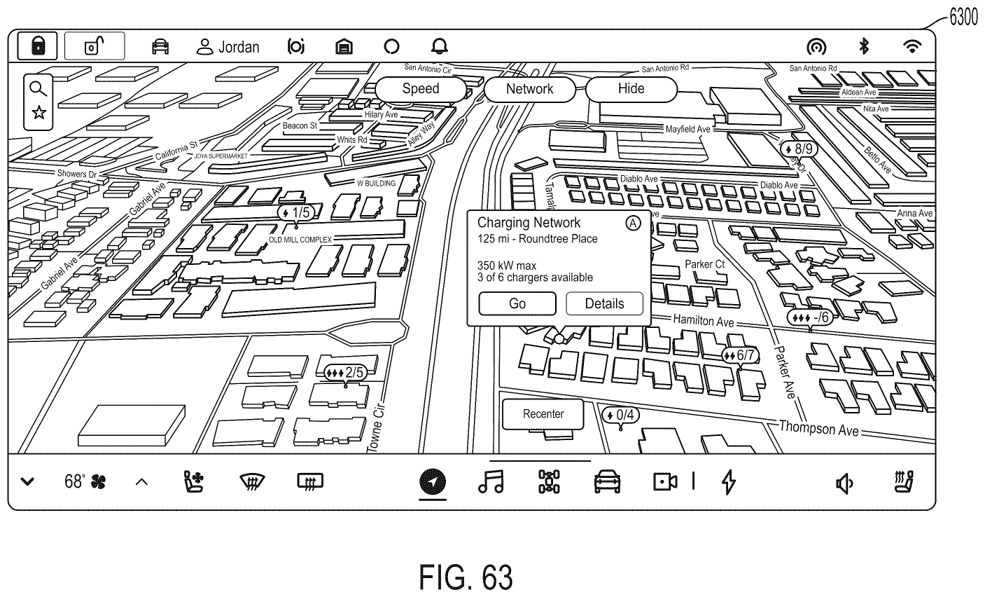

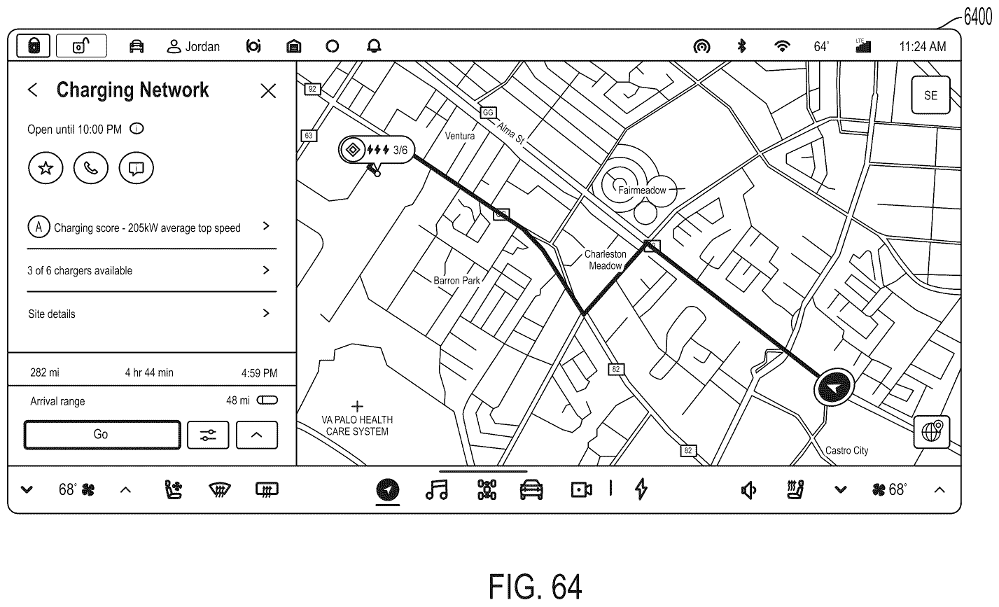

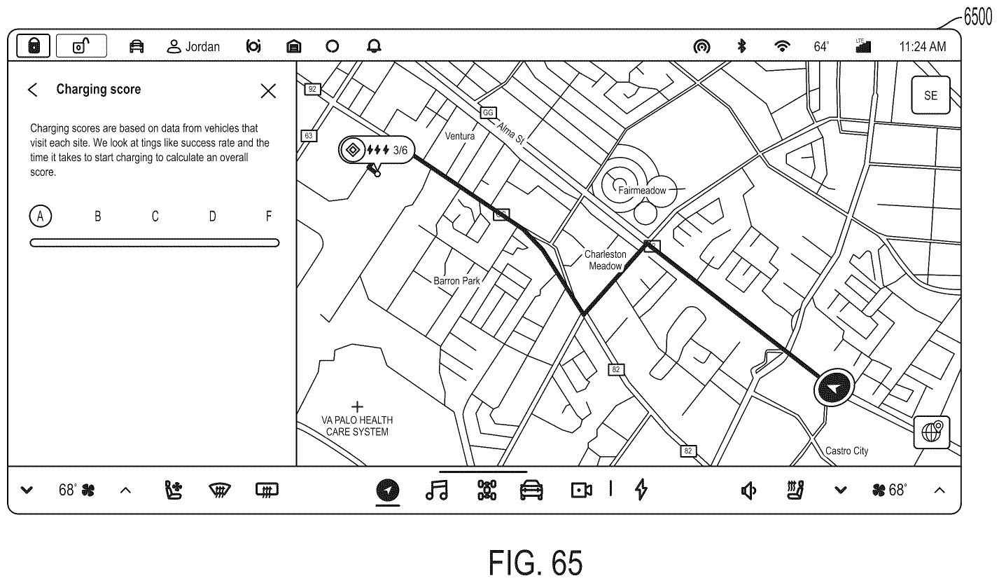

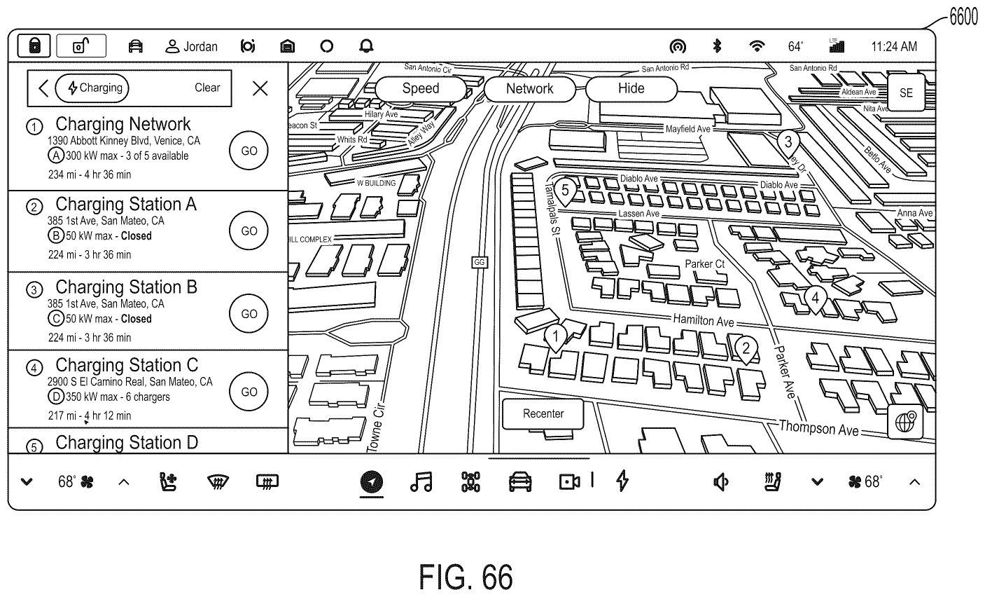

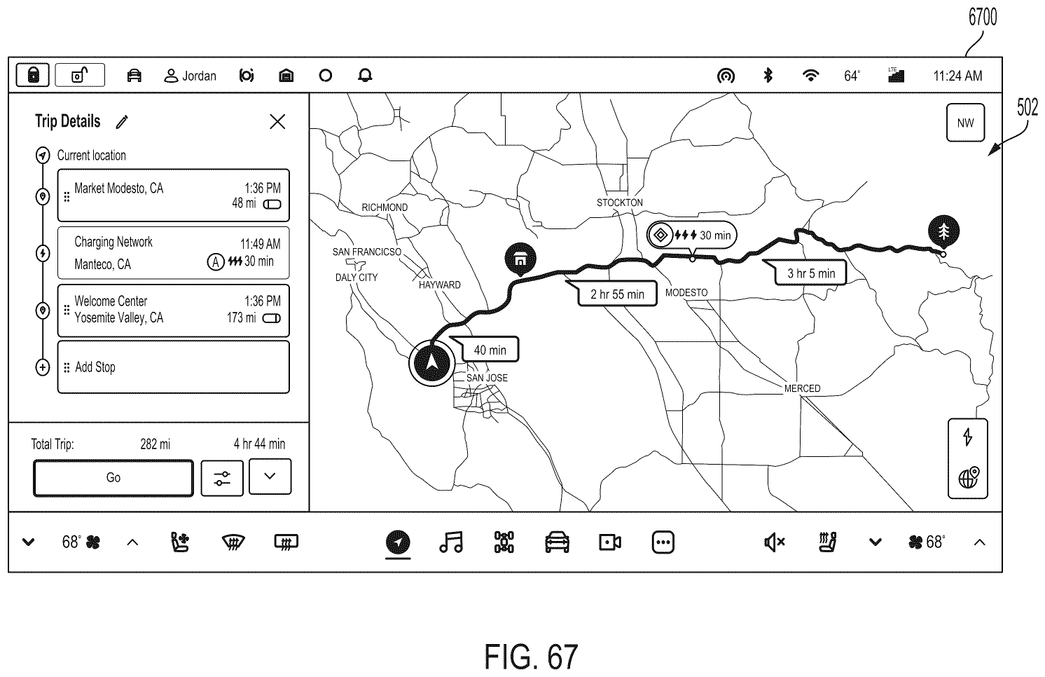

FIGS. 63-67 depict example user interfaces for providing charging station scores on a display device of a vehicle, in accordance with present implementations. A data processing system (e.g., the client device 5704 or the data processing system 5708, shown and described with reference to FIG. 57, a client device, a computer, or a plurality of computers) can generate or update the user interfaces 6300-6700. The user interfaces 6300-6700 can be displayed on a display or display device of a vehicle. The data processing system can execute an application to generate, present, or update the user interfaces 6300-6700.

For example, in the user interfaces 6300-6700, the data processing system can present the user interface 6300, which shows an overhead view of a portion of a geographical region that includes the vehicle or the data processing system on a map. The user interface 6300 can show indicators of different charging stations within the portion of the geographical region shown on the map.

The user interface 6300 shows a view after a user selects one of the indicators for a charging station on the map of the user interface 6300. For example, the user interface 6300 can show a name and information about the charging station associated with the selected indicator. The information can include a max charging power, a number of chargers available, a distance to the charging station, and a score (e.g., as the letter “A” in a green circle).

The data processing system can present the user interface 6400 responsive to selection of an indicator from the user interface 6300. The user interface 6300 can include information regarding the charging station corresponding to the selected indicator. The information can include a max charging power, a number of chargers available, a distance to the charging station, and a score (e.g., as the letter “A” in a green circle).

The data processing system can present the user interface 6500 responsive to selection of the score for the charging station from the user interface 6300 or the user interface 6400. The user interface 6500 can include a description of how scores such as the score for the charging station are determined as well as a visual representation of the score compared with other possible scores. For example, the user interface 6500 shows a sliding color-coded scale of the score compared with other scores ranging from A to F with a corresponding green-to-red color coding scheme.

The data processing system can present the user interface 6600 responsive to receiving a search query for charging stations. The user interface 6600 can include a map showing locations of different charging stations in a geographical region (e.g., a geographical region in which the vehicle is located or is within a defined radius of) and a list that includes descriptions of the different charging stations indicated on the map. The list can include information about the individual charging stations, such as a max charging power, a number of chargers available, a distance to the charging station, and a score.

The user interface 6700 can depict a view of a route to a destination. The user interface 6700 can depict the route on a map as well as in list form. The user interface 6700 can include an identification of the current location of the data processing system or the vehicle, an identification of a charging station to stop at on the route to the destination, and an identification of the destination, both in the list and on the map. The data processing system can present the user interface responsive to determining or receiving a route for the vehicle to travel from the current location of the vehicle to the destination. The charging station may be a charging station at which the vehicle can stop to charge to have enough energy to reach the destination. The indication of the charging station can include information about the charging station, such as the distance to the charging station, the location of the charging station, and a score for the charging station determined as described herein.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A vehicle, comprising:
a display; and
one or more processors, coupled with memory, to execute an application to provide instructions for the vehicle, the one or more processors to:
present, on the display of the vehicle, a user interface comprising a prompt for feedback of performance of the application;
select, in response to the prompt, a set of options based on a state of the application, each option of the set of options corresponding to a different type of feedback regarding performance of the application;
present the set of options on the user interface;
receive a selection of one or more options of the set of options; and
transmit the selection of the one or more options to a remote computer.

2. The vehicle of claim 1, comprising the one or more processors to:
execute the application to generate a route for the vehicle to reach a destination;
identify a predicted state of charge of the vehicle at the destination based on the route for the vehicle to reach the destination; and
select second one or more options to include on the user interface based on the predicted state of charge of the vehicle at the destination.

3. The vehicle of claim 1, comprising the one or more processors to:
identify the state of the application in response to the prompt.

4. The vehicle of claim 1, comprising the one or more processors to:
transmit an identifier of the vehicle or an account associated with the vehicle and a path identifier of a route the application was navigating at a time of selection of the prompt to the remote computer with the selection of the one or more options.

5. The vehicle of claim 1, comprising the one or more processors to:
execute the application to generate instructions to navigate the vehicle to a destination;
receive a selection of the prompt while the application is updating the instructions to navigate the vehicle to the destination; and
select, based on the state of the application of updating the instructions to navigate the vehicle to the destination, the set of options as one or more of a route problem, an illegal route, a wrong vehicle position, a road closure, confusing guidance, or inaccurate traffic.

6. The vehicle of claim 1, comprising the one or more processors to:
transmit data regarding the vehicle, an identifier of the vehicle or an account associated with the vehicle, or a path identifier of a route the application is navigating in a separate transmission from the transmission of the selection of the one or more options to the remote computer;
transmit the identifier of the vehicle or the account associated with the vehicle or the path identifier of a route the application was navigating at a time of selection of the prompt to the remote computer with the selection of the one or more options; and
wherein the remote computer is to correlate the selection of the one or more options with the data regarding the vehicle based on the identifier of the vehicle or the account associated with the vehicle or the path identifier of the route the application was navigating.

7. The vehicle of claim 1, comprising the one or more processors to:
select, responsive to the prompt, the set of options based on the state of the application, each option of the set of options corresponding to a different type of feedback regarding performance of the application while the application was in the state.

8. The vehicle of claim 1, comprising the one or more processors to:
select, responsive to the prompt, the set of options based on the state of the application indicating that the vehicle has arrived at a defined destination after providing navigation instructions for the vehicle to travel to the defined destination.

9. The vehicle of claim 1, comprising the one or more processors to:
select, responsive to the prompt, the set of options based on the state of the application indicating that the application is presenting information regarding a point of interest on the user interface.

10. The vehicle of claim 1, comprising the one or more processors to:
select, responsive to the prompt, the set of options based on the state of the application indicating that the application is presenting information regarding a vehicle charging station on the user interface.

11. The vehicle of claim 1, comprising the one or more processors to:
identify data regarding the vehicle; and
update the one or more options to include second one or more options based on the data regarding the vehicle.

12. A method, comprising:
presenting, by one or more processors on a display of a vehicle, a user interface comprising an element to prompt for feedback of performance of an application to provide instructions for the vehicle;
selecting, by the one or more processors responsive to selection of the element, a set of options based on a state of the application, each option of the set of options corresponding to a different type of feedback regarding performance of the application;
presenting, by the one or more processors, the set of options on the user interface;
receiving, by the one or more processors, a selection of one or more options of the set of options at the user interface; and
transmitting, by the one or more processors, the selection of the one or more options to a remote computer.

13. The method of claim 12, comprising:
executing, by the one or more processors, the application to generate a route for the vehicle to reach a destination;
identifying, by the one or more processors, a predicted state of charge of the vehicle at the destination based on the route for the vehicle to reach the destination; and
selecting, by the one or more processors, second one or more options to include on the user interface based on the predicted state of charge of the vehicle at the destination based on the route for the vehicle to reach the destination.

14. The method of claim 12, comprising:
identifying, by the one or more processors, the state of the application responsive to the selection of the element.

15. The method of claim 12, comprising:
transmitting, by the one or more processors, an identifier of the vehicle or an account associated with the vehicle and a path identifier of a route the application was navigating when the element was selected to the remote computer with the selection of the one or more options.

16. The method of claim 12, comprising:
executing, by the one or more processors, the application to generate instructions to navigate the vehicle to a destination;
receiving, by the one or more processors, the selection of the element while the application is updating the instructions to navigate the vehicle to the destination; and
selecting, by the one or more processors based on the state of the application of updating the instructions to navigate the vehicle to the destination, the set of options as one or more of a route problem, an illegal route, a wrong vehicle position, a road closure, confusing guidance, or inaccurate traffic.

17. The method of claim 12, comprising:
transmitting, by the one or more processors, data regarding the vehicle, an identifier of the vehicle or an account associated with the vehicle, or a path identifier of a route the application is navigating in a separate transmission from the transmission of the selection of the one or more options to a remote computer;
transmitting, by the one or more processors, the identifier of the vehicle or the account associated with the vehicle or the path identifier of a route the application was navigating when the element was selected to the remote computer with the selection of the one or more options; and
wherein the remote computer is to correlate the selection of the one or more options to the remote computer with the data regarding the vehicle based on the identifier of the vehicle or the account associated with the vehicle or the path identifier of a route the application was navigating.

18. A vehicle, comprising:
a display; and
one or more processors, coupled with memory, to execute an application to provide instructions for the vehicle, the one or more processors to:
execute the application to generate a route for the vehicle to reach a destination;
present, on the display of the vehicle, a user interface comprising an element to prompt for feedback of performance of the application;
select, responsive to selection of the element, a set of options based on a state of the application indicating that the application is generating the route for the vehicle to reach the destination, one or more options of the set of options corresponding to different types of feedback regarding the route;
present the set of options on the user interface;
receive a selection of one or more options of the set of options at the user interface; and
transmit the selection of the one or more options to a remote computer.

19. The vehicle of claim 18, comprising the one or more processors to:
identify a predicted state of charge of the vehicle at the destination based on the route for the vehicle to reach the destination; and
select second one or more options to include on the user interface based on the predicted state of charge of the vehicle at the destination.

20. The vehicle of claim 18, comprising the one or more processors to:
transmit an identifier of the vehicle or an account associated with the vehicle and a path identifier of the route the application was navigating when the element was selected to the remote computer with the selection of the one or more options.
